(19) United States
(12) Patent Application Publication
(10) Pub. No.: US 2025/0104137 A1
(43) Pub. Date: Mar. 27, 2025

(54) SYSTEM, MANAGEMENT SERVER, AND MANAGEMENT METHOD

(71) Applicant: TOYOTA JIDOSHA KABUSHIKI KAISHA, Toyota-shi (JP)

(72) Inventors: Teruyoshi FUJIWARA, Toyota-shi (JP); Iwao NITTA, Nagoya-shi (JP); Ryota SUZUKI, Ikeda-shi (JP)

(73) Assignee: TOYOTA JIDOSHA KABUSHIKI KAISHA, Toyota-shi (JP)

(21) Appl. No.: 18/790,362

(22) Filed: Jul. 31, 2024

(30) Foreign Application Priority Data
Sep. 22, 2023 (JP) 2023-159265

(51) Int. Cl. G06Q 30/0645

(52) U.S. Cl. CPC G06Q 30/0645

(57) ABSTRACT

A system includes a management server, a plurality of first terminals corresponding to respective first objects, and a plurality of second terminals corresponding to respective second objects. The management server is configured to accept setting of correlative relations between the first objects and the second objects, by receiving association requests in accordance with usage relations being generated between the first objects and the second objects. The management server is configured such that, when, in accordance with accepting the setting of the correlative relation by two or more of the association requests being accepted with respect to a same first object, two or more correlative relations are established by two or more different second objects with respect to the same first object, the setting of one correlative relation is set to active, and the settings of other correlative relations are set to non-active, in accordance with status information.

### CROSS-REFERENCE TO RELATED APPLICATION

This application claims priority to Japanese Patent Application No. 2023-159265 filed on Sep. 22, 2023, incorporated herein by reference in its entirety.

### BACKGROUND

### 1. Technical Field

The present disclosure relates to a system, a management server, and a management method.

### 2. Description of Related Art

Japanese Unexamined Patent Application Publication No. 2022-140747 (JP 2022-140747 A) proposes a fee collection system for collecting fees for services from vehicle users by using media such as cards or the like. Specifically, the fee collection system proposed in JP 2022-140747 A is configured to issue an object user with a bill for expressway use by an object rental car based on a correlative relation among an identifier (ID) of an electronic toll collection system (ETC) card, a rental car company, a date and time of rental car use, and a rental car user (billing information, registration information, settlement information, and use information).

### SUMMARY

The present disclosure provides a system, a management server, and a management method, for easily tracking a usage relation between a first object and a second object.

A system according to a first aspect of the present disclosure includes a management server a plurality of first terminals corresponding to respective first objects, and a plurality of second terminals corresponding to respective second objects. The first terminals and the second terminals are configured such that, in accordance with a usage relation being generated between the first objects and the second objects, at least one of the first terminals corresponding to the first objects or the second terminals corresponding to the second objects transmits an association request to the management server. The management server is configured to execute accepting a setting of a correlative relation between the first objects and the second objects, by receiving the association request. The management server is configured to execute, when, in accordance with accepting the setting of the correlative relation by two or more of the association requests with respect to a same first object, settings of two or more correlative relations are established with two or more second objects that are different from each other, with respect to the same first object, setting the setting of one correlative relation out of the two or more correlative relations to active, and setting the settings of other correlative relations to non-active, in accordance with status information that is obtained from at least one of the first object regarding which settings for the two or more correlative relations are established, or the two or more second objects.

In the system according to the first aspect of the present disclosure, the management server may be configured to execute, in accordance with the setting of the active correlative relation being established, validating exercise of authority correlated with a corresponding first object via the second object regarding which the active correlative relation is set. The management server may be configured to execute, in accordance with the setting of the non-active correlative relation being established, invalidating the exercise of authority associated with the corresponding first object via the second object to which the non-active correlative relation is set.

In the system according to the first aspect of the present disclosure, the status information may include a selection by the first object. Activating the setting of the one correlative relation may be constituted by activating the correlative relation setting selected by the first object.

In the system according to the first aspect of the present disclosure, the status information may include a report of an execution result of authentication processing for the first object by a second terminal. Activating the setting of the one correlative relation may be constituted by activating the setting of the correlative relation with a second object corresponding to the second terminal that most recently reported the execution result of the authentication processing for the first object.

In the system according to the first aspect of the present disclosure, each of the first terminals may include a first positioning module. Each of the second terminals may include a second positioning module. The status information may include a first current position measured by the first positioning module of the first terminal corresponding to the first object, and a second current position measured by the second positioning module of the second terminal corresponding to each of the two or more second objects. Activating the setting of the one correlative relation may be constituted of activating the setting of the correlative relation as to a second object regarding which the second current position of the corresponding second terminal satisfies a condition of the usage relation, with respect to the first current position of the first terminal.

In the system according to the first aspect of the present disclosure, the management server may be configured such that, after establishing an active correlative relation setting with a second object of a first predetermined type, the management server locks the setting of the active correlative relation until a predetermined condition is satisfied, so as to further execute prohibition of establishing a setting for another active correlative relation by another second object with respect to the first object regarding which the active correlative relation is set.

In the system according to the first aspect of the present disclosure, the first object may be a user. The second object of the first predetermined type may be a mobile body for public transportation. The predetermined condition may be that payment of fares for use of the mobile body for public transportation is completed.

In the system according to the first aspect of the present disclosure, the management server may be configured to, when a predetermined relation holds between the first object and the second object for which the correlative relation is set, maintain the correlative relation in an active or non-active state without terminating the correlative relation, until the predetermined relation is resolved. The management server may be configured such that, when the predetermined relation holds between the first object and the second object for which the correlative relation is set, after the predetermined relation is resolved, the correlative relation is terminated.

In the system according to the first aspect of the present disclosure, the predetermined relation may be an ownership relation.

In the system according to the first aspect of the present disclosure, the first object may be a user. The second object may be a mobile body owned by the user.

In the system according to the first aspect of the present disclosure, the first object may be a user. The second object may be a mobile body rented by the user. The predetermined relation may be that the user rents the mobile body.

In the system according to the first aspect of the present disclosure, the management server may be further configured to establish a setting of a correlative relation with a second object of a second predetermined type, and then, in accordance with detecting an end of use of the second object, terminate the correlative relation.

In the system according to the first aspect of the present disclosure, the first object may be a user. The second object may be a mobile body. The second object of the second predetermined type may be a mobile body for public transportation.

A management server according to a second aspect of the present disclosure includes a control unit. The control unit is configured to execute receiving of an association request from at least one of a first terminal of a first object or a second terminal of a second object, in accordance with a usage relation being generated between the first object and the second object. The control unit is configured to execute accepting a setting of a correlative relation between the first object and the second object, by receiving the association request. The control unit is configured to execute, when, in accordance with accepting the setting of the correlative relation by two or more of the association requests with respect to a same first object, settings of two or more correlative relations are established with two or more second objects that are different from each other, with respect to the same first object, setting the setting of one correlative relation out of the two or more correlative relations to active, and setting the settings of other correlative relations to non-active, in accordance with status information that is obtained from at least one of the first object regarding which settings for the two or more correlative relations are established, or the two or more second objects.

In the system according to the second aspect of the present disclosure, the control unit is configured to execute, in accordance with the setting of the active correlative relation being established, validating exercise of authority correlated with the corresponding first object via a second object to which the active correlative relation is set. The control unit may be configured to execute, in accordance with the setting of the non-active correlative relation being established, invalidating the exercise of authority associated with the corresponding first object via a second object to which the non-active correlative relation is set.

In the system according to the second aspect of the present disclosure, the status information may include a report of an execution result of authentication processing for the first object by the second terminal. Activating the setting of the one correlative relation may be constituted by activating the setting of the correlative relation with the second object corresponding to the second terminal that most recently reported the execution result of the authentication processing for the first object.

In the system according to the second aspect of the present disclosure, the status information may include a first current position measured by a first positioning module of the first terminal corresponding to the first object, and a second current position measured by a second positioning module of the second terminal corresponding to each of the two or more second objects. Activating the setting of the one correlative relation may be constituted of activating the setting of the correlative relation as to the second object regarding which the second current position of the corresponding second terminal satisfies a condition of the usage relation, with respect to the first current position of the first terminal.

In the system according to the second aspect of the present disclosure, the control unit may be configured such that, after establishing an active correlative relation setting with a second object of a first predetermined type, the control unit locks the active correlative relation setting until a predetermined condition is satisfied, thus further executing prohibition of establishing another active correlative relation setting by another second object with respect to the first object regarding which the active correlative relation is set.

In the system according to the second aspect of the present disclosure, the control unit may be configured to, when a predetermined relation holds between the first object and the second object for which the correlative relation is set, maintain the correlative relation in an active or non-active state without terminating the correlative relation, until the predetermined relation is resolved. The control unit may be configured to, when the predetermined relation holds between the first object and the second object for which the correlative relation is set, terminate the correlative relation after the predetermined relation is resolved.

A management method according to a third aspect of the present disclosure is executed by a management server. The management method includes receiving an association request from at least one of a first terminal of a first object or a second terminal of a second object, in accordance with a usage relation being generated between the first object and the second object. The management method includes accepting a setting of a correlative relation between the first objects and the second objects, by receiving the association request. The management method includes, when, in accordance with accepting the setting of the correlative relation by two or more of the association requests with respect to a same first object, settings of two or more correlative relations are established with two or more second objects that are different from each other, with respect to the same first object, setting the setting of one correlative relation out of the two or more correlative relations to active, and setting the settings of other correlative relations to non-active, in accordance with status information that is obtained from at least one of the first object regarding which settings for the two or more correlative relations are established, or the two or more second objects.

According to the present disclosure, technology can be provided for tracking usage relation between the first object and the second object easily.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 schematically illustrates an example of a situation to which the present disclosure is applied;

FIG. 2 schematically illustrates an implementation example of the situation to which the present disclosure is applied;

FIG. 3A schematically illustrates an example of association information according to an embodiment;

FIG. 3B schematically illustrates an example of user information according to the embodiment;

FIG. 3C schematically illustrates an example of mobile body information according to the embodiment;

FIG. 4A schematically illustrates an example of a selection process of association settings to be activated according to the embodiment;

FIG. 4B schematically illustrates an example of a selection process of association settings to be activated according to the embodiment;

FIG. 4C schematically illustrates an example of a selection process of association settings to be activated according to the embodiment;

FIG. 5 schematically illustrates an example of a situation in which active association settings are locked according to the embodiment;

FIG. 6 schematically illustrates an example of a process of association termination according to the embodiment;

FIG. 7 schematically illustrates an example of a situation in which association settings according to the embodiment are maintained in an active or non-active state;

FIG. 8 schematically illustrates an example of a situation of executing association termination according to the embodiment;

FIG. 9 schematically illustrates an example of a situation of use of the association information according to the embodiment;

FIG. 10A schematically illustrates an example of a hardware configuration of a management server according to the embodiment;

FIG. 10B schematically illustrates an example of a hardware configuration of a first terminal according to the embodiment;

FIG. 10C schematically illustrates an example of a hardware configuration of a second terminal according to the embodiment;

FIG. 11 schematically illustrates an example of software configurations of the devices according to the embodiment;

FIG. 12 shows an example of processing procedures of association settings according to the embodiment;

FIG. 13 shows an example of processing procedures of association termination according to the embodiment;

FIG. 14 schematically illustrates an example of a processing process of association settings when an authentication method No. 1 is employed;

FIG. 15 schematically illustrates an example of a processing process of association settings when an authentication method No. 2 is employed;

FIG. 16 schematically illustrates an example of a processing process of association settings when an authentication method No. 3-1 is employed;

FIG. 17A schematically illustrates an example of a processing process of association settings when an authentication method No. 3-2 is employed;

FIG. 17B schematically illustrates another example of a processing process of association settings when the authentication method No. 3-2 is employed;

FIG. 18A schematically illustrates an example of a processing process of association settings when an authentication method No. 4 is employed; and

FIG. 18B schematically illustrates another example of a processing process of association settings when the authentication method No. 4 is employed.

### DETAILED DESCRIPTION OF EMBODIMENTS

According to a system proposed in JP 2022-140747 A, users can pay expressway tolls by ETC even when they do not have their own ETC cards. However, the present inventors have found that the system proposed in JP 2022-140747 A has the following problems.

That is to say, as Mobility as a Service (MaaS) becomes diversified, it is conceivable there will be requests for users to easily track the use of a mobile body, from the viewpoint of convenience, such as improved efficiency of settlement and so forth. With regard to the requests for easily tracking the use of a mobile body by users, conventional systems are capable of maintaining the correlative relation between date and time of use and the user, as usage information, in accordance with a rental car contract or reservation. However, the date and time of use is dependent on the contract or reservation, and accordingly the usage information does not necessarily match the actual usage of the rental car by the user. In addition, generating usage information is not anticipated for vehicles used without a contract or reservation (e.g., a private car), in the first place. Accordingly, in conventional systems, it is difficult for users to easily track the use of mobile bodies. Note that this problem is not limited to situations in which vehicles are used. Similar problems may occur in situations in which mobile bodies other than vehicles (e.g., aircrafts, ships, and so forth) are used, and also in situations in which a plurality of types of mobile bodies are used. Further, similar problems may also occur in all usage situations involving objects other than mobile bodies.

To address the above problem, a system according to a first aspect of the present disclosure includes a management server, a plurality of first terminals corresponding to respective first objects, and a plurality of second terminals corresponding to respective second objects. The first terminals and the second terminals are configured such that, in accordance with a usage relation being generated between the first objects and the second objects, at least one of the first terminals corresponding to the first objects and the second terminals corresponding to the second objects transmits an association request to the management server. The management server is configured to execute accepting a setting of a correlative relation between the first objects and the second objects, by receiving the association request, and when, in accordance with accepting setting of the correlative relation by two or more of the association requests with respect to a same first object, settings of two or more correlative relations are established with two or more second objects that are different from each other, with respect to the same first object, setting a setting of one correlative relation out of the two or more correlative relations to active, and setting settings of other correlative relations to non-active, in accordance with status information that is obtained from at least one of the first object regarding which settings for the two or more correlative relations are established, and the two or more second objects.

In the first aspect of the present disclosure, the usage relation between the first object and the second object can be tracked by setting the correlative relation between the first object and the second object (association setting) and activating the association setting. In addition, in the first aspect of the present disclosure, a plurality of association settings is permitted for one first object (one individual of the first object). Switching the state (active/non-active) of multiple association settings enables usage relations to be tracked. When multiple association settings are not permitted for the one first object, setting and terminating of association will be repeated each time a usage relation is generated or dissolved, which may result in increase in time and effort spent. In particular, when the same usage relation repeatedly is generated and dissolved, association settings of the same content will be repeatedly set and terminated, which may lead to increase in unnecessary processing costs. Conversely, in the first aspect of the present disclosure, in at least some situations, the generation and dissolution of usage relations can be handled by switching the state, without repeating setting and termination of associations. This enables management of associations to be simplified. Thus, according to the first aspect of the present embodiment, the usage relation between the first object and the second object can be easily tracked.

Note that the form of the present disclosure is not limited to the above example. As another form of the system according to the above aspect, one facet of the present disclosure may be an information processing device that realizes all or part of the above components, may be an information processing method, may be a program, and may be a storage medium that stores such a program and is readable by a machine such as a computer. Now, the storage medium readable by a machine is a medium that stores information such as programs and so forth by electrical, magnetic, optical, mechanical, or chemical action. The information processing device may be at least one of the management server, the first terminal, and the second terminal, according to the above aspect. Also, the system according to the above aspect may further include at least one of a first server involved in authentication of the first object and a second server involved in authentication of the second object.

For example, a management server according to a second aspect of the present disclosure may include a control unit configured to execute receiving an association request from at least one of a first terminal of a first object and a second terminal of a second object, in accordance with a usage relation being generated between the first object and the second object, accepting a setting of a correlative relation between the first object and the second object, by receiving the association request, and when, in accordance with accepting setting of the correlative relation by two or more of the association requests with respect to a same first object, settings of two or more correlative relations are established with two or more second objects that are different from each other, with respect to the same first object, setting a setting of one correlative relation out of the two or more correlative relations to active, and setting settings of other correlative relations to non-active, in accordance with status information that is obtained from at least one of the first object regarding which settings for the two or more correlative relations are established, and the two or more second objects.

Also, for example, a management method according to a third aspect of the present disclosure, may be an information processing method in which a management server executes receiving an association request from at least one of a first terminal of a first object and a second terminal of a second object, in accordance with a usage relation being generated between the first object and the second object, accepting a setting of a correlative relation between the first objects and the second objects, by receiving the association request, and when, in accordance with accepting setting of the correlative relation by two or more of the association requests with respect to a same first object, settings of two or more correlative relations are established with two or more second objects that are different from each other, with respect to the same first object, setting a setting of one correlative relation out of the two or more correlative relations to active, and setting settings of other correlative relations to non-active, in accordance with status information that is obtained from at least one of the first object regarding which settings for the two or more correlative relations are established, and the two or more second objects.

Hereinafter, an embodiment according to one aspect of the present disclosure (hereinafter also referred to as “present embodiment”) will be described with reference to the drawings. Note, however, that the present embodiment described below is merely an exemplification of the present disclosure in all respects. Various improvements or modifications may be made without departing from the scope of the present disclosure. In the implementation of the present disclosure, specific configurations may be employed as appropriate in accordance with the form of implementation. Note that data that appears in the present embodiment will be described using natural language, but more specifically, this is specified using pseudo language, commands, parameters, machine language, or the like, which can be recognized by a computer.

### 1. APPLICATION EXAMPLE

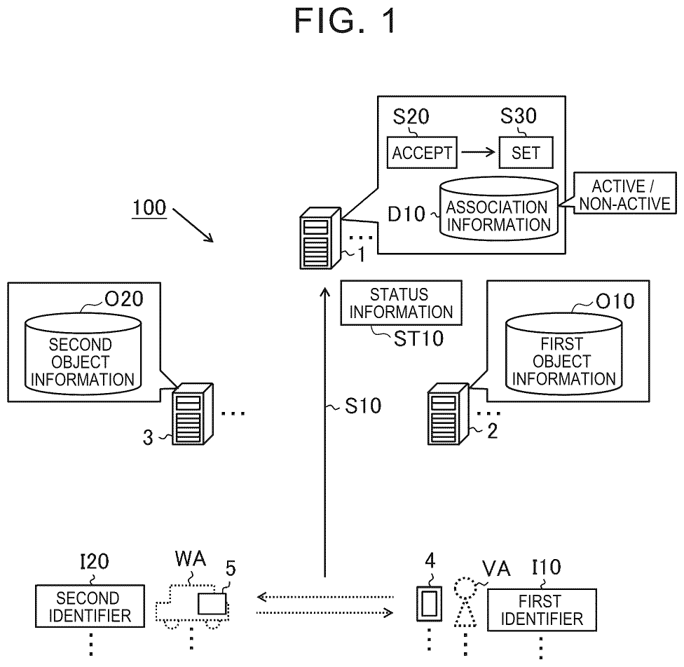

FIG. 1 schematically illustrates an example of a situation to which the present disclosure is applied. A system 100 according to the present embodiment is made up of a management server 1, the first terminals 4, and the second terminals 5. The management server 1 is one or more computers configured to record a correlative relation (association) between a first object VA and a second object WA. The first terminals 4 corresponds to respective first objects VA, and the second terminals 5 correspond to respective second objects WA.

In the present embodiment, the plurality of first terminals 4 and the plurality of second terminals 5 are configured such that, in accordance with usage relations being generated between the first objects VA and the second objects WA, at least one of the first terminals 4 corresponding to the first objects VA and the second terminals 5 corresponding to the second objects WA transmits an association request to the management server 1. As an example, a one-to-one usage relation is generated between the first object VA and the second object WA. That is to say, a usage relation is generated between one first object VA and one second object WA. One first object VA is one individual of the first object VA, and one second object WA is one individual of the second object WA. One individual with which a usage relationship has been generated may be referred to as a “relevant individual” or an “object individual.” In accordance with the generation of this usage relation, at least one first terminal 4 corresponding to the relevant individual of the first object VA and one second terminal 5 corresponding to the relevant individual of the second object WA transmits an association request to the management server 1 (step S10).

In accordance with this, the management server 1 receives an association request from at least one of the first terminal 4 of the first object VA and the second terminal 5 of the second object WA. In accordance with receiving this association request, the management server 1 accepts settings of the correlative relation between the first object VA and the second object WA (step S20). The management server 1 sets the correlative relation between the relevant individual of the first object VA and the relevant individual of the second object WA in accordance with the association request that is accepted (step S30).

In this processing, when no settings of correlative relations with other second objects WA have been established for the relevant individual of the first object VA that is pertinent (i.e., settings of two or more correlative relations are not established among two or more second objects WA that differ from each other with respect to the same first object VA), no conflict of association settings occurs. Accordingly, the management server 1 may directly set an active correlative relation between the relevant individual of the first object VA and the relevant individual of the second object WA. No settings of correlative relation having been established with other second objects WA includes, in addition to there being no settings of correlative relations with other second objects WA regardless of state (active/non-active), a non-active correlative relation existing with other second objects WA, but no active correlative relation existing therewith.

On the other hand, when a correlative relation with another second object WA has already been established for the relevant individual of the first object VA, conflict in the association settings will occur. Correlative relations having already been established with other second objects WA means settings for two or more correlative relations are established with two or more second objects WA that are different from each other, with respect to the same first object VA, in accordance with settings for correlative relations by two or more association requests being accepted with respect to the same first object VA. Correlative relations already being established with other second objects WA may be constituted by the presence of an active correlative relation with another second object WA. In this case, the management server 1 acquires status information ST10 from at least one of the first object VA and the two or more second objects WA with which settings of two or more correlative relations are established. The management server 1 then sets the settings of one correlative relation of the two or more correlative relations to active, and sets the settings of the other correlative relationships to non-active, in accordance with the status information ST10 that is obtained. Thus, the management server 1 arbitrates conflicts in association settings.

Note that when a usage relationship is generated between the first object VA and the second object WA, data exchange may be executed between the first terminal 4 corresponding to the relevant individual of the first object VA and the second terminal 5 corresponding to the relevant individual of the second object WA. In conjunction with this data exchange, an association request may be executed. The series of processing from the association request to the association settings may be executed in real time in accordance with the generation of the usage relation. A correlative relation (association) maintained in an active or non-active state may be terminated at any time. In accordance with the usage relation being dissolved, the active correlative relation may be changed to non-active, or may be terminated.

Further, as long as each individual regarding which a correlative relation is set can be identified, the format of expressing information indicating the settings for a correlative relation is not limited in particular, and may be decided as appropriate in accordance with the form of implementation. In one example, each first object VA may be provided with a first identifier I10, and each individual of the first object VA may be identified by the first identifier I10. In the same way, each second object WA may be provided with a second identifier I20, and each individual of the second object WA may be identified by the second identifier I20. In accordance with this, setting a correlative relation between the relevant individual of the first object VA and the relevant individual of the second object WA may be constituted of setting a correlative relation between the first identifier I10 provided to the relevant individual of the first object VA and the second identifier I20 provided to the relevant individual of the second object WA. That is to say, settings of the correlative relation may be expressed using the first identifier I10 and the second identifier I20.

As described above, in the present embodiment, the usage relation between the relevant individual of the first object VA and the relevant individual of the second object WA can be tracked by processing of setting the correlative relation between the first object VA and the second object WA (association settings) and activation. In addition, in the present embodiment, association settings of each of a plurality of individuals of the second objects WA with respect to one individual of the first object VA is permitted. Establishing a plurality of association settings enables, when the association settings regarding the relevant individual of the first object VA conflict, the conflict to be arbitrated by switching the state (active/non-active). Arbitrating the conflict in the association settings enables the usage relation regarding the relevant individual of the first object VA to be properly tracked. When multiple association settings are not permitted for each individual of the first object VA, setting and terminating of association will be repeated each time a usage relation is generated or dissolved, which may result in increase in time and effort spent. In particular, when the same usage relation repeatedly is generated and dissolved, association settings of the same content will be repeatedly set and terminated, which may lead to increase in unnecessary processing costs. In contrast, in the present embodiment, in at least some situations in which usage relations are tracked, the generation or dissolution of usage relations can be handled by switching the state, without repeatedly setting and terminating the association settings. This enables management of associations to be simplified. Thus, according to the present embodiment, the usage relation between the first object VA and the second object WA can be easily tracked.

### Objects

The first object VA and the second object WA are not limited in particular as long as a usage relation can hold therebetween, and may be selected as appropriate in accordance with the form of implementation. The first object VA and the second object WA may each be any entity such as a physical object, a human, or some other living creature or the like. This any entity may include a virtual entity. A usage relation holding may mean, for example, that a real or a virtual relation occurs between at least two entities, such as a relation in which one uses the other, one possesses the other, one is joined to the other, one is connected to the other, or the like. The system 100 of the present disclosure may be used in any situation in which a correlative relation among two or more entities is to be tracked.

Note that in the present embodiment, when association settings are established for each of a plurality of the relevant individuals of the second objects WA with respect to the relevant individual of the first object VA, the management server 1 executes arbitration processing in which one of the association settings is selected from among the association settings as an active association setting. On the other hand, handling regarding each of the association settings of a plurality of the relevant individual of the first object VA as to the relevant individual of the second object WA may be the same as or different from that of the first object VA. That is to say, when association settings are each established between the relevant individuals of the first object VA as to the relevant individual of the second object WA, the management server 1 may execute arbitration processing of selecting one association setting from among the association settings as an active association setting, in the same way as with the first object VA. Alternatively, the management server 1 may permit multiple active association settings for the same second object WA without executing arbitration processing. For example, a situation will be considered in which the first object VA is a user and the second object WA is a mobile body. When a mobile body can be used by multiple users (e.g., the mobile body is a vehicle that multiple people can board), active association settings of each of the users can be appropriately hold with respect to the same mobile body. In such a case, multiple active association settings may be permitted for the same second object WA. Of two objects of which the usage relation is to be tracked, one object regarding which multiple active association settings is not permitted may be selected as the first object VA, and the other object regarding which multiple active association settings is permitted may be selected as the second object WA.

### Terminals

The terminals (4, 5) are related to the objects (VA, WA). The relation between the terminals (4, 5) and the objects (VA, WA) is not limited in particular, and may be decided as appropriate in accordance with the form of implementation. In one example, each first terminal 4 may accompany a corresponding first object VA, and each second terminal 5 may accompany a corresponding second object WA. Accompanying may include being temporarily or permanently deployed inside or outside the object, being possessed by the object (human), and being possessed by a human involved with the object (physical object). Deploying may include loading. Loading may include not only being is permanently placed on the object but also placing on the object at least temporarily during use of the object. Loading may include being possessed by a user of the object. Either the first terminal 4 or the second terminal 5 may be the object itself. Note that, regarding the terminals (4, 5), a plurality of the terminals may be used as terminals of the same individual, such as one user sharing an account among multiple terminals or the like, for example. In this case, multiple terminals used by the same individual may be interpreted as being one terminal of one individual.

### Object Information

In one example, first object information O10 regarding the first object VA may be used to indicate details of each individual of the first object VA. The first object information O10 may include the first identifier I10. In the same way, second object information O20 regarding the second object WA may be used to indicate details of each individual of the second object WA. The second object information O20 may include the second identifier I20. The first object information O10 and the second object information O20 may be held in any storage area. At least a portion of the first object information O10 and the second object information O20 may be held so as to be accessible from at least one of the management server 1, an external server, and the terminals (4, 5).

The first object information O10 and the second object information O20 may be managed as appropriate. In the example in FIG. 1, a first server 2 may be configured to manage the first object information O10, and a second server 3 may be configured to manage the second object information O20. The first server 2 and the second server 3 may each be made up of one or more server devices. The first object information O10 may be stored in a memory resource located in at least one of inside and outside of the first server 2, so as to be accessible from the first server 2. The second object information O20 may be stored in a memory resource located in at least one of inside and outside of the second server 3, so as to be accessible from the second server 3. Examples of internal memory resources may include random-access memory (RAM), auxiliary storage devices, storage media, and so forth. Examples of external memory resources may include external storage devices, external computers (network-attached storage (NAS) or the like), and so forth. In another example, the pieces of object information (O10, O20) may be stored in memory resources of the management server 1.

The unit for managing the pieces of object information (O10, O20) is not limited in particular, and may be decided as appropriate in accordance with the form of implementation. At least one of the first object information O10 and the second object information O20 may be managed centrally (collectively) or distributively (individually) for each optional group. Server devices making up the servers (2, 3) may be installed by one or more management organizations (entities). At least one of the first server 2 and the second server 3 may be installed by a plurality of management organizations. When the server is installed by multiple management organizations, the object information may be shared (i.e., managed centrally) or may be managed distributively for each management organization.

Further, in one example, at least one of transmitting association requests and accepting settings of correlative relations includes authenticating at least one of the relevant individual of the first object VA and the relevant individual of the second object WA. The authentication of the relevant individual may be performed by any method. Authentication processing may be executed by at least one of the terminals (4, 5), an external server (e.g., the first server 2 or the second server 3), and the management server 1. In one example, the pieces of object information (O10, O20) may include information (unique information that is already registered, or the like) used to authenticate the objects (VA, WA). In another example, the servers (2, 3) may issue information (timed certificate) used for authentication of the objects (VA, WA). When at least part of the authentication processing is executed by the external server or the management server 1, the association request may include data used for authentication. The management server 1 may be configured to execute association setting processing (step S30) only when authentication is successful.

### Identifiers

In one example, the identifiers (I10, I20) may be used to identify the individuals of the objects (VA, WA). As long as the individuals of the objects (VA, WA) can be identified by using the identifiers (I10, I20), the data format and structure are not limited in particular, and may be selected as appropriate in accordance with the form of implementation. In one example, the identifiers (I10, I20) may each be made up of a symbol string including numbers, letters, and so forth. In another example, the identifiers (I10, I20) may use unique information such as identification information uniquely assigned to the objects (VA, WA), information derived from the terminals (4, 5), and so forth. The uniquely assigned identification information may be, for example, a vehicle registration number, a vehicle identification number (VIN), a personal number, or the like. When an integrated circuit (IC) tag is assigned to the object, the uniquely assigned identification information may include information held by the IC tag. The information derived from the terminals (4, 5) may be, for example, a media access control address (MAC address) or terminal identification information (international mobile equipment identifier (IMEI), international mobile subscriber identity (IMSI), mobile equipment identifier (MEID), integrated circuit card ID (ICCID), or other serial numbers or the like), and so forth.

### Management Server

The management server 1 is configured to set a correlative relation between the first object VA and the second object WA in accordance with an association request from at least one of the first terminal 4 and the second terminal 5. The management server 1 may directly receive the association request from at least one of the first terminal 4 and the second terminal 5, or may indirectly receive the association request via an external computer (e.g., the first server 2, the second server 3, or the like). That is to say, transmitting the association request toward the management server 1 may include directly transmitting the association request to the management server 1, and indirectly transmitting the association request via an external computer. In one example, transmitting indirectly may constitute simply having the association request relayed by an external computer. In another example, transmitting indirectly may constitute transmitting a commission for processing related to association to an external computer, and having the external computer transmit some sort of information to the management server 1 in accordance with results of the execution, such as for example, commissioning the servers (2, 3) to authenticate the objects (VA, WA) and to transmit results of the authentication to the management server 1, or the like. That is to say, the association request may be transmitted from the external computer to the management server 1 as a result of data communication for carrying out another purpose with the external computer.

The management server 1 may be configured to set an active correlative relation between the first object VA and the second object WA, or update the state of the correlative relation from non-active to active, in accordance with the generation of a usage relation. The association request (commission for setting an association) may include requesting establishment of a new association setting, and requesting change of the state of an existing association setting from non-active to active. When there is no association setting between the relevant individuals, the association request may be constituted of a request to establish a new association setting. When there is an association setting among the relevant individuals, the association request may be constituted of a request to change the state of the corresponding existing association setting.

Information indicating whether an association setting exists among the relevant individuals may be managed as appropriate. In one example, at least one of the first terminal 4 and the second terminal 5 may reference association information D10 to differentiate whether an association setting among the relevant individuals exists, before transmitting an association request. In another example, at least one of the first terminal 4 and the second terminal 5 may be configured to record history of past association requests. At least one of the first terminal 4 and the second terminal 5 may differentiate whether an association setting exists among the relevant individuals by referencing this history. The past history may be generated by individual processing at the terminals. The past history may be generated by sharing the association information D10 of the relevant individuals with the management server 1. At least one of the first terminal 4 and the second terminal 5 may transmit either a request to establish a new association setting or a request to change the state of a corresponding existing association setting to active, as the association request, in accordance with the results of the differentiation.

In yet another example, the first terminal 4 and the second terminal 5 may transmit association requests without distinguishing whether an association setting exists between the relevant individuals. In this case, when processing the association request, differentiation may be made regarding whether an association setting already exists between the relevant individuals. For example, the management server 1 may perform differentiation regarding whether there is an existing association setting between the relevant individual of the first object VA and the relevant individual of the second object WA specified by the association request, by referencing the association information D10. Also, for example, an external computer such as the first server 2, the second server 3, and so forth, may differentiate whether an association setting already exists between the relevant individuals. In one example, the external computer may differentiate whether an association setting that is an object exists, by referencing the association information D10. In another example, the external computer may be configured to record a history of association separately from the association information D10, and to determine whether association setting that is an object exists by referencing this history. The history of association may be generated by individual processing by an external computer, or may be generated by at least partially sharing the association information D10 with the management server 1. The management server 1 may execute either processing of establishing a new association setting, or processing of changing the state of the corresponding existing association setting to active, in accordance with the results of the differentiation.

In an example of the present embodiment, when there are no existing active association settings with other individuals of the second object WA, the management server 1 may establish a new correlative relation setting, or change the state of a specified existing correlative relation to active, in accordance with the association request. Thus, the management server 1 may set an active correlative relation between the relevant individuals. No presence of existing active association settings with other individuals of the second object WA may include that there is no existing association setting amount other individuals of the second object WA with respect to the relevant individual of the first object VA, or that there are existing association settings for other individuals of the second object WA with respect to the relevant individual of the first object VA but all existing association settings of the second object WA with other individuals are non-active.

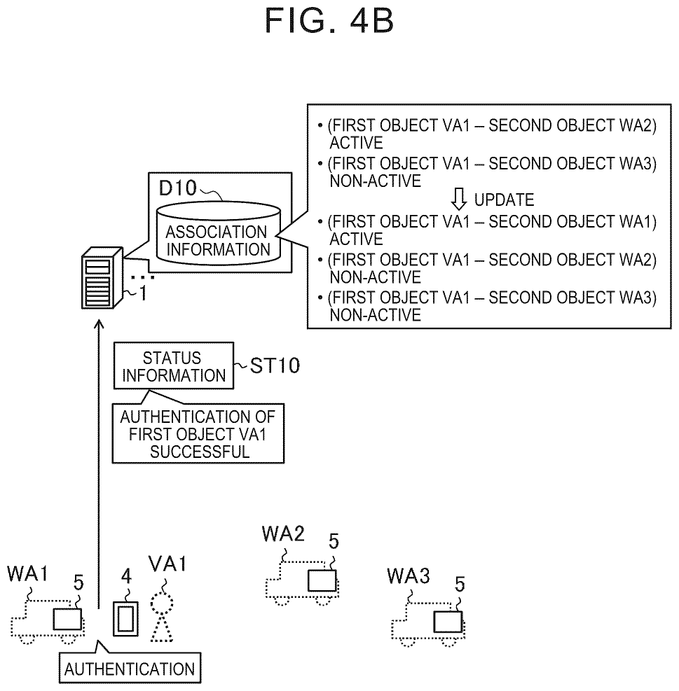

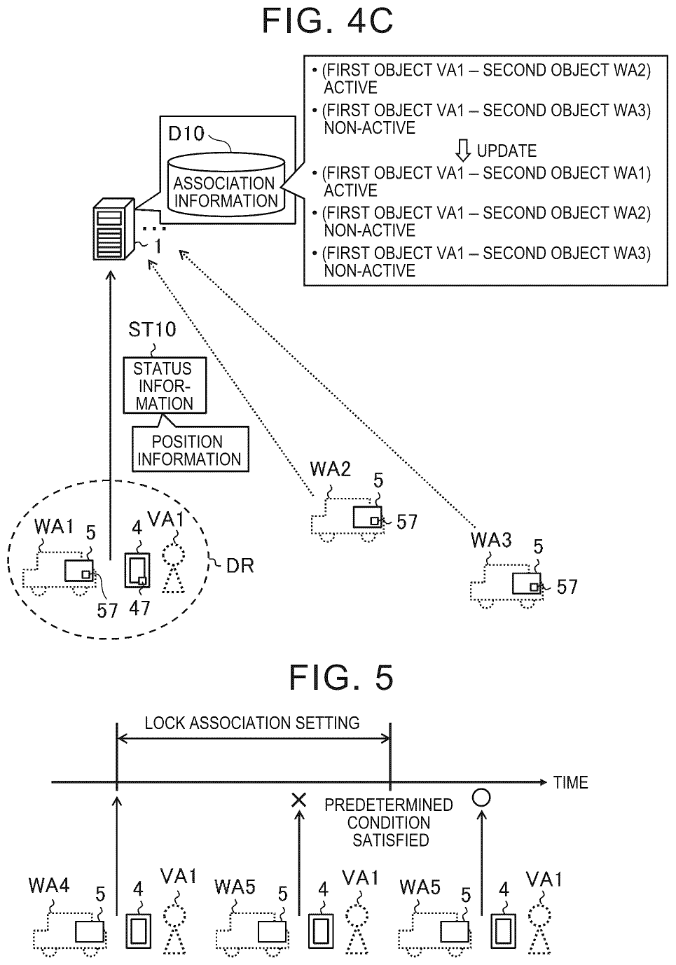

On the other hand, when there is an active existing association setting with other individuals of the second object WA, and an active association setting is established in the current state in accordance with the association request (i.e., an active new association setting is established, or the state of a corresponding existing association setting is changed to active), multiple active association settings hold with respect to the same individual of the first object VA, resulting in a conflict of association settings. Accordingly, through the above arbitration processing, the management server 1 activates the setting of one correlative relation, and sets the settings of the other correlative relations to non-active, in accordance with the status information ST10. Thus, the management server 1 resolves conflicts in association settings. Rules for arbitration based on the status information ST10 (i.e., method for selecting active correlative relations) may be decided as appropriate in accordance with the form of implementation. In a simple example, the management server 1 may set the state of the correlative relation specified by the earliest association request to active, and set the states of the other correlative relations to non-active. In this case, the status information ST10 may be constituted of any information that can differentiate whether the association request is the earliest. In one example, the status information ST10 may be constituted of information such as a timestamp, a transmission time of when the association request was transmitted, a reception time of when the association request was received, the fact that the association request was received, and so forth. Other examples of arbitration rules will be described later (FIGS. 4A to 4C).

In an example of the present embodiment, authentication processing for at least one of the first object VA and the second object WA may be executed in relation with the association request. For example, when a request is made to establish a new association setting, authentication processing may be executed regarding at least one of the first object VA and the second object WA. The same authentication processing as for a request to establish a new association setting may be executed when a request is made to change the state of an existing association setting. However, employing this form will result in the same processing being repeated, which may lead to an increase in processing costs. Therefore, at least a part of the authentication processing may be omitted when requesting changes to the state of existing association settings. Thus, it is preferable for the processing for requesting changing of the state of an existing association setting to be configured to be easier than the processing for requesting a new association setting to be established. For example, when requesting to establish a new association setting, at least one of the first terminal 4 and the second terminal 5 may acquire data to use for authentication as appropriate. When requesting a change to the state of an existing association setting, the processing for acquiring data to be used for authentication may be omitted by storing the data used for authentication that was acquired at the time of making a request to establish this new association setting. Also, authentication processing itself may be omitted, for example. In one example, an arrangement may be made in which, when a request is made to establish a new association setting, authentication processing is executed for both the first object VA and the second object WA, whereas when a request is made to change the state of an existing association setting, authentication processing is omitted for at least one of the first object VA and the second object WA. Also, in another example, an arrangement may be made in which, when a request is made to establish a new association setting, authentication processing is executed for at least one of the first object VA and the second object WA, whereas when a request is made to change the state of an existing association setting, authentication processing is omitted for both of the first object VA and the second object WA. According to an example of the present embodiment, reduction in processing costs can be anticipated.

Also, the management server 1 may be configured to terminate a correlative relation between the first object VA and the second object WA, or update the state of the correlative relation from active to non-active, in accordance with the usage relation being dissolved. When the usage relationship is dissolved, at least one of the first terminal 4 and the second terminal 5 may transmit a commission to terminate the association (termination request) to the management server 1. The termination request may be transmitted directly or indirectly to the management server 1, similar to the association request. The termination request may include requesting invalidation (termination in a narrow sense) of the corresponding association setting, and requesting a change in the state of the existing association setting from active to non-active. Invalidation of the association setting may include deleting the association setting, providing information indicating termination, and indicating that termination conditions are satisfied. Providing information indicating termination may include, for example, adding a termination time, setting a flag indicating the termination, storing transactions indicating termination, and so forth. Indicating that the termination condition is satisfied may include, for example, that a term of validity that was set has expired or the like. Whether to invalidate the association settings or change the state of the association settings may be selected as appropriate by at least one of the terminals (4, 5), the management server 1, and an external computer (e.g., first server 2, second server 3, or the like). In one example, after a correlative relation is invalidated, the invalidated correlative relation may be treated as non-existent. In accordance with this, when an association request is issued again for the combination of the same individuals of the first object VA and second object WA after being invalidated, the management server 1 may execute processing to establish a new association setting. The state of the correlative relation may be updated at any timing other than the above, as long as the setting of the correlative relation (association) is maintained. Note that termination (invalidation or making non-active) in a broad sense may be read as “resolution”, and termination (invalidation) in a narrow sense may also be referred to as “termination”.

In an example of the present embodiment, authentication processing for at least one of the first object VA and the second object WA may be executed in relation with a termination request, in the same way as with the association request above. At the time of requesting change to the state of an existing association setting, authentication processing that is the same as processing for a request to invalidate an association setting may be executed. At least a part of the authentication processing may be omitted when requesting change to the state of an existing association setting. Accordingly, the processing for requesting changing of the state of an existing association setting may be configured to be easier than the processing for requesting invalidation of an association setting. In another example, when making the association request, authentication processing is executed regarding at least one of the first object VA and the second object WA, whereas at least part of the authentication processing may be omitted when making a termination request. Thus, the processing for a termination request may be configured to be easier than the processing for making an association request.

Note that the association request and the termination request may be configured to specify the relevant individual to be the object of processing using any method. In a typical example, the association request and the termination request may each be configured to include the first identifier I10 and the second identifier I20, so as to specify the relevant individual to be the object of processing. However, the method of specifying the relevant individual to be the object of processing is not limited to this example, and may be changed as appropriate in accordance with the form of implementation. In another example, at least one of the first identifier I10 and the second identifier I20 may be omitted in at least one of the association request and the termination request by using alternative information. For example, an identifier may be assigned as alternative information to a combination (association setting) of the relevant individuals of the first object VA and the second object WA. The identifier may be assigned at any timing, such as, for example, when performing the association setting for the first time, or the like. At least one of the association request and the termination request may be configured to specify the relevant individuals of the objects (VA, WA) that are pertinent regarding processing, due to including this identifier therein, without including at least one of the first identifier I10 and the second identifier I20.

Regarding association requests, the method of specifying each relevant individual may be the same or may be different between a request to establish a new association setting and a request to change the state of an existing association setting. In one example, a request to change the state of an existing association setting may be configured to more easily specify each relevant individual than a request to establish a new association setting. For example, a configuration may be made in which a request to establish a new association setting includes the first identifier I10 and the second identifier I20, whereas a request to change the state of an existing association setting is configured to include the above alternative information. In the same way, regarding termination requests, the method of specifying each relevant individual may be the same or may be different between a request to invalidate an association setting and a request to change the state of an existing association setting. In one example, a request to change the state of an existing association setting may be configured to more easily specify each relevant individual than a request to invalidate an association setting. For example, a configuration may be made in which a request to invalidate an association setting includes the first identifier I10 and the second identifier I20, whereas a request to change the state of an existing association setting is configured to include the above alternative information.

The management server 1 may be made up of one or more server devices. In the present embodiment, the management server 1 may be configured to record information regarding the generation and dissolution of correlative relations between the first object VA and the second object WA as the association information D10. The association information D10 may be stored in a memory resource located at least either inside or outside of the management server 1. Examples of internal memory resources may include RAM, auxiliary storage devices, storage media, and so forth. Examples of external memory resources may include external storage devices, external computers (NAS or the like), and so forth.

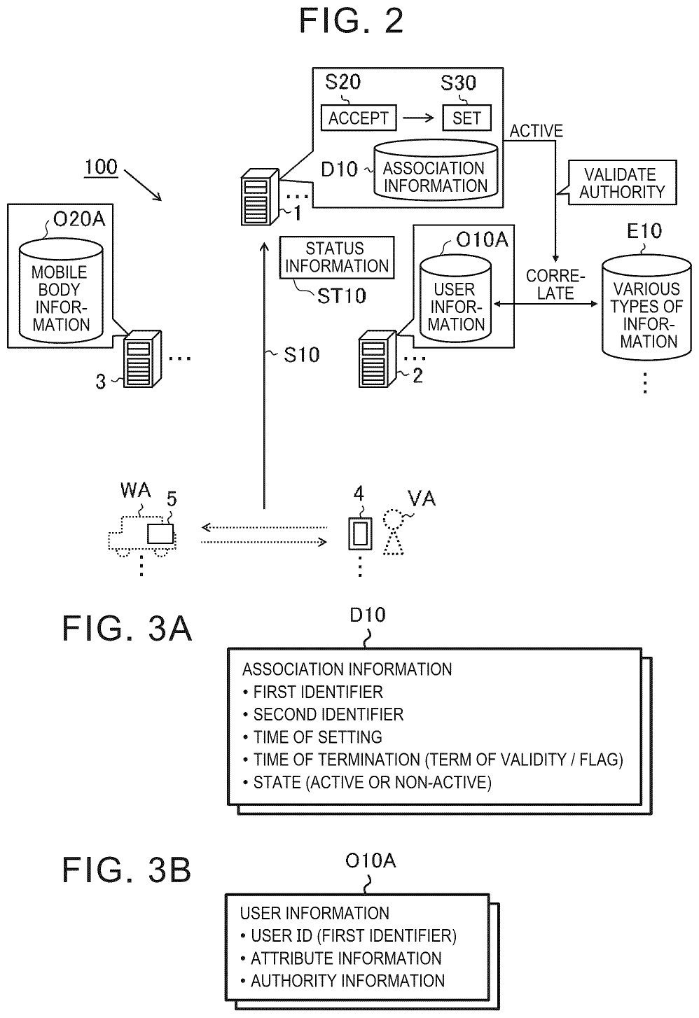

The association information D10 that is obtained may be used in various situations. In one example, the association information D10 may be used to track the relation between the first object VA and the second object WA. As a specific example, the association information D10 may be used for authority associated to one of the first object VA and the second object WA (first object information O10 and second object information O20) to be exercisable by the other, while the correlative relation between the first object VA and the second object WA is set. That is to say, the association information D10 may be used to validate exercising of the authority of one of the first object VA and the second object WA by the other, in accordance with the association between the first object VA and the second object WA (FIG. 2, to be described later).

In an example of the present embodiment, in order to indicate a combination of the first object VA and the second object WA for which a correlative relation has been set, the association information D10 may include information of the first identifier I10 of the relevant individual and the second identifier I20 thereof. The management server 1 may acquire each identifier (I10, I20) of each object as appropriate. In one example, the management server 1 may acquire the information regarding the first identifier I10 and second identifier I20, for which the correlative relation is set, from at least one of the servers (2, 3) and the terminals (4, 5) each time, rather than holding the information in advance. In another example, the management server 1 may hold in advance information regarding at least one of the first identifier I10 and the second identifier I20 for which the correlative relation is set.

The management organizations of the management server 1 and each server (2, 3) may be in any relation. In one example, the management organization of the management server 1 may double as the management organization of at least one of the first server 2 and the second server 3. In another example, the management organization of the management server 1 may be different from the management organizations of the first server 2 and the second server 3. The system 100 according to the present disclosure may be produced by the management server 1 being connected to the terminals (4, 5) via a network, each thereof being deployed in a state in which the information processing is executable as intended by the management organization of the management server 1. When each server (2, 3) is involved in information processing related to association (e.g., authentication processing), each server (2, 3) may be interpreted as being included in the system 100. In this case, the system 100 according to the present disclosure may be produced by the management server 1 being further connected to the servers (2, 3) via a network, each server (2, 3) being further deployed in a state in which the information processing related to association is executable.

### Operation Examples

In one example, one of the first object VA and the second object WA may be a user. One terminal of the first terminal 4 and the second terminal 5 that corresponds to the user may be a user terminal related to the user. The other of the first object VA and the second object WA may be a usage item to be used by the user. One of the first terminal 4 and the second terminal 5 that corresponds to the usage item may be a loaded terminal to be loaded on the usage item. According to an example of this embodiment, usage relations between users and usage items can be easily tracked.

The type of the usage item is not limited in particular, as long as it can be used by the user, and may be selected as appropriate in accordance with the form of implementation. In one example, the usage item may be a mobile body (mobility device). According to an example of the present embodiment, the usage relation between the user and the mobile body can be tracked. Note that the type of the mobile body may be selected as appropriate. The mobile body may be, for example, a vehicle, a railway vehicle, an aircraft (airplane, drone, or the like), a ship, or the like. The mobile body may be at least one of a manually controlled manned machine and an automatically controlled unmanned machine. When the mobile body is a vehicle, the type of the vehicle may be optionally selected. The type of the vehicle may be selected, for example, from among a two-wheeled vehicle, a three-wheeled vehicle, a four-wheeled vehicle, or the like. The vehicle may include a private car, a rental car, a shared car, a taxi, a bus, or the like. The vehicle may be at least one of an automated driving vehicle and a manual driving vehicle. The loaded terminal may be referred to as “mobile body terminal”.

FIG. 2 schematically illustrates an implementation example of the situation to which the system 100 of the present disclosure is applied. In the example in FIG. 2, the first object VA is a user and the second object WA is a mobile body. In the following description of the example in FIG. 2, the term “first” is used relating to the user, and the term “second” relating to the mobile body, for sake of convenience. However, the correlative relation between “first” and “second” does not have to be limited to that of the example in FIG. 2. The terms “first” and “second” may be interchanged. That is to say, the second object WA may be the user and the first object VA may be the mobile body.

When the first object VA is the user, an example of the first terminal 4 is a user terminal. The user terminal may be, for example, any computer such as a mobile terminal (smartphone or the like), a dedicated device (electronic key device or the like), another computer device, or the like. The user terminal typically may be possessed by the user that is an association object (each individual of first object VA). An account of the user may be shared among multiple computers, and in accordance with this, the computers sharing the account may each be used as a user terminal (first terminal 4) of the same user.

An example of the first identifier I10 is a user identifier (user ID, personal ID). The user identifier may be, for example, an ID of a user account, a personal number, or identification information of the user terminal (e.g., a MAC address or terminal identification information), or the like. An example of the first object information O10 is user information O10A. The user information O10A may include any information regarding the user. In one example, the user information O10A may be correlated with various types of information E10 for exercise of authority of the corresponding user, by including information regarding the authority of the corresponding user (corresponding individual of the user). The various types of information E10 may include, for example, public personal authentication information, settlement information, other service-related information, and so forth. The public personal authentication information may include, for example, a personal number or the like. The settlement information may include, for example, credit card information, internet banking information, electronic settlement information, and so forth. The other service-related information may include, for example, information regarding electronic prescription (insured person number, prescription information, and so forth). The various types of information E10 may be managed by an external system or may be managed within the system 100. Note that the first server 2 may be installed by a public organization, a neutral organization, individual business operators (vehicle manufacturers, service operator companies, and so forth), or the like. The first server 2 may be referred to as “user ID server”, “personal ID server”, or the like.

On the other hand, when the second object WA is a mobile body, an example of the second terminal 5 is a mobile body terminal (loaded terminal). The mobile body terminal may be, for example, a terminal attached to the inside or outside of the mobile body, a terminal possessed by a person involved in the operation of the mobile body (e.g., driver, conductor, or the like), a device installed in a facility of the mobile body (e.g., ticket gate or the like), and so forth. When the mobile body is a vehicle, the mobile body terminal may be referred to as “in-vehicle terminal”.

An example of the second identifier I20 is a mobile body identifier (mobile body ID, car ID). The mobile body identifier may be, for example, an ID of a mobile body account, identification information uniquely assigned to the object mobile body (e.g., vehicle registration number, vehicle identification information, or the like), identification information of the mobile body terminal, or the like. An example of the second object information O20 is mobile body information O20A. The mobile body information O20A may include any information regarding the mobile body. In the example in FIG. 2, exercise of at least part of the authority in the various types of information E10 correlated with the user information O10A by the mobile body may be validated (activated) in accordance with a setting of association between the user and the mobile body that is active. Note that the second server 3 may be installed by a public organization, a neutral organization, or individual business operators (vehicle manufacturers, service operator companies, or the like) and so forth. The second server 3 may be referred to as “mobile body ID server”, “car ID server”, or the like.

The mobile body is an example of the usage item. The form in FIG. 2 may be applied to any case in which the user (occupant) of the usage item changes dynamically. The usage item may be, for example, a rental item, a lodging facility, or the like, besides the mobile body. The rental item may include a rental office, a rental space, or the like.

The system 100 may be configured to set an active association between the user (first identifier I10) and the relevant individual of the usage item (second identifier I20), or update the state of the association from non-active to active, in accordance with usage of the usage item being started. Also, the system 100 may be configured to update the state of the association between the relevant individuals from active to non-active, or to terminate the association, in accordance with the end of usage. The start and end of usage may be sensed by any method, such as, for example, at the timings of getting in and out of a vehicle, renting and returning the usage item, or the like. In one example, at least one of the start and end of usage may be sensed in accordance with execution of data exchange between the first terminal 4 and the second terminal 5.

Note that the usage item can be classified into at least two types, which are an item that can be used repeatedly over a long period, and an item that can be used temporarily. For convenience of description, the former will be referred to as “constant usage item” and the latter will be referred to as “temporary usage item”. An example of a constant usage item is property of the user, such as a private car or the like. An example of a temporary usage item is an item possessed by a person other than the user, such as a rental car, a shared car, a mobile body for public transportation, a rental item, a lodging facility, and so forth. Examples of a mobile body for public transportation include a taxi, a bus, a railway vehicle, an airplane, a ship, and so forth.

In the system 100, the types of the usage items (whether constant usage item or temporary usage item) may or may not be distinguished. When distinguishing the types of the usage items, the system 100 may differentiate the types of the use items by any method. In one example, the object information (mobile body information etc.) may include information indicating the type of the usage item, and the system 100 may differentiate the type of the usage item by this information. In another example, the type of the usage item may be differentiated from information such as an identifier or the like. In another example, information transmitted from at least one of the first terminal 4 and the second terminal 5 to the management server 1 may include information indicating the type of the usage item, and the system 100 may differentiate the type of the usage item based on this information. In another example, in a case in which the management organization of the server (second server 3 in the example in FIG. 2) that handles the information regarding the usage item is decided in accordance with the type of the usage item, the type of the usage item may be differentiated based on the management organization to which the server belongs.

Also, the system 100 may also switch, in accordance with the type of usage item that is differentiated, processing of association settings, conditions for switching the state (active/non-active), conditions for association termination, management method of association information D10, forms of authentication processing, and so forth, for example.

Note that the situation to which the system 100 according to the present disclosure is applied does not have to be limited to the situation in which the relation between the user and the usage item is tracked. In another example, both the first object VA and the second object WA may be robot devices configured to operate autonomously under autonomous control. The robotic device may include a mobile body such as an automated driving vehicle, a drone, or the like. In a situation in which two or more robot devices interact autonomously, the system 100 according to the present disclosure may be used to track the relations between the robot devices being generated and dissolved.

As a specific example, one of the first object VA and the second object WA may be a large-sized automated driving vehicle, and the other may be a small-sized automated driving vehicle. The large-sized automated driving vehicle may be configured to be capable of accommodating a plurality of small-sized automated driving vehicles. The small-sized automated driving vehicles may not be able to board a plurality of large-sized automated driving vehicles at the same time (i.e., a small-sized automated driving vehicle can only be accommodated in one large-sized automated driving vehicle at any given time). In accordance with this, the first object VA may be a small-sized automated driving vehicle, and the second object WA may be a large-sized automated driving vehicle. The large-sized automated driving vehicle may collect, transport, and release each small-sized automated driving vehicle as appropriate. Each small-sized automated driving vehicle may be operated as appropriate at a release destination thereof. In this case, the system 100 according to the present disclosure may be configured to perform setting of the correlative relation between the large-sized automated driving vehicle and the small-sized automated driving vehicle, and to switch and terminate the state, thereby tracking the operational state (e.g., whether transporting).

### Data Exchange

In the present embodiment, the series of processing related to association setting may be started with data exchange between the first terminal 4 and the second terminal 5 as a trigger. That is to say, generation of a usage relation (start of usage) may be sensed from data exchange. The data exchange method is not limited in particular, and may be selected as appropriate in accordance with the form of implementation.

In one example, the data exchange between the first terminal 4 and the second terminal 5 may be performed by wireless or wired data communication. Wireless communication may be performed by using, for example, near field communication (NFC), Bluetooth (registered trademark), Wi-Fi (registered trademark), or the like. Wired communication may be performed by using, for example, a wired local area network (LAN) a universal serial bus (USB), or the like. The data communication may be performed directly between the first terminal 4 and the second terminal 5, or may be performed indirectly via another computer. In another example, the data exchange may be performed by a method other than the data communication, such as reading a two-dimensional code, or the like. For example, the data exchange may be performed by one of the first terminal 4 and the second terminal 5 displaying data on a display, and the other reading the displayed data using a sensor such as an image sensor or the like.

The association request may include at least one of the first identifier I10 and the second identifier I20. When the association request includes the first identifier I10, the first identifier I10 may be transmitted from at least one of the first terminal 4 and the second terminal 5. When the first identifier I10 is transmitted from the first terminal 4, the first terminal 4 may acquire the first identifier I10 at any timing. In one example, the first identifier I10 may be stored in the memory resource of the first terminal 4 in advance. The first terminal 4 may acquire the first identifier I10 from the memory resource. In another example, the first terminal 4 may acquire the first identifier I10 using an input device, a sensor, or the like. When the first identifier I10 is transmitted from the second terminal 5, the second terminal 5 may be provided with the first identifier I10 by the first terminal 4 at the time of data exchange, or may perform acquisition thereof by an unprompted action. In one example, the second terminal 5 may acquire the first identifier I10 from the first terminal 4 through data communication. In another example, the second terminal 5 may acquire the first identifier I10 from the first terminal 4 by a method other than data communication, such as reading the first identifier I10 displayed in a two-dimensional code on the first terminal 4, or the like. In yet another example, the second terminal 5 may acquire the first identifier I10 from either the first object VA or the first terminal 4, using a device such as an input device, a sensor, or the like. Acquisition from the first object VA may include that a person related to the second object WA is present (e.g., the second object WA is a person, the second object WA is operated by a person, or the like), and when the first object VA is a physical object, that acquisition is performed by a person related to the second object WA operating a device on its behalf.

Similarly, when the association request includes the second identifier I20, the second identifier I20 may be transmitted from at least one of the first terminal 4 and the second terminal 5. When the second identifier I20 is transmitted from the second terminal 5, the second terminal 5 may acquire the second identifier I20 at any timing. In one example, the second identifier I20 may be stored in the memory resource of the second terminal 5 in advance. The second terminal 5 may acquire the second identifier I20 from the memory resource. In another example, the second terminal 5 may acquire the second identifier I20 using an input device, a sensor, or the like. When the second identifier I20 is transmitted from the first terminal 4, the first terminal 4 may be provided with the second identifier I20 from the second terminal 5 at the time of data exchange, or may perform acquisition thereof by an unprompted action. In one example, the first terminal 4 may acquire the second identifier I20 from the second terminal 5 through data communication. In another example, the first terminal 4 may acquire the second identifier I20 from the second terminal 5 by a method other than data communication, such as reading the second identifier I20 displayed in a two-dimensional code on the second terminal 5, or the like. In yet another example, the first terminal 4 may acquire the second identifier I20 from either the second object WA or the second terminal 5 using a device such as an input device, a sensor, or the like. Acquisition from the second object WA may include that a person related to the first object VA is present (e.g., the first object VA is a person, the first object VA is operated by a person, or the like), and when the second object WA is a physical object, that acquisition is performed by a person related to the first object VA operating a device on its behalf.

In the example in FIG. 2 above, the first terminal 4 may acquire the second identifier I20 (mobile body identifier) from the second terminal 5 by data communication or by reading a code, for example. When the second identifier I20 is a vehicle registration number, the first terminal 4 may acquire the second identifier I20 by photographing a license plate by an image sensor and analyzing the obtained image. The first terminal 4 may acquire the second identifier I20 via an input device. The second terminal 5 may acquire the second identifier I20 as appropriate. The second terminal 5 may also acquire the first identifier I10 (user identifier) by data communication or by reading a code. When the first identifier I10 is a personal number or the like printed on a card, the second terminal 5 may acquire the first identifier I10 by photographing the card by an image sensor and analyzing the obtained image. The second terminal 5 may acquire the first identifier I10 via an input device. The first terminal 4 may acquire the first identifier I10 as appropriate.

When an input device is used to acquire data of the identifiers (I10, I20) or the like, acquisition of the data by one terminal from the other object may include, in addition to acquisition of the data from the other object by the other object operating the input device, acquisition of the data from the other object by one object operating the input device. For example, in the example in FIG. 2 above, when the second identifier I20 is a vehicle registration number and an input device is used to acquire the vehicle registration number, the first terminal 4 may acquire the second identifier I20 from the mobile body (second object WA), by the user (first object VA) inputting the vehicle registration number via the input device.

Note that the acquisition of the data by one terminal from the other object does not necessarily have to be executed at the time of the data exchange. One terminal may acquire the data from the other object at any timing different from that of the data exchange. Any of the above methods may be employed as the data acquisition method. In this case, the data exchange between the first terminal 4 and the second terminal 5 may function as a simple trigger for starting the series of processing related to the association setting.

### Association Information

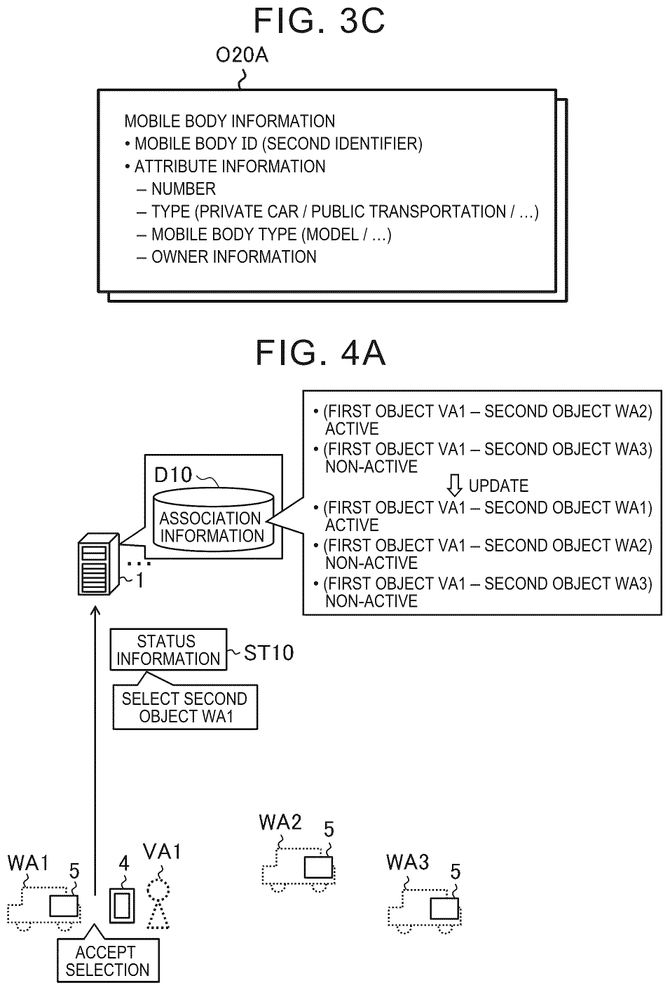

FIG. 3A schematically illustrates an example of the association information D10 according to the present embodiment. In the example in FIG. 3A, it is assumed that a form is employed in which the setting of the correlative relation is expressed using the first identifier I10 and the second identifier I20. In the example in FIG. 3A, the association information D10 includes the first identifier I10, the second identifier I20, a setting time, a termination time, and a state. The first identifier I10 and the second identifier I20 indicate the relevant individual of the first object VA and the relevant individual of the second object WA, for which a correlative relation (association) has been set. The setting time indicates the time when the correlative relation was set. The setting time may be constituted of a timestamp. The termination time indicates the time when the correlative relation was terminated. The value of the termination time may be added when the processing of terminating the correlative relation is executed. The method for expressing the termination is not limited to such an example. In another example, the termination time may be replaced with at least one of a term of validity and a flag. The term of validity indicates a period during which the setting of the correlative relation is valid. In this case, whether the setting of the correlative relation is enabled (i.e., whether the correlative relation is set or terminated) is indicated in accordance with whether within the term of validity. The flag indicates whether the correlative relation is terminated. The flag may be set when the processing of terminating the correlative relation is executed. In yet another example, the association information D10 may include at least one of the term of validity and the flag together, with a field for the termination time. The state indicates whether the setting of the correlative relation is active or non-active. Note that as long as the setting and state of the correlative relation can be indicated, the structure of the association information D10 is not limited to the example in FIG. 3A, and may be changed as appropriate in accordance with the form of implementation. In another example, the association information D10 may further include information indicating the type of the usage item (whether constant usage item or temporary usage item). Note that the type of the usage item does not necessarily have to be identified using separate information. For example, the type of the usage item may be identified by information such as an identifier or the like. Also, in another example, the association information D10 may further include information indicating the time of state change (from active to non-active, from non-active to active).

The data format of the association information D10 is not limited in particular, and may be selected as appropriate in accordance with the form of implementation. The association information D10 may be held on any database platform. In one example, the association information D10 may be held by a relational database in a table format, or the like. In another example, the association information D10 may be held by a blockchain platform. In this case, transactions for each of association setting, state changing, and termination may be stored in the blockchain as the association information D10. For example, a transaction for an association setting may include information indicating the first identifier I10, the second identifier I20, the setting time, and the type of state (active or non-active). A transaction for state changing may include a first identifier I10, a second identifier I20, and information indicating the type of change (whether change from active to non-active, or from non-active to active). The information indicating the change type may be replaced with information indicating the type of the state after changing (active or non-active). A transaction for association termination may include the first identifier I10, the second identifier I20, and the termination time (or information indicating termination).

### First Object Information

The first object information O10 may include any information regarding the first object VA. The first object information O10 may include, for example, the first identifier I10, attribute information of the first object VA, information regarding authority, and so forth. In the example in FIG. 2, the user information O10A is an example of the first object information O10.

FIG. 3B schematically shows an example of the user information O10A according to the present embodiment. In the example in FIG. 3B, the user information O10A includes a user ID (first identifier I10), attribute information, and authority information. The attribute information may include any information regarding attributes of the corresponding user. The attribute information may include personal information such as, for example, name, address, age, gender, contact information, and so forth. The authority information is related to the authority of the corresponding user. The authority information may include, for example, information for cooperation with a server that executes information processing related to the authority of the object, information indicating association with the various types of information E10, and so forth. Note that the configuration of the user information O10A is not limited to the example in FIG. 3B, and may be changed as appropriate in accordance with the form of implementation. For example, the user information O10A (first object information O10) may further include information (e.g., unique information that is already registered, or the like) used to authenticate the user (first object VA).

The data format of the first object information O10 (user information O10A) is not limited in particular, and may be selected as appropriate in accordance with the form of implementation. The first object information O10 (user information O10A) may be held on any database platform. In one example, the first object information O10 (user information O10A) may be held by a relational database in a table format, or the like. In another example, the first object information O10 (user information O10A) may be held by a blockchain platform.

### Second Object Information

The second object information O20 may include any information regarding the second object WA. The second object information O20 may include, for example, the second identifier I20, attribute information of the second object WA, information regarding authority, and so forth. In the example in FIG. 2, the mobile body information O20A is an example of the second object information O20.

FIG. 3C schematically illustrates an example of the mobile body information O20A according to the present embodiment. In the example in FIG. 3C, the mobile body information O20A includes a mobile body ID (second identifier I20) and attribute information. The attribute information includes number, type (type of the object), type of mobile body, and owner information. When the mobile body is a vehicle, the number may be a vehicle registration number. The type may be optionally defined. In one example, the type may be defined to indicate a category that can distinguish between constant usage items and temporary usage items, such as, for example, a private car, a rental car, a shared car, a mobile body for public transportation, and so forth. The mobile body type indicates a type such as a model or the like, for example. When the mobile body type and the type (type of object) are the same, the mobile body type field may be omitted. The owner information may include any information regarding the owner of the mobile body. The owner information may include personal information of the owner, such as, for example, name, address, age, gender, contact information, and so forth. The owner may be a corporation. Note that the configuration of the mobile body information O20A does not have to be limited to the example in FIG. 3C, and may be changed as appropriate in accordance with the form of implementation. For example, the mobile body information O20A (second object information O20) may further include information (e.g., unique information that is already registered, or the like) used for authentication of the mobile body (second object WA). The configuration of the attribute information may also be changed as appropriate. For example, the mobile body information O20A (attribute information) may further include information regarding the mobile body terminal, such as contact information and so forth of the mobile body terminal.

The data format of the second object information O20 (mobile body information O20A) does not have to be limited in particular, and may be selected as appropriate in accordance with the form of implementation. The second object information O20 (mobile body information O20A) may be held on any database platform. In one example, the second object information O20 (mobile body information O20A) may be held by a relational database in a table format, or the like. In another example, the second object information O20 (mobile body information O20A) may be held by a blockchain platform.

### Notification Processing

When executing at least one of the processing of association setting, state change, and termination, the management server 1 may transmit a notification indicating an execution result to at least one of the first terminal 4 and the second terminal 5. The transmission route of the notification does not have to be limited in particular, and may be decided as appropriate in accordance with the form of implementation. In one example, the management server 1 may directly notify at least one of the first terminal 4 and the second terminal 5. In another example, the management server 1 may indirectly notify at least one of the first terminal 4 and the second terminal 5 via an external computer, such as each of the servers (2, 3), or the like.

Note that in the case of performing direct notification, the management server 1 may acquire the contact information of each of the terminals (4, 5) as appropriate. The contact information may be a telephone number, an e-mail address, account information of a contact application (e.g., social networking service application or the like), an identification number, or the like. The management server 1 may acquire information that indicates the contact information of each of the terminals (4, 5) at any timing. In one example, the management server 1 may acquire information indicating contact information at the timing of accepting a request, such as an association request or a termination request. The information that indicates the contact information may originate from at least one of the terminals (4, 5) and the servers (2, 3).

### Status Information

Status information ST10 is used to select active correlative relations. As long as an active correlative relation can be selected, the status information ST10 does not have to be limited in particular. The configuration of the status information ST10 may be decided as appropriate depending on selection conditions and so forth. Also, at an optional timing before executing the arbitration processing, the management server 1 may acquire status information ST10 in real time from at least one of the relevant individual (e.g., corresponding first terminal 4) of the first object VA regarding which settings of two or more correlative relations are established, and each of the relevant individuals (e.g., each corresponding second terminal 5) of two or more second objects WA, regarding which correlative relations are set with the relevant individual of the first object VA. Thus, the association setting between the first object VA and relevant individual of the second object WA regarding which a usage relation is currently being generated may be activated. In the present embodiment, at least one of the following three methods may be employed as a method for selecting an active correlative relation.

### (1) First Method

FIG. 4A schematically illustrates an example of a selection process of association settings to be activated according to a first method of the present embodiment. In the example in FIG. 4A, a first object VA1 is an example of one individual of the first object VA with which two or more correlative relation settings are established with two or more second objects WA (two or more individuals of the second object WA). One individual of the first object VA for which two or more correlative relation settings are established is also referred to as “first individual of the first object”. A second object WA2 and a second object WA3 are each examples of other second objects WA (other individuals of second object WA) with which settings of correlative relations have already been established with the first object VA1 (first individual of the first object VA). A situation is assumed in which, when the setting of the correlative relation with the second object WA2 is active and the setting of the correlative relation with the second object WA3 is non-active, an association request for association with a second object WA1 (request for establishing new association setting) is accepted. Also, a situation is assumed in which a usage relationship is currently being generated between the second object WA1 out of the second objects WA1 to WA3 and the first object VA1.

In the first method, an association setting to be activated may be selected in accordance with a selection by the first object VA (first object VA1) regarding which two or more correlative relation settings are established. That is to say, the status information ST10 may include the selection by the first object VA (first object VA1). In accordance with this, activating one correlative relation setting may be constituted of activating the correlative relation setting selected by the first object VA (first object VA1).

In the example in FIG. 4A, the first object VA1 selects the second object WA1 from among the second objects WA1 to WA3. In accordance with this, the association settings of the first object VA1 may be updated such that an active association setting is established with the second object WA1, and the state of the association setting with the second object WA2 changes from active to non-active.

Note that selecting an association setting to activate may include directly selecting an association setting to activate, and selecting an association setting for making non-active, thereby indirectly selecting the association setting to activate. Selecting the association setting may include selecting the second object WA. The selection may be executed by automatic processing by a computer (terminal), or may be executed manually.

Also, the selection of the association setting to be activated may be accepted by at least one of the first terminal 4 of the first object VA (first object VA1) and the second terminal 5 of the second object WA. The second terminal 5 of the second object WA may be the second terminal 5 of the second object WA (second object WA1 in FIG. 4A) with which a usage relation is currently being generated. The status information ST10 may be transmitted toward the management server 1 from at least one of the first terminal 4 and the second terminal 5. In one example, the status information ST10 may be transmitted from one terminal of the first terminal 4 and the second terminal 5 that has accepted the selection. In another example, the status information ST10 may be transmitted from another terminal that is different from the one terminal that has accepted the selection, out of the first terminal 4 and the second terminal 5, by data exchange of the selection result.

Further, any transmission trigger may be employed. In one example, at least one of the first terminal 4 and the second terminal 5 may transmit the status information ST10 toward the management server 1, as unprompted information processing in conjunction with the association request. In another example, at least one of the first terminal 4 and the second terminal 5 may transmit the status information ST10 toward the management server 1 as a reply to an inquiry from the management server 1. The status information ST10 to be transmitted may be configured as appropriate to indicate the selection result of the first object VA. According to an example of the present embodiment, active association settings can be selected through easy processing.

### (2) Second Method

FIG. 4B schematically illustrates an example of a selection process of association settings to be activated by a second method according to the present embodiment. The preconditions in FIG. 4B are the same as those in FIG. 4A, and the example in FIG. 4B also assumes the same situation as in FIG. 4A.

In the second method, an association setting with the second object WA that was involved in the most recent authentication of the first object VA (first object VA1) may be selected as the association setting to be activated. That is to say, the status information ST10 may include a report of the execution result of the authentication processing performed by the second terminal 5 with respect to the first object VA (first object VA1). In accordance with this, activating the setting of one correlative relation may be constituted of activating the setting of the correlative relation with the second object WA corresponding to the second terminal 5 that most recently reported the execution result of the authentication processing with respect to the first object VA (first object VA1).

In the example in FIG. 4B, out of the second objects WA1 to WA3, the second terminal 5 of the second object WA1 was involved in the most recent authentication processing of the first object VA1, and the status information ST10 includes information indicating that this authentication was successful. In accordance with this, the association settings of the first object VA1 may be updated such that an active association setting is established with the second object WA1, and the state of the association setting with the second object WA2 changes from active to non-active.

Note that the authentication processing for the first object VA (first object VA1) may be executed by at least one of the first terminal 4 and the second terminal 5 as the origin. In the example in FIG. 2, the second terminal 5 of the mobile body (second object WA) may perform authentication of the user (first object VA) by methods such as performing facial authentication using an image sensor provided in the mobile body, using a fingerprint reader attached to a steering wheel to perform fingerprint authentication, having the user speak and performing voiceprint authentication using a microphone provided in the mobile body, and so forth. Note that, however, that the method for authenticating is not limited to these examples, and may be selected as appropriate in accordance with the form of implementation. A known method may be employed as the authentication method.

The authentication processing may be executed by at least one of the first terminal 4 and the second terminal 5, as long as the second terminal 5 is involved in the authentication processing. Also, at least a part of the authentication processing may be executed by at least one of the management server 1 and an external server (e.g., the first server 2). The second terminal 5 being involved in the authentication processing may include that the second terminal 5 executes at least a part of the authentication processing, and that the authentication process is executed by another computer (e.g., the first terminal 4, the management server 1, the first server 2), but that the second terminal 5 executes information processing related to the authentication processing (for example, exchanging data with the first terminal 4). The second terminal 5 may induce the authentication processing.

The status information ST10 may be transmitted toward the management server 1 from at least one of the first terminal 4 and the second terminal 5. In one example, when at least one of the first terminal 4 and the second terminal 5 executes the authentication processing, the status information ST10 may be transmitted from, of the first terminal 4 and the second terminal 5, the one terminal that has completed the authentication processing, or may be transmitted from another terminal different from the one terminal. When transmitting the status information ST10 from another terminal, completion of the authentication processing may be notified from one terminal to the other terminal by any method. In another example, after the status information ST10 is transmitted from at least one of the first terminal 4 and the second terminal 5, at least one of the management server 1 and the external server may execute at least a part of the authentication processing. In this case, the status information ST10 may be in an incomplete state at a stage of being transmitted from at least one of the first terminal 4 and the second terminal 5. The status information ST10 may be configured to indicate the authentication result of the first object VA after the authentication process is completed, by at least one of the management server 1 and the external server executing at least a part of the authentication processing.

Further, any transmission trigger may be employed, in the same way as in the first method. In one example, at least one of the first terminal 4 and the second terminal 5 may execute information processing related to authentication processing as unprompted information processing accompanying the association request, and transmit the status information ST10 toward the management server 1. Executing information processing related to authentication processing may include that at least one of the first terminal 4 and the second terminal 5 executes the authentication processing of itself, and that an external computer (e.g., management server 1, first server 2) is commissioned to perform the authentication processing. In another example, at least one of the first terminal 4 and the second terminal 5 may execute information processing related to authentication processing in response to an inquiry from the management server 1, and transmit the status information ST10 toward the management server 1 as a reply to the inquiry. According to an example of the present embodiment, the individual of the second object WA, regarding which a usage relation is currently being generated with the relevant individual of the first object VA, can be appropriately identified, due the authentication processing of the first object VA being performed in conjunction. Thus, appropriate association settings can be anticipated to be activated.

### (3) Third Method

FIG. 4C schematically illustrates an example of a selection process of association settings to be activated by a third method according to the present embodiment. The preconditions in FIG. 4C are the same as those in FIG. 4A, and the example in FIG. 4C also assumes the same situation as in FIG. 4A.

In the third method, the association setting to be activated may be selected in accordance with a positional relationship between the first individual of the first object VA (first terminal 4) and each individual of the second object WA (each second terminal 5). That is to say, each first terminal 4 may include a positioning module 47. Each second terminal 5 may include a positioning module 57. A positioning module 47 is an example of a first positioning module. A positioning module 57 is an example of a second positioning module. The status information ST10 may include a first current position measured by the positioning module 47 of the first terminal 4 corresponding to the first object VA (first object VA1/first individual of the first object VA), and second current positions measured by the positioning modules 57 of the second terminals 5 corresponding to each of two or more second objects WA (each individual of second object WA). In accordance with this, activating the setting of one correlative relation may be constituted of setting to active the setting of a correlative relation with a second object WA, of which the second current position of the corresponding second terminal 5 satisfies the conditions for the usage relation with the first current position of the first terminal 4.

Conditions for the usage relation may be set as appropriate. In one example, the conditions for the usage relation may be defined by a range DR of distance as to the first current position as a reference. In this case, whether the conditions for the usage relation are satisfied may be determined in accordance with whether there is a presence thereof within the range DR. In the example in FIG. 4C, out of the second objects WA1 to WA3, the second terminal 5 of the second object WA1 is present within the range DR of which the first terminal 4 (first current position) of the first object VA1 is a reference. The status information ST10 may include at least the first current position of the first terminal 4 of the first object VA1 and the second current position of the second terminal 5 of the second object WA1, the presence of the second terminal 5 of the second object WA1 within the range DR may be determined as appropriate. In accordance with this, the association settings of the first object VA1 may be updated such that an active association setting is established with the second object WA1, and the state of the association setting with the second object WA2 changes from active to non-active.

Note that the range DR may be set as appropriate, so as to be able to determine the second object WA with which a usage relation has been generated. The shape of the range DR may be optionally defined. The range DR may be defined such that the distances in each direction are the same, or may be defined such that the distances are different in at least a part of the directions.

The type of the positioning modules (47, 57) is not limited in particular, and may be selected as appropriate in accordance with the form of implementation. The positioning modules (47, 57) may be, for example, Global Positioning System (GPS) modules, global navigation satellite system (GNSS) modules, or the like.

Information regarding each current position (status information ST10) may be transmitted from each first terminal 4 and each second terminal 5 toward the management server 1 at any timing. In one example, each terminal (4, 5) of each object (VA, WA) regarding which association settings have been established may report information regarding each current position toward the management server 1, as unprompted information processing, such as periodic transmission or the like. In this case, the management server 1 may determine the second object WA that satisfies the conditions for the usage relation from the most-recently reported current position information. Also, in another example, the management server 1 may directly or indirectly transmit a request to each terminal (4, 5) at any timing before executing the arbitration processing. In accordance with this request, each of the terminals (4, 5) may report information regarding the most-recent current position toward the management server 1 in real time. The management server 1 may determine the second object WA that satisfies the conditions for the usage relation from each most-recent current position information that is reported in real time. Note that regardless of the form of implementation, there are cases in which a second terminal 5 that does not report (respond with) the second current position, due to the power of the second terminal 5 being off or the like. In this case, the second object WA corresponding to the second terminal 5 regarding which the most-recent second current position has not been reported may be determined not to satisfy the conditions for the usage relation, and in accordance with this, the correlative relation as to the second object WA may be set to non-active.

Also, a report destination to which information regarding each current position is reported may be selected as appropriate in accordance with the form of implementation. In one example, the report destination for information regarding each current position may be the management server 1. In accordance with this, information regarding each current position may be managed by the management server 1. In another example, the report destination for information regarding each current position may be an external server (first server 2, second server 3, or the like). In accordance with this, information regarding each current position may be managed by the external server. The management server 1 may acquire information regarding each current position (status information ST10) from an external server. Reporting towards the management server 1 may include reporting directly to the management server 1, and indirectly reporting to the management server 1 via an external server. The reported current position information may be discarded after it is no longer used for arbitration processing, or may be stored as history for at least a predetermined period of time. When employing a form of directly reporting to the management server 1, the information regarding each current position may be stored in the management server 1 or stored in an external server (first server 2, second server 3, NAS, or the like). In the same way, when employing a form of indirectly reporting to the management server 1, the information regarding each current position may be stored in the management server 1 or stored in an external server. According to an example of the present embodiment, using the position information enables the individual of the second object WA with which the relevant individual of the first object VA is currently in a usage relation to be appropriately identified. Thus, appropriate association settings can be anticipated to be activated.

### Locking of Active Settings

For example, in the situation in FIG. 2, it is assumed that an active correlative relation is set between the relevant individual of the first object VA (relevant user) and the one individual of the second object WA, which is a mobile body for public transportation. In this situation, it is undesirable for an event to occur in which, even though payment of fares for the mobile body for public transportation has not been completed, the relevant individual (the relevant individual of the first object VA) resolves the active correlative relation with the relevant individual of the mobile body (one individual of the second object WA) (making non-active or termination) based on using another mobile body (another individual of second object WA), and establishes a new active correlative relation setting with the other mobile body. In this way, when the relevant individual of the second object WA is a predetermined type, there are cases in which rejecting establishing an active correlative relation setting with another individual of the second object WA, until a predetermined condition is satisfied (completion of payment of fares in the above example) is desirable.

Therefore, in an example of the present embodiment, the management server 1 may be configured to further execute, after establishing an active correlative relation setting with a second object WA of a first predetermined type (one individual of the second object WA), locking of the setting of an active correlative relation until a predetermined condition is satisfied, thereby prohibiting the first object VA (relevant individual of the first object VA) with which the active correlative relation has been set from establishing another active correlative relation setting with another second object WA (another individual of second object WA).

Establishing an active correlative relation setting with the second object WA of the first predetermined type may include establishing a new association setting in an active state with the relevant individual of the second object WA, and changing the state of the association setting with the relevant individual of the second object WA from non-active to active. Prohibiting the establishment of another active correlative relation setting may include prohibiting the establishment of a new association setting in an active state with another individual of the second object WA, and prohibiting a change in the state of association settings with other individuals of the second object WA from non-active to active. Establishing a new association setting with another individual of the second object WA in a non-active state may or may not be permitted.

The predetermined condition may be set as appropriate in accordance with the form of implementation. Also, whether the predetermined condition is satisfied may be sensed as appropriate. In a simple example, satisfaction of the predetermined condition may be sensed by a notification from the second terminal 5 corresponding to the relevant individual of the second object WA of the first predetermined type. In the above example, when the payment of fares is completed, the second terminal 5 of the relevant individual of the mobile body may transmit a notification to the management server 1, indicating completion of payment of fares (satisfying predetermined condition). The management server 1 may recognize that the predetermined condition is satisfied by receiving this notification. Note that the management server 1 may also execute such locking processing on other types of second objects WA besides the first predetermined type, or execution of the locking processing may be omitted for other types of second objects WA.

FIG. 5 schematically illustrates an example of a situation in which active association settings are locked according to the embodiment. In the example in FIG. 5, a second object WA4 is an example of a second object WA of the first predetermined type. The first object VA1 is an example of a first object VA that has established an active correlative relation setting with one individual of the second object WA of the first predetermined type. A second object WA5 is an example of another second object WA (another individual of the second object WA) that attempts to establish an active correlative relation setting with the first object VA1.

In the example in FIG. 5, the management server 1 may lock the setting of the correlative relation between the first object VA1 and the second object WA4 until a predetermined condition is satisfied. When an association request is accepted from at least one of the first terminal 4 of the first object VA1 and the second terminal 5 of the second object WA5 during this locked period, the management server 1 may disregard the association request and not permit the establishment of an active correlative relation setting with the second object WA5 in accordance with the association request. In this case, the management server 1 may transmit a notification indicating that setting of other active correlative relations is prohibited, either directly or indirectly, to at least one of the first terminal 4 of the first object VA1 and the second terminal 5 of the second object WA5.

The management server 1 may terminate the locked state of the correlative relation setting with the second object WA in accordance with to sensing satisfaction of the predetermined condition. Thus, the management server 1 may permit the establishment of an active correlative relation setting between the second object WA and other individuals. When an association request is accepted from at least one of the first terminal 4 of the first object VA1 and the second terminal 5 of the second object WA5 after terminating the locked state, the management server 1 may establish an active correlative relation setting with the second object WA5, in accordance with the association request. In accordance with one example of the present embodiment, in situations in which establishing other active correlative relation settings is inappropriate, such other active correlative relation settings that are established can be locked, thereby enabling prohibition of establishment of such other active correlative relation settings.

Note that the first predetermined type may be selected as appropriate in accordance with the form of implementation. In one example, the first object VA may be a user. The second object WA of the first predetermined type may be a mobile body for public transportation. The predetermined condition may be that the payment (payment of fares) for the use of the mobile body for public transportation is completed. According to an example of the present embodiment, when fares for a mobile body for public transportation is unpaid, transferring to another mobile body (establishing an active correlative relation setting with the other mobile body) can be prohibited.

### Confirmation Processing for Continued Use

As one of optional configurations, after setting the correlative relation between the relevant individual of the first object VA and the relevant individual of the second object WA, the management server 1 may further execute processing for confirming whether this correlative relation is continuing (confirmation processing). The confirmation method for continued use may be selected as appropriate in accordance with the form of implementation.

In one example, the continuation of the correlative relation may be confirmed by authenticating at least one of the first object VA and the second object WA via at least one of the first terminal 4 and the second terminal 5. The authentication method may be performed using any method, in the same way as with the association setting and so forth. In the example in FIG. 2, for example, the user may be authenticated by methods such as performing facial authentication of the user using an image sensor provided in the mobile body, using a fingerprint reader attached to a steering wheel to perform fingerprint authentication of the user, having the user speak and performing voiceprint authentication using a microphone provided in the mobile body, and so forth. The authentication processing may be executed by at least one of the terminals (4, 5), the servers (2, 3), and the management server 1. When executing the authentication processing at the servers (2, 3), the data to be used for authentication may be transmitted directly from the terminals (4, 5) to the servers (2, 3) or may be transmitted indirectly via an external computer such as the management server 1 or the like. When executing the authentication processing at the management server 1, the data to be used for authentication may be transmitted directly from the terminals (4, 5) to the management server 1 or may be transmitted indirectly via an external computer such as the servers (2, 3), or the like. The management server 1 may acquire an authentication result as appropriate. The management server 1 may determine that the correlative relation is continuing when the authentication result that is acquired indicates that authentication of the objects is successful, and determine that the correlative relation is not continuing when authentication is unsuccessful.

In another example, when at least one of the first object VA and the second object WA is a user (e.g., the case of FIG. 2), the management server 1 may directly or indirectly transmit a confirmation notification including an operator to at least one of the first terminal 4 and the second terminal 5. The operator may be made up of, for example, a confirmation button, a reply button, a link, or the like. A transmission destination of the confirmation notification does not necessarily have to correspond to the user. In the case of FIG. 2, the management server 1 may transmit the confirmation notification to at least one of the first terminal 4 and the second terminal 5. The transmission destination of the confirmation notification may be the same as or different from the transmission destination of the notification indicating the result of the processing relating to association. The confirmation notification may be configured so as to directly or indirectly reply with a response to the management server 1, in accordance with operation of the operator by the user. The management server 1 may determine that the correlative relation is continuing when the response by the operation of the operator is received within a predetermined period, and determine that the correlative relation is not continuing when no response is received.

In yet another example, when tracking the correlative relation between the first object VA and the second object WA in the real world, the terminals (4, 5) may include the positioning modules (47, 57), as in the example in FIG. 4C. The first terminal 4 may measure the current position of the first object VA (first terminal 4) using the positioning module 47, and the second terminal 5 may measure the current position of the second object WA (second terminal 5) using the positioning module 57. The terminals (4, 5) may transmit the current positions of the objects (VA, WA) that are obtained to the management server 1, directly, or indirectly via an external computer such as the servers (2, 3), or the like. The management server 1 may determine whether the correlative relation is continuing in accordance with whether the current positions of the objects (VA, WA) that are received are close enough to each other to satisfy a predetermined condition for the usage relation (e.g., the user is on board the mobile body). That is to say, the management server 1 may determine that the correlative relation is continuing when the current positions of the objects (VA, WA) are close enough to each other to satisfy the predetermined condition. Also, the management server 1 may determine that the correlative relation is not continuing when the current positions of the objects (VA, WA) are not close enough to each other to satisfy the predetermined condition. Note that when this form is employed, the management server 1 may store information regarding the current positions of the objects (VA, WA) that are obtained, in association with the association information D10. Thus, the management server 1 can track, along with the correlative relation of the objects (VA, WA), the movement history of the objects (VA, WA) as well. Also, at least part of the above processing may be executed by a computer other than the management server 1.

When determining that the correlative relation is continuing, the management server 1 may maintain the state of the setting of the correlative relation (e.g., may maintain in an active state). On the other hand, when determining that the correlative relation is not continuing, the management server 1 may terminate the correlative relation or change the state of the correlative relation from active to non-active. The management server 1 may be configured to repeat the confirmation processing periodically or non-periodically after the correlative relation is set until the correlative relation is terminated, so as to update the state of the correlative relation.

### Association Termination

In the present embodiment, the management server 1 may be configured to terminate (invalidate or make non-active) the correlative relation upon receiving a termination request from at least one of the first terminal 4 and the second terminal 5, or when a predetermined termination condition is satisfied.

### I. Termination Request

In one example, the termination request may be configured to include at least one of the first identifier I10 and the second identifier I20, and thereby indicate the correlative relation of the termination objects. In another example, the termination request may be configured to include alternative information to indicate the correlative relation of the termination objects.

When the first terminal 4 transmits a termination request including the second identifier I20, the first terminal 4 may acquire the second identifier I20 at any timing. In one example, at the time of the association request, the first terminal 4 may acquire the second identifier I20, and may store the second identifier I20 that is acquired in a memory resource. At the time of the termination request, the first terminal 4 may acquire the second identifier I20 from the memory resource. Also, when the first terminal 4 transmits a termination request including the first identifier I10, the first terminal 4 may acquire the first identifier I10 at any timing. In one example, the first identifier I10 may be stored in the memory resource in advance. The first terminal 4 may acquire the first identifier I10 from the memory resource.

Similarly, when the second terminal 5 transmits a termination request including the first identifier I10, the second terminal 5 may acquire the first identifier I10 at any timing. In one example, at the time of the association request, the second terminal 5 may acquire the first identifier I10, and may store the first identifier I10 that is acquired in a memory resource. At the time of the termination request, the second terminal 5 may acquire the first identifier I10 from the memory resource. Also, when the second terminal 5 transmits a termination request including the second identifier I20, the second terminal 5 may acquire the second identifier I20 at any timing. In one example, the second identifier I20 may be stored in the memory resource in advance. The second terminal 5 may acquire the second identifier I20 from the memory resource.

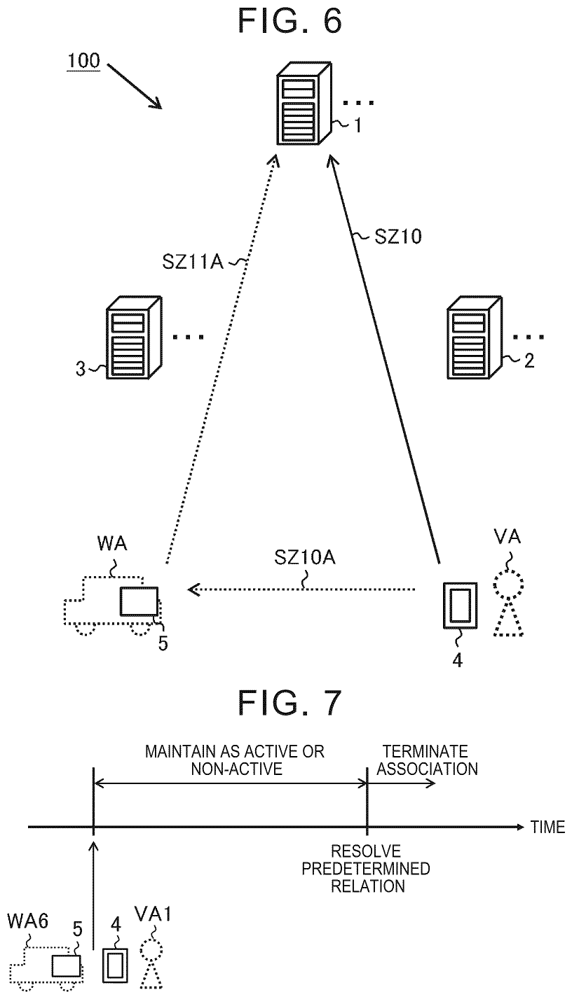

FIG. 6 schematically illustrates an example of a process of association termination according to the present embodiment. In the example in FIG. 6, the first terminal 4 directly transmits a termination request to the management server 1, as a first route (step SZ10). Also, as a second route, the first terminal 4 provides an instruction to the second terminal 5 (step SZ10A), and causes the second terminal 5 to directly transmit the termination request to the management server 1 (step SZ11A). Note, however, that the transmission routes of the termination requests do not have to be limited to such an example. The first terminal 4 may indirectly transmit the termination request to the management server 1 via an external computer such as the first server 2 or the like. On the second route, the second terminal 5 may indirectly transmit the termination request to the management server 1 via an external computer such as the second server 3 or the like. Note that the origin of the termination request does not have to be limited to the first terminal 4. In another example, the second terminal 5 may directly or indirectly transmit the termination request to the management server 1. Also, the second terminal 5 may provide an instruction to the first terminal 4 and cause the first terminal 4 to directly or indirectly transmit the termination request to the management server 1. After receiving the termination request, the management server 1 references the association information D10, and terminates (invalidates or makes non-active) the correlative relation specified by the identifier included in the termination request. After this termination processing, the management server 1 may transmit a notification indicating results of the termination processing to at least one of the first terminal 4 and the second terminal 5, in the same way as at the time of the association setting.

The trigger for the termination request may be set as appropriate in accordance with the form of implementation. In one example, when at least one of the first object and the second object is a user, the termination request may be transmitted from at least one of the first terminal 4 and the second terminal 5 by a user operation on at least one of the first terminal 4 and the second terminal 5. That is to say, the trigger for the termination request may be a user operation. In another example, at least one of the first terminal 4 and the second terminal 5 may execute any information processing in conjunction with dissolution of the usage relation. Execution of this information processing may trigger the transmission of the termination request from at least one of the first terminal 4 and the second terminal 5. For example, the any information processing may be data exchange between the first terminal 4 and the second terminal 5. The method of exchanging data when terminating the association may be the same as the method of exchanging data for association setting. Whether the data exchange is data exchange at the time of association setting or data exchange at the time of association termination may be distinguished as appropriate. For example, in the example in FIG. 2, the second terminal 5 may include separate sensor devices at an entrance and an exit, as in the case of some bus doors, railway ticket gates, and so forth. In this case, whether the data exchange is data exchange at the time of association setting or data exchange at the time of association termination may be distinguished in accordance with the sensor device used for data exchange. Also, for example, when the data exchange is to be executed by an application of a terminal, the application may be configured to be switchable between an association setting mode and an association termination mode. In this case, whether the data exchange is data exchange at the time of association setting or data exchange at the time of association termination may be distinguished in accordance with the mode of the application.

Further, in one example, when a termination request for the correlative relationship is accepted while the settings of the correlative relation are locked by the locking processing, the management server 1 may reject the received termination request. The management server 1 may directly or indirectly transmit a notification indicating that termination of the correlative relation is prohibited, to at least one of the first terminal 4 and the second terminal 5. On the other hand, after the locking is terminated due to satisfaction of a predetermined condition, the management server 1 may accept the termination request and terminate the correlative relation. For example, the management server 1 may sense satisfying of a predetermined condition, in accordance with the above usage relation being dissolved. In one example, the termination request may include information indicating satisfaction of a predetermined condition. In another example, information indicating satisfaction of a predetermined condition may be transmitted to the management server 1 prior to the termination request. Accordingly, the management server 1 may accept the termination request that is transmitted in response to the dissolution of the usage relationship, and terminate (invalidate or make non-active) the correlative relation specified by the termination request.

Note that there are cases in which non-active correlative relations are maintained between the relevant individual of the first object VA and one or more other individuals of the second object WA. In this case, in accordance with invalidation or non-activation of the correlative relation specified in the termination request, the management server 1 may activate one correlative relation out of the non-active correlative relations with the one or more other individuals of the second object WA, maintained with respect to the same individual of the first object VA. The correlative relation to be activated may be decided in accordance with the degree of priority, type (for example, whether a constant usage item or temporary usage item), and so forth, of each individual of the second object WA. In the example of FIG. 2 as a specific example, assumption will be made that a first mobile body is a constant usage item (e.g., a private car) and a second mobile body is a temporary usage item (e.g., a rental car, a shared car, a mobile body for public transportation, or the like). In this case, the management server 1 may accept the setting of the correlative relation between the object user and the second mobile body while the correlative relation between the object user and the first mobile is set, and in accordance with this accepting, may change the state of the previous correlative relation (correlative relation with the first moving body) to non-active. Then, in accordance with the correlative relation with the second mobile body (temporary usage item) being invalidated or made non-active, the management server 1 may activate the correlative relation between the first mobile body (constant usage item) and the object user. Thus, the setting of the active correlative relation with the constant usage item can be quickly recovered.

### I-1. Maintaining Association Setting

When making a termination request, whether to terminate (invalidate) the relevant association setting or to change the state of the association setting to non-active may be selected as appropriate. However, in particular situations, there are cases in which it is efficient to select maintaining the association setting in an active or non-active state, rather than selecting to terminate (invalidate) the association setting. For example, in the situation in FIG. 2, when the relevant individual of the second object WA is a private car, the relevant individual of the second object WA is repeatedly used by the first object VA (user). Therefore, processing may be able to be made more efficient by handling the situation through switching between active and non-active states, rather than repeating the generating and dissolution of correlative relations each time they are used.

Therefore, in an example of the present embodiment, the management server 1 may be further configured such that, when a predetermined relation holds between the first object VA and the second object WA for which a correlative relation has been set, the correlative relation may be maintained in an active or non-active state without being terminated (invalidated) until the predetermined relation is resolved, and the correlative relation may be terminated after the predetermined relation is resolved. Terminating (invalidating) a correlative relation may include terminating the correlative relation in accordance with the predetermined relations being resolved, and terminating the correlative relation in accordance with accepting a termination request after the predetermined relation has been resolved.

FIG. 7 schematically illustrates an example of a situation in which association settings according to the present embodiment are maintained in an active or non-active state. The first object VA1 and a second object WA6 are examples of the first object VA and the second object WA with which a predetermined relation holds. In the example in FIG. 7, the management server 1 may maintain the setting of the correlative relation between the first object VA1 and the second object WA6 in an active or non-active state, while the predetermined relation holds. On the other hand, after the predetermined relation is resolved, the management server 1 may terminate (invalidate) the correlative relation between the first object VA1 and the second object WA6.

According to an example of the present embodiment, in a situation in which a predetermined relation holds, it can be anticipated that processing related to setting a correlative relation will be more efficient. Note that the predetermined relation that defines the objects for which the correlative relation is maintained may be set as appropriate, in accordance with the form of implementation. From the perspective of improving the efficiency of processing related to association setting, it is desirable that the predetermined relation be a relation that continues for a certain period of time, and that the predetermined relation be a relation in which a usage relation repeatedly is generated and dissolved during that period in which the relation is continuing.

In one example, the predetermined relation may be an ownership relation. That is to say, while the ownership relation between the first object VA and the second object WA holds, the setting of the correlative relation between the relevant individuals of the first object VA and the second object WA may be maintained, and after the ownership relation ends, the correlative relation may be terminated (invalidated). According to an example of the present embodiment, in a situation in which an ownership relation holds between a first object VA and a second object WA, it can be anticipated that processing related to setting of a correlative relation will be made more efficient.

The objects (VA, WA) regarding which a ownership relation holds are not limited in particular, and may be selected as appropriate in accordance with the form of implementation. In one example, the first object VA may be a user, and the second object WA may be a mobile body (e.g., a private car) owned by the user. According to an example of the present embodiment, in a situation in which a mobile body owned by a user appears, it can be anticipated that the processing related to setting the correlative relation will be made more efficient.

In another example, the first object VA may be a user, and the second object WA may be a mobile body (that is pertinent) of renting, that is rented by the user. The predetermined relation may be that the user rents the mobile body. That is to say, while the relevant individual of the mobile body is rented to the relevant user, the correlative relation setting between the relevant user and the relevant individual of the mobile body may be maintained, and after the rental period ends, the correlative relation may be terminated (invalidated). According to an example of the present embodiment, in a situation in which a mobile body that is rented by a user (e.g., a rental car) appears, it can be anticipated that the processing related to setting the correlative relation will be made more efficient.

Note that whether the predetermined relation holds may be differentiated as appropriate in accordance with the form of implementation. For example, there are cases in which it may be possible to differentiate from the attribute information whether the mobile body (second object WA) is an object, for which a predetermined relationship holds, such as a private car, a rental car, or the like. Accordingly, in one example, whether a predetermined relation holds may be determined from attribute information of at least one of the first object VA and the second object WA. The attribute information may be included in each object information (O10, O20). In another example, whether a predetermined relation holds may be determined from information (proprietary information, rental information, and so forth) provided from an external system. The external system may be one that is involved in a predetermined relation, such as for example, a terminal at a retail store, a terminal at a rental company, or the like. In yet another example, whether the predetermined relation holds may be determined in response to a notification from at least one of the first terminal 4 of the first object VA and the second terminal 5 of the second object WA.

Furthermore, the resolution of the predetermined relation may be sensed as appropriate in accordance with the form of implementation. In one example, the resolution of a predetermined relation may be sensed from information provided from an external system (information regarding changes in ownership relations, information regarding rental ending, and so forth). In another example, at least one of the first terminal 4 and the second terminal 5 of the first object VA and the second object WA, with which a predetermined relation holds, may transmit a notification to the management server 1 or an external server (first server 2, second server 3, and so forth) at the time of ending the predetermined relation, in order to make notification thereof. The management server 1 may sense that the predetermined relation has been resolved by receiving the notification or by referencing information regarding the external server.

### I-2. Termination of Association Setting

For example, in the situation in FIG. 2, there are cases in which repeated generation and dissolution of usage relations is rare, depending on the types of the first object VA and the second object WA, such as when the relevant individual of the second object WA is a mobile body for public transportation, or the like. In such cases, by choosing to terminate (invalidate) the association setting instead of selecting to maintain the association setting, the efficiency of memory resources used to maintain the association setting may be improved.

Accordingly, in an example of the present embodiment, the management server 1 may be further configured to terminate (invalidate) the correlative relation in accordance with detecting end of use of the second object WA, after having established a correlative relation setting with the second object WA of the second predetermined type. Ending of usage is an example of dissolution of the usage relation. The end of usage may be detected as appropriate in accordance with the form of implementation. In one example, in conjunction with the end of usage, any information processing may be executed on at least one of the first terminal 4 and the second terminal 5, and the execution of this information processing may be used as a trigger for at least one of the first terminal 4 and the second terminal 5 to transmit a termination request. The end of usage may be detected by this termination request.

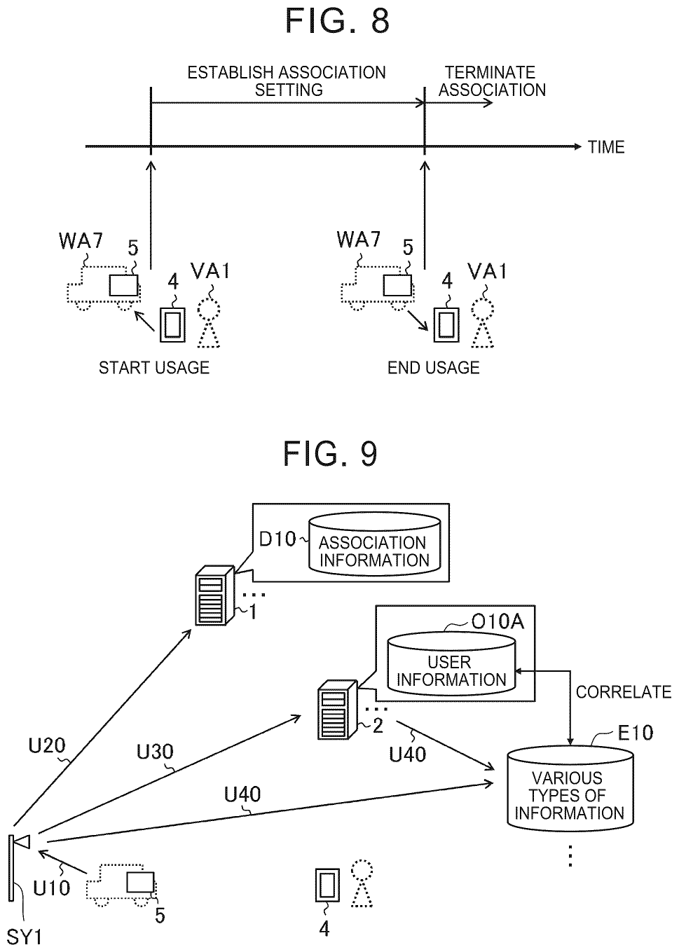

FIG. 8 schematically illustrates an example of a situation of executing association termination (invalidation) according to the present embodiment. In the example in FIG. 8, a second object WA7 is an example of the second object WA of the second predetermined type. The first object VA1 is an example of a first object VA that has established a setting of a correlative relation with the second object WA of the second predetermined type. In the example in FIG. 8, the first terminal 4 of the first object VA1 and the second terminal 5 of the second object WA7 may execute data exchange, in conjunction with starting of usage. At least one of the first terminal 4 and the second terminal 5 may transmit an association request toward the management server 1, with this data exchange as a trigger thereof. In the example in FIG. 8, a situation is assumed that the management server 1 established an active association setting between the first object VA1 and the second object WA7, in accordance with this association request. Thereafter, the first terminal 4 of the first object VA1 and the second terminal 5 of the second object WA7 may execute data exchange, in conjunction with ending of usage. At least one of the first terminal 4 and the second terminal 5 may transmit a termination request toward the management server 1, with this data exchange as a trigger thereof. In accordance with this termination request, the management server 1 may terminate (invalidate) the correlative relation between the first object VA1 and the second object WA7.

According to an example of the present embodiment, in a situation in which the second object WA is of the second predetermined type, it can be anticipated that the memory resources used to maintain the association settings will be made more efficient. Note that the second predetermined type may be selected as appropriate in accordance with the form of implementation. From the perspective of improving the efficiency of memory resources, the second predetermined type is preferably such that the frequency of an active correlative relation being set between the same individual in the second object WA and the same individual of the first object VA (i.e., that a usage relation is generated) is low.

In one example, the first object VA may be a user, and the second object WA may be a mobile body. The second object WA of the second predetermined type may be a mobile body for public transportation. That is to say, when a relevant user uses a relevant individual of the mobile body of public transportation, an active correlative relation setting may be established between the relevant individual of the mobile body and the relevant user. The correlative relation may be terminated (invalidated) in accordance with the end of use of the relevant individual of the mobile body for public transportation. According to an example of the present embodiment, it can be anticipated that the memory resources used to maintain the association setting will be made more efficient in a situation in which a mobile body for public transportation (e.g., a taxi or the like) appears.

### II. Termination Conditions

A termination condition indicates a condition for termination (to invalidate or make non-active) of the object correlative relation. The termination condition may be defined as appropriate in accordance with the form of implementation.

In one example, the termination condition may be defined to terminate the correlative relation at a termination time set optionally. The termination time may be provided, for example, by specification by the user or specification from another application (scheduler or the like), or the like. In this case, the management server 1 may terminate the correlative relation between the objects in accordance with the termination time arriving. The termination time may be set as the end of a term of validity of the association information D10. When the termination time is set as the end of the term of validity, the management server 1 may treat the correlative relation between the objects as being terminated in accordance with the termination time arriving.

In another example, in a case in which multiple correlative relation settings are duplicated for the same individual of the first object VA or the second object WA due to interruption of the correlative relation settings by at least one other individual of the first object VA and the second object WA, the termination condition may be defined to terminate one of the correlative relations that are duplicative. The number of active correlative relations (associations) that can be set for the same individual of the second object WA is not limited to one, and may be two or more. Furthermore, the number of correlative relations (associations) that can be maintained in a non-active state for the same individual of the first object VA may be infinite or finite. The management server 1 may terminate any of the previously set and maintained correlative relations when the number of duplicative settings of a correlative relation has exceeded a threshold value (upper limit). The threshold value may be provided as appropriate. Which correlative relation to be terminated may be decided as appropriate depending on the degree of priority, order, type of the object, and so forth. The management server 1 may transmit an inquiry regarding termination to at least one of the first terminal 4 and the second terminal 5, and decide the correlative relation to be terminated in accordance with a reply that is obtained.

For example, as in the example of FIG. 2, situation in which the first object VA is a user and the second object WA is a usage item will be assumed. In this case, the number of users that can be associated with the same usage item may be infinite or finite. When the number of users that can be associated is finite, the upper limit of the number of users that can be associated may be provided as appropriate by a threshold value. The threshold value may be set in accordance with the attribute of the usage item (e.g., passenger capacity). When a correlative relation setting for the relevant individual of the usage item is newly accepted, the management server 1 may reference the association information D10 and extract a previous correlative relation that has been set and maintained for the relevant individual of the usage item. When the newly accepted correlative relation settings cause the duplications of correlative relation settings for the relevant individual of the usage item to exceed the threshold value, the management server 1 may discard the correlative relation settings request that is newly accepted, or terminate (invalidate or make non-active) at least one of the previous correlative relations that was extracted. When terminating the previous correlative relation, the management server 1 may decide the correlative relation to be terminated in accordance with degree of priority, order (e.g., the earlier the correlative relation was set, the more likely the termination thereof), and so forth, of the user.

In the example of FIG. 2 as a specific example, assumption will be made that the mobile body is a private car, and the first user and the second user are, for example, a family or the like, that shares the object private car. The private car may be reread as “constant usage item.” For convenience of description, it is assumed that the number of users that can be associated with the object private car is one. In this case, in accordance with an active correlative relation being set between one of the first user and the second user and the private car that is the object, and a correlative relation setting between the other thereof and the private car that is the object being accepted while this correlative relation is set, the management server 1 may change the state of the previous correlative relation (the correlative relation between the one thereof and the private car that is the object) from active to non-active.

Further, the number of usage items that can be maintained associated with the same user in a non-active state may be infinite or finite. When the number of usage items with which association can be maintained is finite, the upper limit value of the number of these usage items may be provided as appropriate by a threshold value. When a new correlative relation setting for the object user is accepted, the management server 1 may refer to the association information D10 and extract the previous correlative relation that has been set and maintained for the object user. When the number of duplicative correlative relation settings for the object user exceeds the threshold value due to a newly accepted correlative relation setting, the management server 1 may discard the request for the newly accepted correlative relation setting or terminate (invalidate) at least one of the previous correlative relations that was extracted. When terminating the previous correlative relation, the management server 1 may decide the correlative relation to be terminated in accordance with the degree of priority, the type (e.g., a constant usage item or a temporary usage item), and so forth, of the usage item.

Note that, in a case in which the correlative relation of the object is terminated in conjunction with a predetermined termination condition holds as well, the above form may be employed in which the correlative relation is not terminated (invalidated) and is maintained in an active or non-active state, until the predetermined relation is resolved. That is to say, when a predetermined relation holds, the management server 1 may select processing of changing the state of the specified correlative relation to non-active until the predetermined relation is resolved, as termination processing in conjunction with the predetermined termination conditions being satisfied. After the predetermined relation is resolved, the management server 1 may terminate the correlative relation.

### Situations of Use of Association Information

As described above, the association information D10 may be used in various situations. In one example, the association information D10 may be used to simply track the generation and dissolution of the relation between the first object VA and the second object WA.

In another example, when an active correlative relation is set between the first object VA and the second object WA, the association information D10 may be used to make at least part of authority associated with one of the first object VA and the second object WA to be exercisable by the other. For example, the management server 1 may be configured to further execute validating of exercise of authority related to the corresponding first object VA (correlative individual of first object VA) via the second object WA (relevant individual of second object WA) regarding which an active correlative relation has been set, in accordance with the establishment of the setting of the active correlative relation. In addition, the management server 1 may be configured to further execute invalidating of exercise of authority correlated with the corresponding first object VA via the second object WA regarding in which non-active correlative relation has been set, in accordance with the establishment of non-active correlative relation setting. In the example of FIG. 2, the association information D10 may be used in order that at least part of the authority associated with the user is exercisable by the mobile body, while the active correlative relation between the user and the mobile body is set. According to an example of the present embodiment, by switching the state of the correlative relation setting between active and non-active, permission and prohibition of exercising the authority associated with the first object VA can be controlled.

FIG. 9 schematically illustrates an example of the situation of use of the association information D10 according to the present embodiment. In FIG. 9, a situation is assumed in which the authority associated with the user is exercised by the mobile body in the example of FIG. 2. Also, the association information D10 is assumed to include the first identifier I10 and the second identifier I20, so as to be configured to indicate the first object VA (user) and the second object WA (mobile body) regarding which a correlative relation has been set. Further, a situation will be assumed in which user information is managed by the first server 2, and mobile body information is managed by the second server 3. An external system SY1 is installed at a location where various types of services are exercised (e.g., a parking lot or the like), and is configured to execute information processing to provide object services to a user that has object authority. The configuration and the services of the external system SY1 are not limited in particular, and may be selected as appropriate in accordance with the form of implementation.

In step U10, the external system SY1 may first acquire the second identifier I20 (mobile body identifier) from the object mobile body. The method for acquiring the second identifier I20 may be selected as appropriate in accordance with the form of implementation. In one example, the external system SY1 may acquire the second identifier I20 from the second terminal 5 by exchanging data with the second terminal 5. The data exchange method may be similar to that of the data exchange between the first terminal 4 and the second terminal 5. In another example, when the second identifier I20 is a vehicle registration number, the external system SY1 may acquire the second identifier I20 by capturing an image of a license plate with an image sensor, and analyzing the obtained image.

In step U20, the external system SY1 uses the second identifier I20 that is acquired as a query to inquire of the management server 1 whether there is a valid correlative relation on an object date and time with respect to the object mobile body. Valid means that the active correlative relation setting is maintained at the object date and time. Also, the object date and time is basically “current (immediate)” but is not limited thereto. For example, when executing settlement processing for a date and time in the past, the object date and time may be a date and time in the past. When there is a valid correlative relation, the first identifier I10 (user identifier) of the user associated with the object mobile body is extracted. Meanwhile, when there is no valid correlative relation, and the user associated with the object mobile body is not extracted, this processing may end.

In step U30, the external system SY1 uses the extracted first identifier I10 as a query to inquire of the first server 2 about exercisable authority for the user associated with the object mobile body. The first server 2 refers to the first object information O10 (user information O10A) and extracts exercisable authority correlated with the object user. When no exercisable authority is extracted, this processing may end. Note that in the first object information O10 (user information O10A), whether to permit exercise of the authority by the mobile body may be set for each authority. The exercisable authority may be extracted in accordance with this setting. This processing may end also when the object authority to be exercised by the external system SY1 is not included in the exercisable authority. The authority to be exercised may be specified as appropriate at any timing. In one example, the authority to be exercised may be specified by the external system SY1 in advance, or may be specified by the user.

In step U40, when the authority of the object is included in the exercisable authority, the external system SY1 may executes processing for exercising the authority of the object. Thus, the authority that is associated with the user is exercised by the mobile body, and the user can receive a service via the mobile body. For example, when the authority information includes information regarding public personal authentication and the object authority is related to public personal authentication, the user can receive a public service via the mobile body. Also, for example, when the authority information includes settlement information and the object authority is related to settlement, the user can receive a settlement service via the mobile body. The settlement service may be, for example, payment for use of a parking lot, toll fees for an expressway, a payment for a drive-through order, fares for public transportation, and payment of rental fees or the like. Also, for example, when the authority information includes information regarding an electronic prescription, and the object authority is reception of medication dispensed by the electronic prescription, the user can exercise the electronic prescription via the mobile body and receive the medication.

Note that, for example, when multiple users are using one individual of a mobile body, such as when multiple users are riding in the same vehicle, or the like, the user that exercises the authority may be selected as appropriate. In one example, a user that exercises authority may be selected by activating the correlative relation of one user among multiple users that use the same individual of the mobile body. In another example, the correlative relation among two or more users among multiple users that use the same individual of the mobile body may be set to be active. In this case, the method of exercising authority may be adjusted as appropriate among two or more users for which an active correlative relation has been set. For example, the authority of one or more selected users (representatives) may be exercised. The selection by the user may be performed by at least one of the external system SY1, the first terminal 4, and the second terminal 5. Also, for example, when the exercise of authority is payment of a price, authority of each user may be exercised according to predetermined rules. As a specific example, the payment amount may be equally allocated to each user, and the authority of each user may be exercised regarding the payment of the allocated amount. The amount allocated to each user may be specified as appropriate.

Also, in another example, a group may be set in advance among multiple users, and a degree of priority may be set for the members (users) within the group. For example, when a family uses a private car, one group may be set for one family, and the degree of priority may be set in accordance with relations within the family. As an example, a parent's degree of priority may be set high and a child's degree of priority may be set low. Information of the group and the degree of priority may be managed as appropriate using, for example, the first object information O10 (user information O10A) or the like. In accordance with this, out of the multiple users using the same individual of the mobile body, the correlative relation among two or more users in the same group may be set to be active. In this case, the authority of each user may be exercised in accordance with the degree of priority. For example, when a parent and a child are using a private car and the degree of priority of the parent is set high, the authority of the parent may be exercised. Exercising authority according to degree of priority may include selecting a user to exercise authority according to degree of priority (users with higher degree of priority are selected as objects to exercise authority), and deciding the proportionality of exercising authority in accordance with the degree of priority (e.g., the higher the degree of priority of the user is, the higher the payment amount allocated to the user will be, or the like).

Also, the processing procedures for exercising the authority is merely an example, and each step may be changed to the greatest extent possible. Regarding the processing procedures, steps can be omitted, substituted, or added as appropriate in accordance with the form of implementation. Also, in the processing procedure, the user may be replaced with the first object VA and the mobile body may be replaced with the second object WA. Further, in the processing procedure, the terms “first” and “second” may be interchanged.

Data Communication between Devices

The data communication between the devices (management server 1, first server 2, second server 3, first terminal 4, and second terminal 5) is not limited in particular, and may be selected as appropriate in accordance with the form of implementation. The network among the devices may be selected as appropriate from among, for example, the Internet, a wireless communication network, a mobile communication network, a telephone network, a private network, and a local area network. The data communication between the devices may be encrypted by a method such as Secure Socket Layer (SSL), Transport Layer Security (TLS), or the like. In one example, each terminal (4, 5) may include a subscriber identity module (SIM), and the data communication between each terminal (4, 5) and server (management server 1, first server 2, second server 3) may be performed by encrypted communication using the SIM.

### 2. CONFIGURATION EXAMPLES

### Hardware Configuration Examples

### Management Server

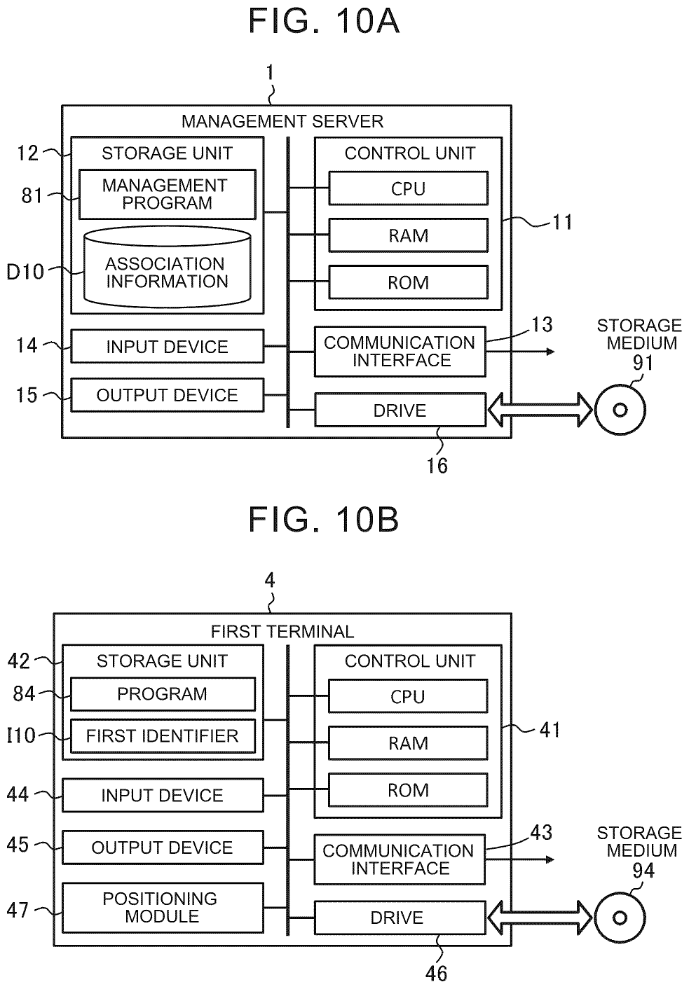

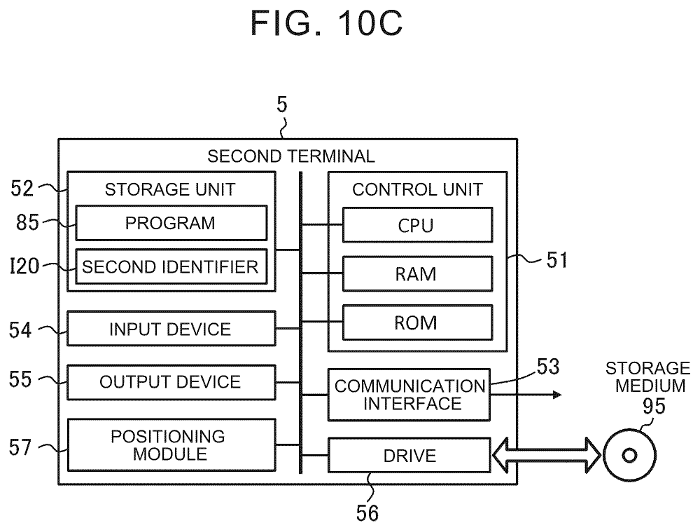

FIG. 10A schematically illustrates an example of the hardware configuration of the management server 1 according to the present embodiment. The management server 1 according to the present embodiment is a computer in which a control unit 11, a storage unit 12, a communication interface 13, an input device 14, an output device 15, and a drive 16 are electrically connected.

The control unit 11 includes a central processing unit (CPU) that is a hardware processor, a random access memory (RAM), a read only memory (ROM), etc., and is configured to execute any information processing based on programs and various types of data. The control unit 11 (CPU) is an example of a processor resource of the management server 1.

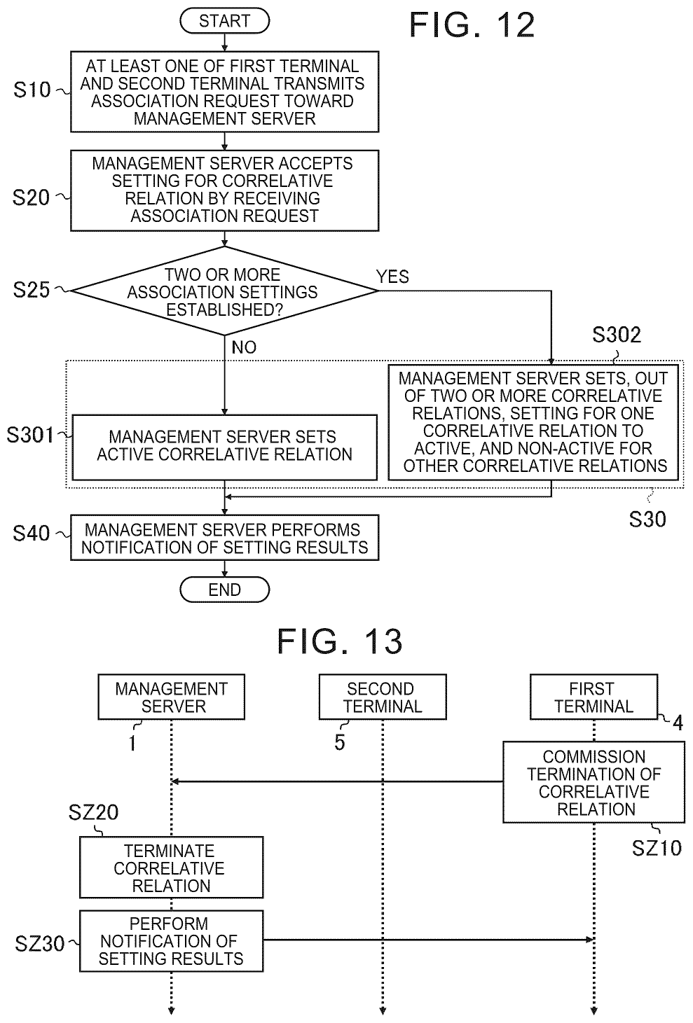

The storage unit 12 may be made up of, for example, a hard disk drive, a solid state drive, semiconductor memory, or the like. The storage unit 12 (and the RAM and the ROM) is an example of the memory resources. In the present embodiment, the storage unit 12 stores various types of information such as a management program 81, the association information D10, and so forth. The management program 81 is a program for causing the management server 1 to execute information processing (FIGS. 12 and 13 described later) related to the setting and termination of the correlative relation between the first object VA and the second object WA. The management program 81 includes a series of instructions for the information processing.

The communication interface 13 is configured to perform wired or wireless communication via a network. The communication interface 13 may be made up from, for example, a wired local area network (LAN) module, a wireless LAN module, or the like. The management server 1 may execute data communication among other computers (first server 2, second server 3, first terminal 4, second terminal 5) via the communication interface 13.

The input device 14 is a device for performing input, such as a mouse, a keyboard, operation buttons, and so forth, for example. The output device 15 is a device for performing output, such as a display, a speaker, or the like, for example. An operator can operate the management server 1 by using the input device 14 and the output device 15. The input device 14 and the output device 15 may be an integrally-configured device, such as a touch panel display or the like, for example. The input device 14 and the output device 15 may be connected via external interfaces. The external interface may be configured as appropriate to connect to an external device by wire or wirelessly, for example, using a Universal Serial Bus (USB) port, a dedicated port, a wireless communication port, or the like.

The drive 16 is a device for reading various types of information such as programs and so forth, stored in a storage medium 91. At least one of the management program 81 and the association information D10 may be stored in the storage medium 91 instead of in the storage unit 12, or in both the storage medium 91 and the storage unit 12. The storage medium 91 is configured to store various types of information (stored programs etc.) by electrical, magnetic, optical, mechanical, or chemical operations, so that a machine such as a computer or the like can read the information. The management server 1 may acquire at least one of the management program 81 and the association information D10 from the storage medium 91. Note that the storage medium 91 may be a disc storage medium such as a compact disc (CD), a digital versatile disc (DVD), or the like, or may be a storage medium other than disc storage media, such as semiconductor memory (e.g., flash memory) or the like. The type of the drive 16 may be selected as appropriate in accordance with the type of the storage medium 91. The drive 16 may be connected via an external interface.

Note that in the specific hardware configuration of the management server 1, components can be omitted, substituted, or added as appropriate, in accordance with the form of implementation. For example, the control unit 11 may include a plurality of hardware processors. The hardware processors may be made up of a microprocessor, a field-programmable gate array (FPGA), a digital signal processor (DSP), a graphics processing unit (GPU), an application specific integrated circuit (ASIC), and so forth. At least one of the input device 14, the output device 15, and the drive 16 may be omitted. The association information D10 may be stored not in the storage unit 12 but in an external computer (e.g., an NAS or the like) accessible by the management server 1. The management server 1 may be made up of a plurality of computers. In this case, the hardware configurations of the computers may or may not match each other. The management server 1 may be an information processing device designed exclusively for a service to be provided, or may be a general-purpose server device, a general-purpose computer, or the like.

### First Server and Second Server

The hardware configuration of each server (2, 3) may be the same as that of the management server 1. In one example, each server (2, 3) may be a computer to which a control unit, a storage unit, a communication interface, an input device, an output device, and a drive are electrically connected. The servers (2, 3) may be made up of one or more of computer devices. The processor resources of each server (2, 3) may be made up of one or more processors. The types of the processors may be selected as appropriate. The first object information O10 may be stored in at least one of the memory resources of the first server 2 and an external computer (such as an NAS) that the first server 2 can access. The second object information O20 may be stored in at least one of the memory resources of the second server 3 and an external computer (such as an NAS) that the second server 3 can access. In the hardware configuration of each server (2, 3), components can be omitted, substituted, or added as appropriate in accordance with the form of implementation. Each server (2, 3) may be an information processing device designed exclusively for the service provided, or may be a general-purpose server device, a general-purpose computer, or the like.

### First Terminal

FIG. 10B schematically illustrates an example of the hardware configuration of the first terminal 4 according to the present embodiment. The first terminal 4 according to the present embodiment is a computer to which a control unit 41, a storage unit 42, a communication interface 43, an input device 44, an output device 45, a drive 46, and a positioning module 47 are electrically connected. The control unit 41 to the drive 46 and a storage medium 94 of the first terminal 4 may be configured the same as each of the control unit 11 to the drive 16 of the management server 1, and the storage medium 91 thereof, respectively.

The control unit 41 (CPU) is an example of a processor resource of the first terminal 4, and the storage unit 42 (and RAM, ROM) is an example of the memory resources of the first terminal 4. In the present embodiment, the storage unit 42 stores various types of information such as a program 84, the first identifier I10, and so forth. The program 84 is a program that causes the first terminal 4 to execute information processing (FIGS. 12 and 13, described later) related to association. The program 84 includes a series of instructions for the information processing. At least one of the program 84 and the first identifier I10 may be stored in the storage medium 94 instead of in the storage unit 42, or in both the storage medium 94 and the storage unit 42. The first terminal 4 may acquire at least one of the program 84 and the first identifier I10 from the storage medium 94. The first terminal 4 may perform data communication among other computers (management server 1, first server 2, second server 3, second terminal 5, and so forth) via the communication interface 43. The first terminal 4 may be operated via the input device 44 and the output device 45.

Note that in the specific hardware configuration of the first terminal 4, components can be omitted, substituted, or added as appropriate in accordance with the form of implementation. For example, the control unit 41 may include a plurality of hardware processors. The hardware processors may be made up of a microprocessor, an FPGA, a DSP, a GPU, an ASIC, an electronic control unit (ECU), or the like. At least one of the input device 44, the output device 45, the drive 46, and the positioning module 47 may be omitted. The first identifier I10 does not have to be stored in the storage unit 42. The first identifier I10 may be acquired each time. To acquire data such as identifiers and information to be used for authentication, and so forth, the first terminal 4 may further include a data acquisition device such as a sensor, a reader device, or the like. The communication interface 43 may be made up of a plurality of types of modules. For example, the communication interface 43 may include a Near Field Communication module and a wireless communication module, and the first terminal 4 may perform data communication with the second terminal 5 via the Near Field Communication module, and may perform data communication with a server (management server 1, first server 2, second server 3) via the wireless communication module. The first terminal 4 may be made up of multiple computers. In this case, the hardware configurations of the computers may or may not match each other. The first terminal 4 may be an information processing device designed exclusively for a service to be provided, or may be a general-purpose computer, a terminal device (e.g., a smartphone or a tablet personal computer (PC)), or the like.

### Second Terminal

FIG. 10C schematically illustrates an example of the hardware configuration of the second terminal 5 according to the present embodiment. The second terminal 5 according to the present embodiment is a computer to which a control unit 51, a storage unit 52, a communication interface 53, an input device 54, an output device 55, a drive 56, and a positioning module 57 are electrically connected. The control unit 51 to the drive 56 and a storage medium 95 of the second terminal 5 may be configured similar to the control unit 11 to the drive 16 and the storage medium 91 of the management server 1, respectively.

The control unit 51 (CPU) is an example of a processor resource of the second terminal 5, and the storage unit 52 (and RAM, ROM) is an example of the memory resources of the second terminal 5. In the present embodiment, the storage unit 52 stores various types of information, such as a program 85, the second identifier I20, and so forth. The program 85 is a program that causes the second terminal 5 to execute information processing (FIGS. 12 and 13, described later) related to association. The program 85 includes a series of instructions for the information processing. At least one of the program 85 and the second identifier I20 may be stored in the storage medium 95 instead of in the storage unit 52, or in both the storage medium 95 and the storage unit 52. The second terminal 5 may acquire at least one of the program 85 and the second identifier I20 from the storage medium 95. The second terminal 5 may perform data communication among other computers (management server 1, first server 2, second server 3, first terminal 4, and so forth) via the communication interface 53. The second terminal 5 may be operated via the input device 54 and the output device 55.

Note that in the specific hardware configuration of the second terminal 5, components can be omitted, substituted, or added as appropriate in accordance with the form of implementation. For example, the control unit 51 may include a plurality of hardware processors. The hardware processor may be made up of a microprocessor, an FPGA, a DSP, a GPU, an ASIC, an ECU, or the like. At least one of the input device 54, the output device 55, the drive 56, and the positioning module 57 may be omitted. The second identifier I20 does not have to be stored in the storage unit 52. The second identifier I20 may be acquired each time. To acquire data such as identifiers and information or the like to be used for authentication, the second terminal 5 may further include a data acquisition device such as a sensor, a reader device, or the like. The communication interface 53 may be made up of multiple types of modules, similar to the first terminal 4. The second terminal 5 may be made up of multiple computers. In this case, the hardware configurations of the computers may or may not match each other. The second terminal 5 may be an information processing device designed exclusively for a service to be provided, or may be a general-purpose computer, a terminal device, or the like.

### Software Configuration Examples

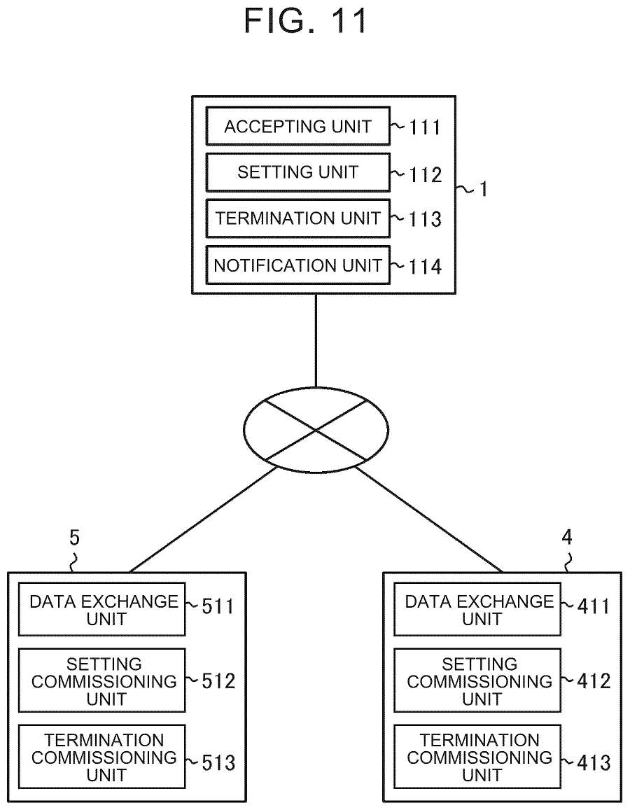

FIG. 11 schematically illustrates an example of the software configurations of the devices (management server 1, first terminal 4, and second terminal 5) according to the present embodiment.

### Management Server

The control unit 11 of the management server 1 loads the management program 81 stored in the storage unit 12 to the RAM, and executes the instructions included in the management program 81 by the CPU. Thus, the management server 1 operates as a computer including an accepting unit 111, a setting unit 112, a termination unit 113, and a notification unit 114 as software modules.

The accepting unit 111 is configured to receive, directly or indirectly, an association request from at least one of the first terminal 4 of the relevant individual of the first object VA and the second terminal 5 of the relevant individual of the second object WA, in accordance with a usage relation being generated between the relevant individual of the first object VA and the relevant individual of the second object WA. The accepting unit 111 is configured to accept the setting of a correlative relation between the relevant individual of the first object VA and the relevant individual of the second object WA by receiving the association request.

The setting unit 112 is configured to execute setting processing for the accepted correlative relation. The setting processing may include setting a new active correlative relation between the relevant individual of the first object VA and the relevant individual of the second object WA specified in the association request, and changing the state of the correlative relation from non-active to active. There are cases in which, in accordance with the acceptance of correlative relation settings based on two or more association requests regarding the same individual of the first object VA, two or more correlative relation settings will be established with two or more individuals of the second object WA that differ from each other, with respect to the same relevant individual of the first object VA. The setting unit 112 is configured so as to, in this case, set one correlative relation setting of out of the two or more correlative relations to active, and to set the other correlative relation settings to non-active, in accordance with the status information ST10 obtained from at least one of the relevant individual of the first object VA and the two or more individuals of the second object WA.

The termination unit 113 is configured to execute termination processing for the correlative relation, in conjunction with a termination request being received from at least one of the first terminal 4 and the second terminal 5, or predetermined termination conditions being satisfied. The termination processing may include terminating (invalidating) the setting of the correlative relation and changing the state of the correlative relation to non-active.

The notification unit 114 is configured to transmit a notification, indicating results of having executed the correlative relation setting processing, to at least one of the first terminal 4 and the second terminal 5. The notification unit 114 is configured to transmit a notification, indicating results of having executed the correlative relation termination processing, to at least one of the first terminal 4 and the second terminal 5.

### First Terminal

The control unit 41 of the first terminal 4 executes the instructions included in the program 84 by the CPU. Thus, the first terminal 4 operates as a computer including a data exchange unit 411, a setting commissioning unit 412, and a termination commissioning unit 413, as software modules. The data exchange unit 411 is configured to execute data exchange with the second terminal 5. The setting commissioning unit 412 is configured to transmit an association request (association setting commission) toward the management server 1. The termination commissioning unit 413 is configured to transmit a termination request (association termination commission) toward the management server 1.

### Second Terminal

The control unit 51 of the second terminal 5 executes the instructions included in the program 85 by the CPU. Thus, the second terminal 5 operates as a computer including a data exchange unit 511, a setting commissioning unit 512, and a termination commissioning unit 513, as software modules. The data exchange unit 511 is configured to execute data exchange with the first terminal 4. The setting commissioning unit 512 is configured to transmit an association request (association setting commission) toward the management server 1. The termination commissioning unit 513 is configured to transmit a termination request (association termination commission) toward the management server 1.

### Others

The present embodiment illustrates an example in which each software module of each device is realized by a general-purpose CPU. However, part or all of the software modules may be realized by one or more dedicated processors. Each of the modules may be implemented as a hardware module. In the software configuration of each device, modules may be omitted, substituted, or added as appropriate in accordance with the form of implementation. For example, when employing a form in which an association request is transmitted from only one terminal of the first terminal 4 and the second terminal 5, the setting commissioning unit may be omitted from the other terminal. In the same way, when employing a form in which a termination request is transmitted from only one terminal of the first terminal 4 and the second terminal 5, the termination commissioning unit may be omitted from the other terminal.

### 3. OPERATION EXAMPLES

### Association Setting

FIG. 12 shows an example of processing procedures of the association setting by the system 100 according to the present embodiment. The following processing procedures are an example of the information processing method to be executed by the computer. Of the following processing procedures, the processing procedures of the management server 1 are an example of the management method to be executed by the computer.

In step S10, in accordance with a usage relation between the relevant individuals of the first object VA and the second object WA being generated, at least one of the control unit 41 of the corresponding first terminal 4 and the control unit 51 of the second terminal 5 transmits an association request toward the management server 1. In one example, in accordance with a usage relation being generated, the control unit 41 of the corresponding first terminal 4 may operate as the data exchange unit 411, and execute data exchange with the corresponding second terminal 5. The control unit 51 of the second terminal 5 may operates as the data exchange unit 511, and execute data exchange with the first terminal 4. The control unit 41 of the first terminal 4 may operate as the setting commissioning unit 412, and transmit an association request toward the management server 1, with this data exchange as a trigger. The control unit 51 of the second terminal 5 may operate as the setting commissioning unit 512, and transmit an association request toward the management server 1. The association request may be transmitted directly to the management server 1, or may be transmitted indirectly via an external computer (first server 2, second server 3, or the like).

In step S20, the control unit 11 of the management server 1 operates as the accepting unit 111, and directly or indirectly receives an association request from at least one of the first terminal 4 of the relevant individual of the first object VA and the second terminal 5 of the relevant individual of the second object WA. Upon receiving this association request, the control unit 11 accepts the setting of the correlative relation between the relevant individual of the first object VA and the relevant individual of the second object WA.

Note that in step S10, when employing a form in which association requests are transmitted from both the first terminal 4 and the second terminal 5, one association request may be transmitted from the first terminal 4 and the second terminal 5 in parts, or identical association requests may be transmitted. When transmitting in parts, part of the data of the association request may be transmitted from the first terminal 4, and the remaining data may be transmitted from the second terminal 5. In step S20, in order to identify the combination of the relevant individuals of the first object VA and the second object WA that are currently requesting the setting of the correlative relation, the management server 1 may identify the correlation of this data as appropriate (i.e., the combination of corresponding data is differentiated).

The correlation of data may be identified by any method. In one example, the data transmitted from the terminals (4, 5) to the management server 1 via the servers (2, 3) may include shared information for identifying the correlation of data. The shared information may be made up of information having a relationship of, for example, agreement, a correlative relation holding, and so forth. In accordance with a relationship holding between shared information included in the data received from one of the first terminal 4 and the second terminal 5, and shared information included in the data received from the other, the management server 1 may identify correlation of data.

The shared information may have any configuration. In one example, the shared information may be made up of a combination of the first identifier I10 and the second identifier I20. In accordance with the combination of identifiers (I10, I20) included in the data received from the first terminal 4, matching the combination of identifiers (I10, I20) included in the data received from the second terminal 5, the management server 1 may identify correlation of data. In another example, the shared information may be made up of temporary information such as random numbers, timestamps, hash values, and the like. In this case, in accordance with a relationship holding between temporary information included in the data received from the first terminal 4 and temporary information included in the data received from the second terminal 5, the management server 1 may identify correlation of data. Note that the shared information may be shared between the first terminal 4 and the second terminal 5 at any timing. In a typical example, the first terminal 4 and the second terminal 5 may share the shared information when exchanging data.

In step S25, the control unit 11 of the management server 1 operates as the setting unit 112, and in accordance with accepting correlative relation settings based on two or more association requests regarding the same individual of the first object VA, determines whether two or more correlative relation settings are established with two or more individuals of the second object WA that differ from each other, with respect to the same relevant individual of the first object VA. In one example, the control unit 11 references the association information D10, and thereby determines whether active already-existing association settings exist for another individual of the second object WA, with respect to the relevant individual of the first object VA specified in the association request that is accepted. When there is no active existing association setting for the second object WA with another individual, the control unit 11 advances the processing to step S301. On the other hand, when there is an active existing association setting, the control unit 11 advances the processing to step S302.

In step S301, the control unit 11 operates as the setting unit 112, and, with respect to the relevant individuals of the first object VA and second object WA specified by the association request, establishes new active correlative relation settings therebetween, or updates the association information D10 to change the state of the existing correlative relation to active. Updating the association information D10 for establishing a new correlative relation setting may be constituted by generating corresponding new association information D10. Updating the association information D10 in response to changing the state of the correlative relation to active may be constituted by recording information indicating the change to active. In one example, when the association information D10 has the configuration shown in FIG. 3A, the control unit 11 may change the state of the correlative relation to active, by storing a value indicating active in a state field of the corresponding association information D10. When the association information D10 is configured on a blockchain platform, the control unit 11 may generate a transaction indicating a change in the correlative relation to active, and add the generated transaction to the blockchain, thereby changing the state of the correlative relation to active. After updating the association information D10, the control unit 11 advances the processing to the next step S40.

On the other hand, in step S302, the control unit 11 operates as the setting unit 112 and acquires the status information ST10. In accordance with the status information ST10, the control unit 11 updates the association information D10 so as to activate the setting of one correlative relation and make the settings of the other correlative relations to be non-active. In an example of the present embodiment, any one of the above three methods may be employed as a method for selecting an active correlative relation. The updating of the association information D10 for establishing a new correlative relation setting and changing the state of an existing correlative relation to active may be the same as described above. Updating the association information D10 in response to changing the state of the correlative relation to non-active may be constituted by recording information indicating the change to non-active. In one example, when the association information D10 has the configuration shown in FIG. 3A, the control unit 11 may change the state of the correlative relation to non-active, by storing a value indicating non-active in the state field of the corresponding association information D10. When the association information D10 is configured on a blockchain platform, the control unit 11 may generate a transaction indicating a change in the correlative relation to non-active, and add the generated transaction to the blockchain, thereby changing the state of the correlative relation to non-active. After updating the association information D10, the control unit 11 advances the processing to the next step S40. Note that the processing in step S301 and step S302 is an example of the correlative relation setting processing (step S30 described above) in accordance with the accepted association request.

In step S40, the control unit 11 operates as the notification unit 114 to transmit a notification indicating a result of the correlative relation setting processing that was executed, directly or indirectly, to at least one of the first terminal 4 and the second terminal 5. When the notification of the result is completed, the processing procedures related to the association setting according to the present operation example end.

Note that the above processing procedures is merely an example, and each step may be changed to the greatest extent possible. Also, regarding the above processing procedures, steps can be omitted, substituted, or added as appropriate in accordance with the form of implementation. For example, the association setting processing may include authentication processing for at least one of the first object VA and the second object WA.

### Association Termination

FIG. 13 shows an example of processing procedures for termination of the association by the system 100 according to the present embodiment. The following processing procedures are an example of the information processing method to be executed by the computer. Of the following processing procedures, the processing procedures of the management server 1 are an example of the management method to be executed by the computer. Note that in the example shown in FIG. 13, a situation is assumed in which a form is employed in which a termination request is directly transmitted from the first terminal 4 to the management server 1.

In step SZ10, the control unit 41 of the first terminal 4 operates as the termination commissioning unit 413 to transmit a termination request for the correlative relation to the management server 1. Accordingly, the control unit 11 of the management server 1 receives the termination request. The correlative relation to be terminated by commissioning may be specified as appropriate. The trigger for the termination request may be selected as appropriate in accordance with the form of implementation.

In step SZ20, the control unit 11 operates as the termination unit 113, and terminates (invalidates) the setting of the correlative relation specified by the termination request that is received, or changes the state of the correlative relation from active to non-active. The updating of the association information D10 with respect to the change to non-active may be the same as described above. The updating of the association information D10 with respect to terminating (invalidating) the correlative relation may be constituted by recording information indicating termination. In one example, when the association information D10 has the configuration in FIG. 3A, the control unit 11 may terminate the correlative relation between the objects by adding a termination time or setting a termination flag to the corresponding association information D10. When the association information D10 is configured on a blockchain platform, the control unit 11 may terminate the correlative relation between the objects by generating a transaction indicating the association termination, and adding the generated transaction to the blockchain.

In step SZ30, the control unit 11 operates as the notification unit 114 to transmit a result of execution of the association termination processing to the first terminal 4. When the notification of the result is completed, the processing procedures related to the association termination according to this operation example end.

Note that the above processing procedures is merely an example, and each step may be changed to the greatest extent possible. Also, regarding the above processing procedures, steps can be omitted, substituted, or added as appropriate in accordance with the form of implementation. For example, as described above, the transmission route of the termination request is not limited to the example in FIG. 13, and may be selected as appropriate in accordance with the form of implementation. The termination request may be transmitted from the second terminal 5 (termination commissioning unit 513). The processing of the termination request may include authentication processing for at least one of the first object VA and the second object WA. Also, instead of step SZ20, the control unit 11 of the management server 1 may operate as the termination unit 113 to terminate the correlative relation in conjunction with of the predetermined termination condition being satisfied.

### Features

In the present embodiment, information indicating the setting of the correlative relation between the relevant individuals of the first object VA and the second object WA is recorded by the processing in step S30 (step S301, step S302). This recording enables the usage relation between relevant individuals of the first object VA and the second object WA to be tracked. In addition, in the present embodiment, association settings for each of a plurality of individuals of the second object WA with respect to one individual of the first object VA are permitted. When establishing the association settings results in the association settings for the relevant individual of the first object VA conflicting, the state of the association setting is switched through the processing of step S25 and step S302. By switching the state of the association settings, the conflict is arbitrated. This enables proper tracking the usage relation regarding the relevant individual of the first object VA. Accordingly, in the present embodiment, in at least some situations, the generation and dissolution of usage relations can be handled by switching the state, without repeating setting and termination of associations. Thus, the usage relation between the first object VA and the second object WA can be easily tracked.

### 4. MODIFICATIONS

Although the embodiment of the present disclosure has been described in detail above, the above description is only exemplary of the present disclosure in all respects. It is needless to say that various improvements or modifications may be made without departing from the scope of the present disclosure. For example, the following changes can be made. Note that the same reference symbols are used below for the same components as those in the above embodiment, and description has been omitted as appropriate for the same points as those in the above embodiment. The following modifications can be combined as appropriate.

4.1

In the embodiment described above, authentication processing for the first object VA and the second object WA may be executed when at least one of association setting and association termination is performed. The authentication processing may be executed in at least one of the management server 1, the external servers (first server 2, second server 3, and so forth), and the terminals (4, 5). In one example, at least one of the following four authentication methods may be employed.

### A. Authentication Method No. 1

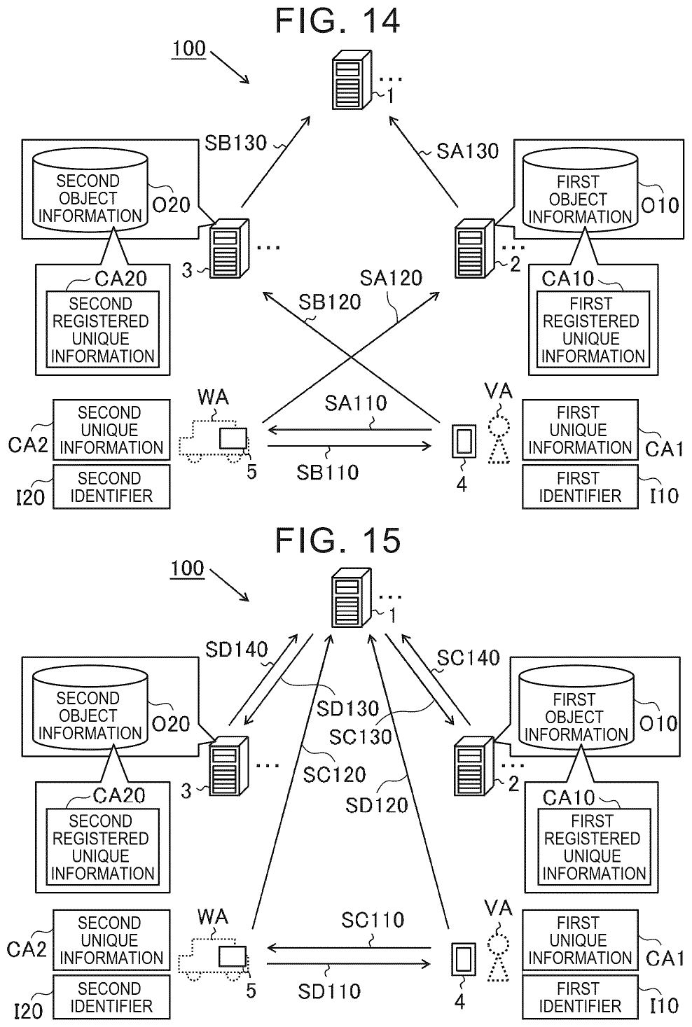

FIG. 14 schematically illustrates an example of a processing process of association settings when an authentication method No. 1 is employed. In the authentication method No. 1, the second server 3 executes authentication of the second object WA in accordance with a request from the first terminal 4 of the first object VA, and the first server 2 executes authentication of the first object VA in accordance with a request from the second terminal 5 of the second object WA. Each terminal (4, 5) requests each server (2, 3) to authenticate each other as an association request, and causes the management server 1 to report the results of authentication. Thus, each terminal (4, 5) transmits an association request to the management server 1.

The first server 2 is configured so as to be capable of accessing a first storage device that stores first registered unique information CA10 for authentication of the first object VA. The first storage device may be made up of at least one of the memory resources of the first server 2 and an external storage device (such as an NAS). The first registered unique information CA10 may be included in the first object information O10. The second server 3 is configured so as to be capable of accessing a second storage device that stores second registered unique information CA20 for authentication of the second object WA. The second storage device may be made up of at least one of the memory resources of the second server 3 and an external storage device (such as an NAS). The second registered unique information CA20 may be included in the second object information O20.

Each registered unique information (CA10, CA20) is unique information registered in advance for authentication of each object (VA, WA). As long as the unique information can be used for authentication, the data format and configuration thereof are not limited in particular and may be selected as appropriate in accordance with the form of implementation. The unique information may be made up of any information, such as, for example, object-derived information, terminal-derived information, temporarily-generated information, information generated by any other method, and so forth.

The object-derived information may be, for example, biometric information, uniquely assigned identification information, or the like. The biometric information may be, for example, a facial image, a fingerprint, a voiceprint, or the like. The uniquely assigned identification information may be, for example, a vehicle registration number, a vehicle identification number, a personal number, or the like. When an integrated circuit (IC) tag is assigned to the object, the uniquely assigned identification information may include information held by the IC tag. The terminal-derived information may be, for example, a MAC address, terminal identification information, and so forth. The temporarily generated information may be, for example, a one-time password, a private address (dynamically generated address), or the like. The temporarily generated information may be made up of a timestamp, a random number, a hash value, or the like. The information generated by any other method may include, for example, a password, a passcode, and any other information except a symbol string.

First, when a usage relation is generated between relevant individuals of the first object VA and the second object WA, data exchange is executed between the corresponding first terminal 4 and the second terminal 5 (step SA110, step SB110).

In step SA110, the second terminal 5 acquires the first identifier I10 and first unique information CA1 from the relevant individual of the first object VA. The first unique information CA1 corresponds to the first registered unique information CA10. The second terminal 5 may acquire the first identifier I10 and the first unique information CA1 from the first object VA as appropriate, during data exchange. Acquiring from the first object VA may include acquiring from the first terminal 4. For example, the second terminal 5 may acquire at least one of the first identifier I10 and the first unique information CA1 from the first object VA via an input device, a sensor, or the like. The second terminal 5 may acquire at least one of the first identifier I10 and the first unique information CA1 from the first terminal 4 during data exchange.

In step SB110, the first terminal 4 acquires the second identifier I20 and the second unique information CA2 from the relevant individual of the second object WA. The second unique information CA2 corresponds to the second registered unique information CA20. The first terminal 4 may acquire the second identifier I20 and the second unique information CA2 from the second object WA as appropriate, during data exchange. Acquiring from the second object WA may include acquiring from the second terminal 5. For example, the first terminal 4 may acquire at least one of the second identifier I20 and the second unique information CA2 from the second object WA via an input device, a sensor, or the like. The first terminal 4 may acquire at least one of the second identifier I20 and the second unique information CA2 from the second terminal 5 during data exchange.

In step SA120, the second terminal 5 transmits a first authentication request including the first identifier I10 and the first unique information CA1 to the first server 2. In accordance with this, the first server 2 receives the first authentication request for the relevant individual of the first object VA. The first server 2 executes authentication processing for the first object VA as appropriate, in accordance with receiving the first authentication request. In one example, the first server 2 may search for the first object information O10 using the first identifier I10 included in the first authentication request as a query, thereby extracting the first registered unique information CA10 of the relevant individual of the first object VA from the first object information O10. The first server 2 may perform cross-checking of the first registered unique information CA10 that is extracted and the first unique information CA1 included in the first authentication request. The cross-checking may be performed as appropriate in accordance with the unique information that is used. The first server 2 may determine whether the authentication is successful for the relevant individual of the first object VA, in accordance with the results of the cross-checking. In step SA130, the first server 2 reports the result of the authentication for the relevant individual of the first object VA to the management server 1. In one example, the first server 2 may transmit the result of the authentication of the first object VA to the management server 1, with the first identifier I10 of the first object VA attached thereto. The first server 2 may transmit the result of the authentication to the management server 1 regardless of whether the authentication is successful, or may transmit the authentication result to the management server 1 only when the authentication is successful.

On the other hand, in step SB120, the first terminal 4 transmits a second authentication request including the second identifier I20 and the second unique information CA2 to the second server 3. In accordance with this, the second server 3 receives the second authentication request for the relevant individual of the second object WA. The second server 3 executes authentication processing for the second object WA as appropriate, in accordance with receiving the second authentication request. In one example, the second server 3 may search for the second object information O20 using the second identifier I20 included in the second authentication request as a query, thereby extracting the second registered unique information CA20 of the relevant individual of the second object WA from the second object information O20. The second server 3 may perform cross-checking of the second registered unique information CA20 that is extracted and the second unique information CA2 included in the second authentication request. The cross-checking may be performed as appropriate in accordance with the unique information that is used. The second server 3 may determine whether the authentication is successful for the relevant individual of the second object WA, in accordance with the result of the cross-checking. In step SB130, the second server 3 reports the result of the authentication for the relevant individual of the second object WA to the management server 1. In one example, the second server 3 may transmit the result of the authentication of the second object WA to the management server 1, with the second identifier I20 of the second object WA attached thereto. The second server 3 may transmit the result of the authentication to the management server 1 regardless of whether the authentication is successful, or may transmit the authentication result to the management server 1 only when the authentication is successful.

The second terminal 5 providing the first authentication request to the first server 2, and causing the first server 2 to transmit the authentication result to the management server 1, is an example of the second terminal 5 transmitting an association request toward the management server 1. Also, the first terminal 4 providing the second authentication request to the second server 3, and causing the second server 3 to transmit the authentication result to the management server 1, is an example of the first terminal 4 transmitting an association request toward the management server 1. That is to say, when the first authentication method is employed when performing the association setting, the processing in step SA120, step SA130, step SB120, and step SB130 is an example of the processing in step S10 above.

The management server 1 receives the authentication results for the relevant individual of each object (VA, WA) from each server (2, 3). In order to identify the combination of the relevant individuals of the first object VA and the second object WA that are currently requesting the setting of the correlative relation, the management server 1 may identify the correlation of the data of the authentication results using a method such as using the above shared information, or the like. In the authentication results of the first object VA and the second object WA that are received, when authentication of both the first object VA and the second object WA are successful, the management server 1 sets a correlative relation between the relevant individuals of the first object VA and the second object WA. The setting processing of the correlative relation may be the same as that in the above embodiment. Note that the series of processing from the data exchange between the terminals (4, 5) to the association setting may be executed in real time in accordance with the generation of the usage relation.

In the first authentication method, in accordance with a usage relation being generated between the relevant individuals of the first object VA and the second object WA, authentication of the relevant individuals of the first object VA and the second object WA is performed at each of the first server 2 and the second server 3. At this time, the second terminal 5 of the second object WA commissions the authentication of the first object VA. The first terminal 4 of the first object VA commissions the authentication of the second object WA. That is to say, cross-authentication is performed in which each object does not proceed with its own authentication, but proceeds with the authentication of the other. Thus, ensuring of security can be anticipated.

Note that the processing procedures of FIG. 14 are merely an example, and each step may be changed to the greatest extent possible. Also, regarding the above processing procedures, steps can be omitted, substituted, or added as appropriate in accordance with the form of implementation. For example, the order of processing of step SA110 to step SA130, and step SB110 to step SB130, is not limited in particular, and may be decided as appropriate in accordance with the form of implementation. At least one of the authentication processing for the first object VA (step SA110 to step SA130) and the authentication processing for the second object WA (step SB110 to step SB130) may be omitted.

### B. Authentication Method No. 2

FIG. 15 schematically illustrates an example of a processing process of association settings when an authentication method No. 2 is employed. In the second authentication method, the management server 1 commissions each server (2, 3) for authentication in accordance with a request from at least one of the first terminal 4 and the second terminal 5. That is to say, at least one of the first terminal 4 and the second terminal 5 transmits an association request including an authentication request for each object (VA, WA). The data (unique information) used for authentication is the same as that in the authentication method No. 1.

First, when a usage relation is generated between relevant individuals of the first object VA and the second object WA, data exchange is executed between the corresponding first terminal 4 and second terminal 5 (step SC110, step SD110). At least one of the first terminal 4 and the second terminal 5 transmits an authentication request including the first identifier I10, the first unique information CA1, the second identifier I20, and the second unique information CA2, to the management server 1 as an association request (step SC120, step SD120). In accordance with this, the management server 1 receives the authentication request including the first identifier I10, the first unique information CA1, the second identifier I20, and the second unique information CA2. The processing in step SC120 and step SD120 is an example of the processing in step S10.

Apportioning for data transmission may be decided as appropriate, in accordance with the form of implementation. In one example, the second terminal 5 may be in charge of transmitting the first identifier I10 and the first unique information CA1, and the first terminal 4 may be in charge of transmitting the second identifier I20 and the second unique information CA2. That is to say, in step SC110, the second terminal 5 may acquire the first identifier I10 and the first unique information CA1 from the first object VA. Acquiring from the first object VA may include acquiring from the first terminal 4. In step SC120, the second terminal 5 may transmit an association request including the first identifier I10 and the first unique information CA1 that are acquired to the management server 1. In step SD110, the first terminal 4 may acquire the second identifier I20 and the second unique information CA2 from the second object WA. Acquiring from the second object WA may include acquiring from the second terminal 5. In step SD120, the first terminal 4 may transmit an association request including the second identifier I20 and the second unique information CA2 that are acquired to the management server 1.

Note that apportioning of data transmission does not have to be limited to such an example. In another example, at least one of the first identifier I10 and the first unique information CA1 may be transmitted from the first terminal 4. At least one of the second identifier I20 and the second unique information CA2 may be transmitted from the second terminal 5. When employing a form in which transmission is performed divisionally, the management server 1 may identify the correlation of data of the authentication request by the above method of using shared information and so forth, in order to identify the combination of the relevant individuals of the first object VA and second object WA currently requesting settings for correlative relation. In yet another example, the first identifier I10, the first unique information CA1, the second identifier I20, and the second unique information CA2 may be transmitted from just one of the first terminal 4 and the second terminal 5.

In step SC130, the management server 1 transmits the first identifier I10 and first unique information CA1 of the received data to the first server 2, thereby commissioning the first server 2 to authenticate the relevant individual of the first object VA. In accordance with this, the first server 2 may perform cross-checking of the first unique information CA1 and the first registered unique information CA10, and determine whether the authentication is successful for the relevant individual of the first object VA, in accordance with the results of the cross-checking. In step SC140, the first server 2 returns the results of the authentication for the relevant individual of the first object VA to the management server 1.

In the same way, in step SD130, the management server 1 transmits the second identifier I20 and the second unique information CA2 to the second server 3, thereby commissioning the second server 3 to authenticate the relevant individual of the second object WA. In accordance with this, the second server 3 may perform cross-checking of the second unique information CA2 and the second registered unique information CA20, and determine whether authentication is successful for the relevant individual of the second object WA, in accordance with the results of the cross-checking. In step SD140, the second server 3 transmits the results of the authentication for the relevant individual of the second object WA to the management server 1.

The management server 1 receives the authentication results for the relevant individual of each object (VA, WA) from each server (2, 3). In the authentication results of the first object VA and the second object WA that are received, when authentication of both the first object VA and the second object WA are successful, the management server 1 sets a correlative relation between the relevant individuals of the first object VA and the second object WA. The setting processing of the correlative relation may be the same as that in the above embodiment. Note that the series of processing from the data exchange between the terminals (4, 5) to the association setting may be executed in real time in accordance with the generation of the usage relation. Other configurations may be the same as that in the authentication method No. 1.

In the authentication method No. 2, in accordance with a usage relation being generated between the relevant individuals of the first object VA and the second object WA, authentication of the relevant individuals of the first object VA and the second object WA is performed at each of the first server 2 and the second server 3. This double authentication can be anticipated to ensure security.

Note that the processing procedures of FIG. 15 are merely an example, and each step may be changed to the greatest extent possible. Also, regarding the above processing procedures, steps can be omitted, substituted, or added as appropriate in accordance with the form of implementation. For example, the order of processing of step SC110 to step SC140, and step SD110 to step SD140, is not limited in particular, and may be decided as appropriate in accordance with the form of implementation. At least one of the authentication processing for the first object VA (step SC110 to step SC140) and the authentication processing for the second object WA (step SD110 to step SD140) may be omitted.

### C-1. Authentication Method No. 3-1

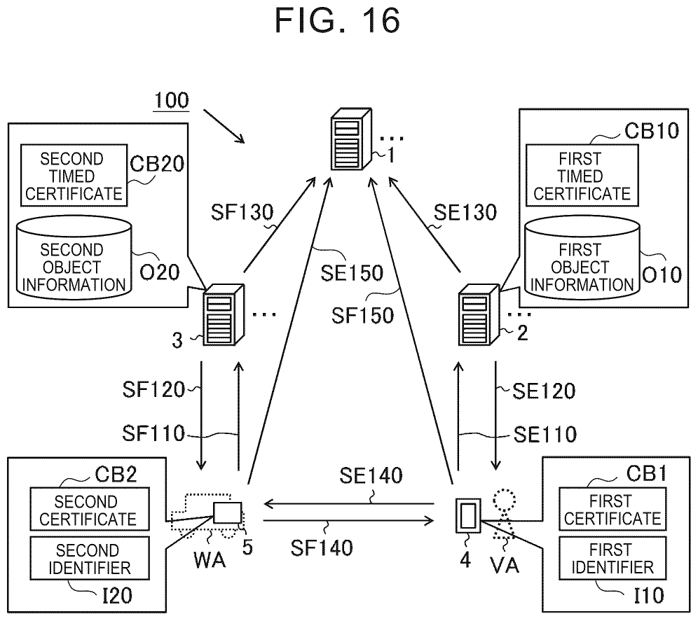

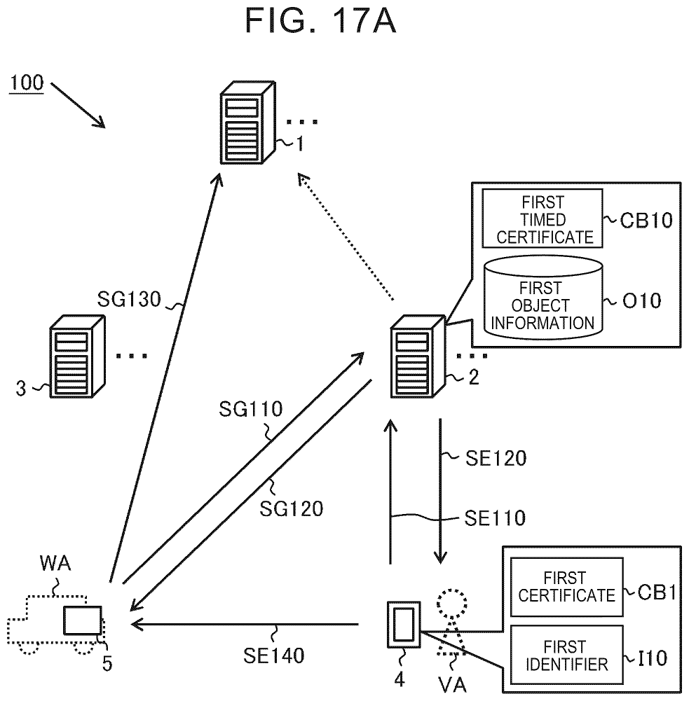

FIG. 16 schematically illustrates an example of a processing process of association settings when an authentication method No. 3-1 is employed. The authentication method No. 3-1 uses a timed certificate for authentication instead of unique information. The authentication processing is executed by the management server 1.

The first server 2 is configured to issue a first timed certificate CB10 to each individual of the first object VA. The second server 3 is configured to issue a second timed certificate CB20 to each individual of the second object WA.

Each timed certificate (CB10, CB20) is configured to expire after a validity period thereof elapses. The configuration of each timed certificate (CB10, CB20) is not limited in particular, as long as expiration thereof can be controlled due to the validity period elapsing, and may be selected as appropriate in accordance with the form of implementation. The timed certificates (CB10, CB20) may include any information. In one example, each timed certificate (CB10, CB20) may be constituted of a random number, a timestamp, a hash value, or the like. Each timed certificate (CB10, CB20) may be constituted of temporary information such as a one-time password or the like.

The validity period of each timed certificate (CB10, CB20) may be managed as appropriate. Expiration due to elapsing of the validity period may be identified as appropriate. For example, whether the object timed certificate has expired may be identified by such that the time limit set on the timed certificate has passed, the timed certificate has been added to a revocation list, the timed certificate has been removed from a valid list, the timed certificate has been updated to a new one, information indicating revocation (e.g., a time stamp) has been assigned, or the like. When reference information such as a revocation list, a valid list, or the like is used for managing the validity period, the reference information may be stored in any storage device that is accessible from the system 100. Typically, reference information for each timed certificate (CB10, CB20) may be stored on each server (2, 3).

First, in step SE110, the first terminal 4 of the first object VA transmits a commission for issuance of the first timed certificate CB10 to the first server 2 in relation to the first identifier I10 of the first object VA. In accordance with receiving the commission, the first server 2 issues a first timed certificate CB10 in relation with the first identifier I10. In step SE120, the first server 2 returns the first timed certificate CB10 that is issued to the first terminal 4. In accordance with this, the first terminal 4 receives the first timed certificate CB10 that is issued from the first server 2. The first terminal 4 stores the first timed certificate CB10 that is received in a usable manner as a first certificate CB1. In step SE130, the first server 2 also notifies the management server 1 of the first timed certificate CB10 that is issued. The first server 2 may perform notification of the first timed certificate CB10 by attaching the first identifier I10.

In step SF110, the second terminal 5 of the second object WA transmits a commission to issue the second timed certificate CB20 to the second server 3 in relation to the second identifier I20 of the second object WA. In response to receiving the commission, the second server 3 issues the second timed certificate CB20 in relation with the second identifier I20. In step SF120, the second server 3 returns the second timed certificate CB20 that is issued to the second terminal 5. In accordance with this, the second terminal 5 receives the second timed certificate CB20 that is issued from the second server 3. The second terminal 5 stores the second timed certificate CB20 that is received, in a usable manner as a second certificate CB2. Also, in step SF130, the second server 3 also notifies the management server 1 of the second timed certificate CB20 that is issued. The second server 3 may perform notification of the second timed certificate CB20 by attaching the second identifier I20.

When a usage relationship is generated between relevant individuals of the first object VA and the second object WA, data exchange is executed between the corresponding first terminal 4 and second terminal 5 (step SE140, step SF140). At least one of the first terminal 4 and the second terminal 5 transmits an authentication request including the first certificate CB1 and the second certificate CB2 to the management server 1 as an association request (step SE150, step SF150). In accordance with this, the management server 1 receives the first certificate CB1 corresponding to the first timed certificate CB10 and the second certificate CB2 corresponding to the second timed certificate CB20. The processing in step SE150 and step SF150 is an example of the processing in step S10 above.

Apportioning for data transmission may be decided as appropriate, in accordance with the form of implementation. In one example, the second terminal 5 may be in charge of transmitting the first certificate CB1, and the first terminal 4 may be in charge of transmitting the second certificate CB2. That is to say, in step SE140, the second terminal 5 may acquire the first certificate CB1 from the first terminal 4. In step SE150, the second terminal 5 may transmit an association request including the first certificate CB1 to the management server 1. In step SF140, the first terminal 4 may acquire the second certificate CB2 from the second terminal 5. In step SF150, the first terminal 4 may transmit an association request including the second certificate CB2 to the management server 1.

Note that apportioning of data transmission does not have to be limited to such an example. In another example, the first certificate CB1 may be transmitted from the first terminal 4. The second certificate CB2 may be transmitted from the second terminal 5. Also, each identifier (I10, I20) may also be transmitted to the management server 1 along with each certificate (CB1, CB2). Each identifier (I10, I20) may be transmitted from at least one of the first terminal 4 and the second terminal 5. When employing a form in which transmission is performed divisionally, the management server 1 may identify the correlation of data of the authentication request by the above method of using shared information and so forth, in order to identify the combination of the relevant individuals of the first object VA and second object WA currently requesting settings for correlative relation. In yet another example, the first certificate CB1 and the second certificate CB2 may be transmitted from only one of the first terminal 4 and the second terminal 5.

The management server 1 performs cross-checking of the first certificate CB1 that is received with the first timed certificate CB10 that is notified from the first server 2. The management server 1 performs cross-checking of the second certificate CB2 that is received with the second timed certificate CB20 that is notified from the second server 3. The management server 1 may identify the correlation of data to be cross-checked as appropriate. Identifying the correlation of the data to be cross-checked is to differentiate the combination of the first timed certificate CB10 and first certificate CB1 to be cross-checked, and the combination of the second timed certificate CB20 and the second certificate CB2. Similar to the cross-checking of data in the authentication request, the management server 1 may identify the correlation of data to be cross-checked, by a method such as using the shared information described above, or the like. The shared information may be the identifiers (I10, I20).

Further, the method of cross-checking the certificate and the timed certificate may be selected as appropriate depending on the relationship between the two. In one example, the timed certificates (CB10, CB20) may be used as certificates (CB1, CB2) with no change therein. In this case, whether the cross-checking in the authentication is successful may be determined depending on whether the timed certificates (CB10, CB20) and the certificates (CB1, CB2) match. In another example, the timed certificates (CB10, CB20) may be subjected to any conversion, and the timed certificates (CB10, CB20) after conversion may be used as the certificates (CB1, CB2). In this case, whether the cross-checking in the authentication is successful may be determined depending on whether a predetermined relationship holds between the timed certificates (CB10, CB20) and the certificates (CB1, CB2). For example, the first timed certificate CB10 may be converted to a hash value, and the hash value that is obtained may be used as the first certificate CB1. In accordance with this, whether the relationship holds may be determined depending on whether the hash value of the first timed certificate CB10 and the first certificate CB1 match. Conversion may include data manipulations such as deletions, additions, and so forth. At least one of the first timed certificate CB10 and the second timed certificate CB20 may be used as a certificate as it is, and the other may be used as a certificate after conversion. Note that the conversion processing may be executed by the terminals (4, 5) or executed by the servers (2, 3). When the conversion processing is executed by the servers (2, 3), each terminal (4, 5) may receive the timed certificates (CB10, CB20) after conversion, from each server (2, 3).

The management server 1 may determine whether authentication of the relevant individuals of the objects (VA, WA) is successful, in accordance with the result of each cross-checking. When the cross-checking fails, the authentication is unsuccessful. When the first timed certificate CB10 and the second timed certificate CB20 have expired due to the expiration of the validity period, the cross-checking of the first object VA and the second object WA is unsuccessful. On the other hand, when the first timed certificate CB10 and the second timed certificate CB20 are valid and the cross-checking of each is successful, the authentication of both the first object VA and the second object WA is successful. When authentication of both the first object VA and the second object WA is successful, the management server 1 sets a correlative relation between the relevant individuals of the first object VA and the second object WA. The setting processing of the correlative relation may be the same as that in the above embodiment. Note that the series of processing from the data exchange between the terminals (4, 5) to the association setting may be executed in real time in accordance with the generation of the usage relation. Other configurations may be the same as those in the authentication method No. 1.

In the method No. 3-1, in accordance with the generation of a usage relation between the relevant individuals of the first object VA and the second object WA, authentication of each of the first object VA and second object WA is performed using a timed certificate (CB10, CB20). Each timed certificate (CB10, CB20) is configured to expire after the validity period thereof elapses. Therefore, the same certificate can be suppressed from being used permanently, and security can be anticipated to be ensured.

Note that the processing procedures of FIG. 16 are merely an example, and each step may be changed to the greatest extent possible. Also, regarding the above processing procedures, steps can be omitted, substituted, or added as appropriate in accordance with the form of implementation. For example, the order of processing of step SE110 to step SE150, and step SF110 to step SF150, is not limited in particular, and may be decided as appropriate in accordance with the form of implementation. At least one of the authentication processing for the first object VA (step SE110 to step SE150) and the authentication processing for the second object WA (step SF110 to step SF150) may be omitted.

Furthermore, the issuance of each of the timed certificates (CB10, CB20) does not necessarily have to be based on a commission (request) from each terminal (4, 5). The servers (2, 3) may generate each timed certificate (CB10, CB20), unprompted. In this case, the processing of step SE110 and step SF110 may be omitted.

Also, the issuance of each timed certificate (CB10, CB20) (step SE110 to step SE130, step SF110 to step SF130) may be executed at any timing before the association setting commission (step SE150, step SF150). In one example, the issuance of each timed certificate (CB10, CB20) may be executed in advance before data exchange is executed between the first terminal 4 and the second terminal 5 (step SE140, step SF140). In another example, the processing may be executed at a timing after starting data exchange between the first terminal 4 and the second terminal 5, and before transmitting the association request. From the perspective of reducing the number of steps required for association setting, it is preferable that each timed certificate (CB10, CB20) be issued at the former timing.

In addition, in the authentication method No. 3-1 above, the cross-checking processing of each certificate (CB1, CB2) and each timed certificate (CB10, CB20), i.e., the authentication process of each object (VA, WA), is executed by the management server 1. However, the entity that executes the cross-checking processing is not limited to the management server 1. In another example, the management server 1 may commission each server (2, 3) to perform cross-checking processing by transmitting each certificate (CB1, CB2) to each server (2, 3). Thus, the cross-checking processing may be executed by each server (2, 3).

### C-2. Authentication Method No. 3-2

In the authentication method No. 3-1 above, authentication processing for each object (VA, WA) is executed in accordance with an association request from at least one of the first terminal 4 and the second terminal 5. However, the timing of executing the authentication processing does not have to be limited to this example. In authentication method No. 3-2, before transmitting the association request to the management server 1, authentication processing of at least one of the first object VA and the second object WA may be executed in advance between at least one of the first server 2 and the second server 3, by at least one of the first terminal 4 and the second terminal 5.

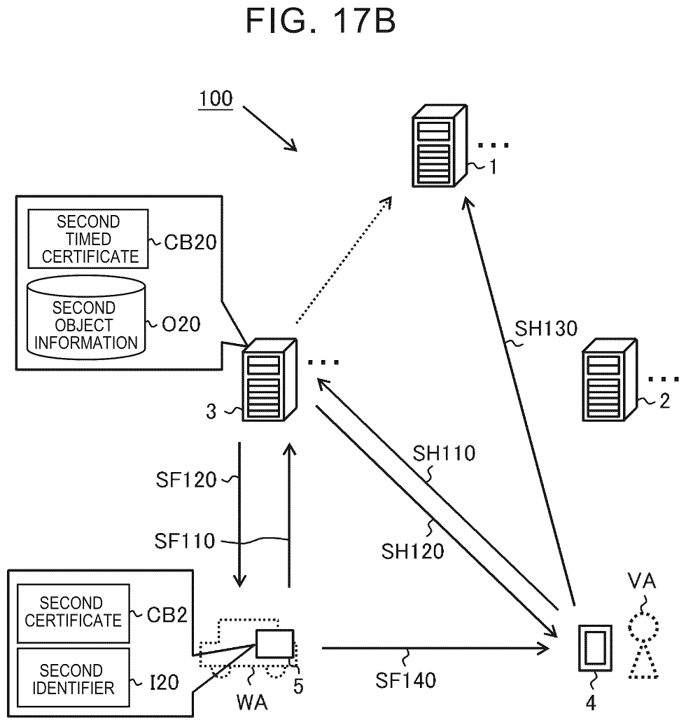

FIG. 17A schematically illustrates an example of the processing process of association setting when the authentication method No. 3-2 is employed. The example in FIG. 17A assumes a situation employing a form in which the authentication processing for the first object VA is executed and the authentication processing for the second object WA is omitted.

First, the processing of step SE110 and step SE120 may be executed between the first terminal 4 and the first server 2 in the same manner as that in the authentication method No. 3-1 above. As a result of the execution, the first timed certificate CB10 is issued, and the first terminal 4 is notified of the first timed certificate CB10 that is issued. At this time, the first server 2 may store the first timed certificate CB10 that is issued correlated with the first identifier I10. The first timed certificate CB10 may be stored as the first object information O10. The notification to the management server 1 (step SE130) may be omitted. In step SE140, the first terminal 4 provides the first timed certificate CB10 that is issued to the second terminal 5 as the first certificate CB1. Further, the first terminal 4 provides the first identifier I10 to the second terminal 5. In accordance with this, the second terminal 5 acquires the first identifier I10 and the first certificate CB1 from the first object VA.

In step SG110, the second terminal 5 transmits an authentication commission, including the first identifier I10 and the first certificate CB1, to the first server 2. In accordance with receiving the authentication commission, the first server 2 performs cross-checking of the first certificate CB1 that is received, with the corresponding first timed certificate CB10. The corresponding first timed certificate CB10 may be acquired as appropriate. In one example, the first timed certificate CB10 that is issued may be saved as the first object information O10, and the first server 2 may extract the corresponding first timed certificate CB10 by searching for the first object information O10, using the first identifier I10 as a query. In step SG120, the first server 2 returns the results of cross-checking to the second terminal 5. In accordance with this, the control unit 51 of the second terminal 5 receives the results of cross-checking.

In the results of cross-checking that are received, when cross-checking of the first certificate CB1 and the first timed certificate CB10 are unsuccessful, the second terminal 5 may end the processing procedure for the association setting as appropriate. The second terminal 5 may request the first terminal 4 to retransmit the first certificate CB1. On the other hand, when the cross-checking is successful, the second terminal 5 transmits an association request including the first identifier I10 and the second identifier I20 to the management server 1 (step SG130). The processing in step SG130 is an example of the processing in step S10 above.

In accordance with this, the management server 1 receives the association request from the second terminal 5. The management server 1 sets a correlative relation between the relevant individuals of the first object VA and the second object WA in accordance with the association request. The setting processing of the correlative relation may be the same as that in the above embodiment. Note that a series of processing from data exchange between the terminals (4, 5) (step SE140) to association setting may be executed in real time in accordance with a usage relation being generated. Other configurations may be the same as those in the authentication method No. 1.

Note that the processing procedures of FIG. 17A are merely an example, and each step may be changed to the greatest extent possible. Also, regarding the above processing procedures, steps can be omitted, substituted, or added as appropriate in accordance with the form of implementation.

For example, the management server 1 may verify that the cross-checking has been successful in the first server 2, as appropriate. In one example, the first server 2 may also transmit the results of cross-checking to the management server 1. For example, the authentication commission may further include the second identifier I20. When cross-checking is successful, the first server 2 may transmit the results of cross-checking, including the first identifier I10 and the second identifier I20, to the management server 1. Thus, the first server 2 may cause the management server 1 to validate an association request for the combination of the first identifier I10 and the second identifier I20, specified in the results of cross-checking. That is to say, in one example, verification of successful cross-checking is constituted of receiving the results of cross-checking. The management server 1 may be configured to holds the results of the cross-checking from the first server 2, accept a request for association setting for the combination of the first identifier I10 and second identifier I20 specified in the results of cross-checking, and reject commissioning for other association settings.

Furthermore, in the authentication method No. 3-2, the object to be authenticated does not have to be limited to the first object VA. In another example, instead of the authentication processing of the first object VA, the authentication processing of the second object WA may be executed. In yet another example, along with the authentication processing of the first object VA, the authentication processing of the second object WA may also be executed.

FIG. 17B schematically illustrates another example of a processing process of association settings when the authentication method No. 3-2 is employed. The example in FIG. 17B assumes a situation of employing a form in which authentication processing for the second object WA is executed instead of the authentication processing for the first object VA. The processing procedure in FIG. 17B may be the same as the processing procedure in FIG. 17A, except that the first object VA and the second object WA are interchanged. That is to say, by executing the processing of step SF110 and step SF120 between the second terminal 5 and the second server 3, the second timed certificate CB20 is issued, and the second terminal 5 is notified of the second timed certificate CB20 that is issued. In step SF140, the second terminal 5 provides the second timed certificate CB20 that is issued, to the first terminal 4 as the second certificate CB2. Also, the second terminal 5 gives the second identifier I20 to the first terminal 4. In step SH110, the first terminal 4 transmits an authentication commission including the second identifier I20 and the second certificate CB2 to the second server 3. In accordance with this, the second server 3 executes cross-checking processing for the second certificate CB2 and the second timed certificate CB20. In step SH120, the second server 3 returns the results of cross-checking to the first terminal 4. In results of the cross-checking, when the cross-checking of the second certificate CB2 and the second timed certificate CB20 is successful, the first terminal 4 transmits the association request including the first identifier I10 and the second identifier I20 to the management server 1. (step SH130). In accordance with this, the management server 1 receives the association request from the first terminal 4. The management server 1 sets a correlative relation between the relevant individuals of the first object VA and the second object WA in accordance with the association request. In another example, the authentication processing for the first object VA and the second object WA may be executed by executing the series of processes in FIGS. 17A and 17B.

In the authentication method No. 3-2, authentication processing is executed before the association request. Thus, the processing load of the management server 1 can be reduced. Also, the processing time from the association request to the setting processing can be shortened.

### D. Authentication Method No. 4

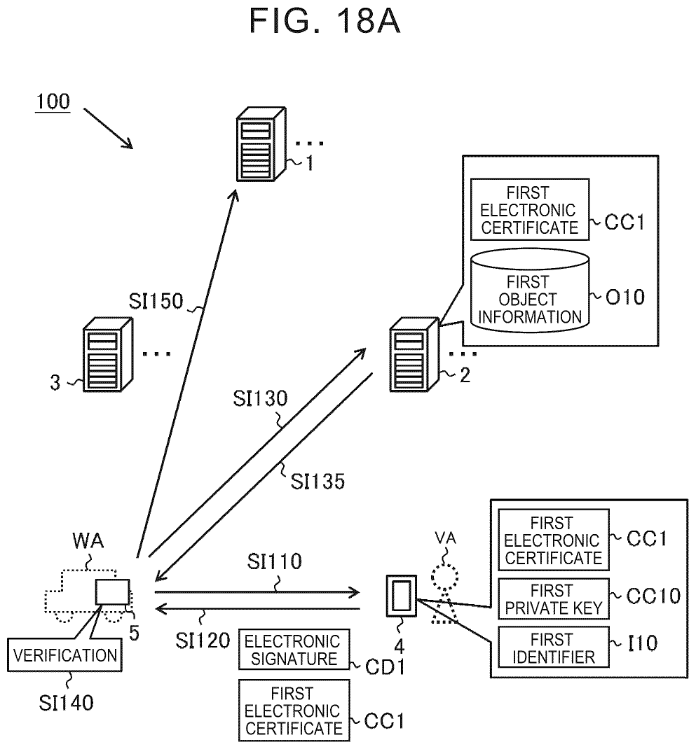

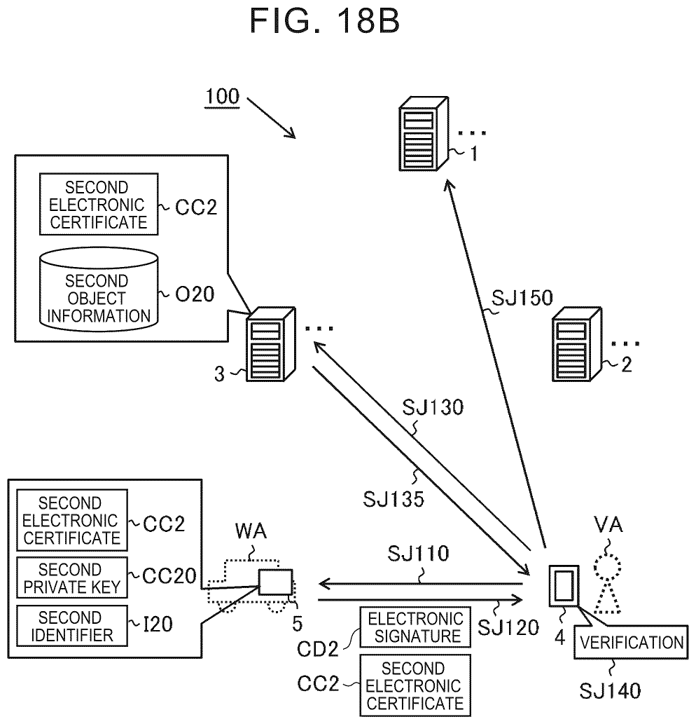

FIG. 18A schematically illustrates an example of the processing process of association setting when an authentication method No. 4 is employed. The authentication method No. 4 uses an electronic signature using a private key and an electronic certificate. The authentication processing is executed by the terminal of the other party object that is to be authenticated. The terminal of the other party object that is to be authenticated is the second terminal 5 when authenticating the first object VA, and is the first terminal 4 when authenticating the second object WA. The example in FIG. 18A assumes a situation in which the authentication processing for the first object VA is executed and the authentication processing for the second object WA is omitted.

As a preparatory stage (pre-processing), a combination of a first private key CC10 and a first public key used for authentication of the first object VA is generated. The method of generating the first private key CC10 and the first public key is not limited in particular, and may be selected as appropriate in accordance with the form of implementation. The first private key CC10 and the first public key may be generated by at least one of the first terminal 4 and an external computer (first server 2, certificate authority, etc.).

Next, a first electronic certificate CC1 for the first public key is generated by the certificate authority. In one example, the certificate authority may generate the first electronic certificate CC1 in accordance with a commission from the first terminal 4. The certificate authority may be the first server 2 or an external server other than the first server 2. As long as the authenticity of the first public key can be verified, the configuration of the first electronic certificate CC1 is not limited in particular, and may be selected as appropriate in accordance with the form of implementation. In one example, the first electronic certificate CC1 may be constituted of an electronic signature from a certificate authority, proprietary information, and a first public key. The certificate authority holds combinations of public keys and private keys. The electronic signature by the certificate authority may be generated by encrypting the proprietary information and the first public key with the private key of the certificate authority. In a specific example, the electronic signature by the certificate authority may be generated by converting the proprietary information and the first public key into a hash value using a hash function, and encrypting the obtained hash value with the private key of the certificate authority.

The first electronic certificate CC1 is provided to the first terminal 4 from the certificate authority. Also, the first electronic certificate CC1 may be stored in any storage area. The term of validity of the first electronic certificate CC1 may be managed by a revocation list. The revocation list may also be stored in any storage area. The first electronic certificate CC1 and the revocation list may be stored in the first server 2, or may be stored in an external server that is accessible from the first server 2. With the first terminal 4 in a state of holding the first private key CC10 and the first electronic certificate CC1, preparation for the authentication processing of the first object VA is complete.

At a state of usage, first, when a usage relation is generated between relevant individuals of the first object VA and the second object WA, data exchange is executed between the corresponding first terminal 4 and second terminal 5 (step SI110, step SI120). In this data exchange, electronic information is shared between the first terminal 4 and the second terminal 5. The electronic information may be constituted of any information, such as random numbers, time stamps, and so forth, for example. The electronic information may include information derived from the first object VA, such as owner information of the first terminal 4, or the like, for example.

The electronic information may be generated by at least one of the first terminal 4 and the second terminal 5. When the second terminal 5 is involved in the generation of at least a portion of the electronic information, data regarding the electronic information may be provided from the second terminal 5 to the first terminal 4 as the processing of step SI110. The first terminal 4 generates an electronic signature CD1 by encrypting the first identifier I10 and the electronic information using the first private key CC10. In the specific example, the first terminal 4 may convert the first identifier I10 and the electronic information into a hash value using a hash function, and encrypt the hash value that is obtained by the first private key CC10, thereby generating the electronic signature CD1.

In step SI120, the first terminal 4 provides the second terminal 5 with the first identifier I10, the electronic signature CD1 that is generated, and the first electronic certificate CC1. Thus, the second terminal 5 acquires the first identifier I10, the electronic signature CD1, and the first electronic certificate CC1, from the first terminal 4. When the first terminal 4 is involved in the generation of at least a portion of the electronic information, such as first object VA-derived information or the like, data regarding the electronic information may be provided from the first terminal 4 to the second terminal 5 as the processing of step SI120.

Next, the second terminal 5 verifies the validity of the first electronic certificate CC1 (step SI130, step SI135). In the example of FIG. 18A, a situation is assumed in which the first server 2 holds a revocation list. In step SI130, the second terminal 5 inquires of the first server 2 whether the first electronic certificate CC1 is valid. When the first electronic certificate CC1 is not registered in the revocation list, the first electronic certificate CC1 is differentiated as being valid (that is, the term of validity has not expired). When the first electronic certificate CC1 is registered in the revocation list, the first electronic certificate CC1 is differentiated as being not valid. The first server 2 references the revocation list and determines whether the first electronic certificate CC1 is valid. In step SI135, the first server 2 returns the determination results to the second terminal 5. The second terminal 5 may also inquire of the first server 2 whether the first identifier I10 is valid. Note that when the revocation list is held in an external server, the second terminal 5 may, directly or indirectly (e.g., via the first server 2), inquire of the external server whether the first electronic certificate CC1 is valid. Also, in another example, the second terminal 5 may acquire a revocation list and refer to the acquired revocation list to determine whether the first electronic certificate CC1 is valid. When the first electronic certificate CC1 is not valid (i.e., the term of validity has expired), the second terminal 5 may certify the verification of the validity of the first electronic certificate CC1 as being unsuccessful, and end processing procedures for association setting as appropriate. The second terminal 5 may request the first terminal 4 to resend the series of information. On the other hand, when the first electronic certificate CC1 is valid, the second terminal 5 acquires the public key of the certificate authority as appropriate. The second terminal 5 decrypts the electronic signature of the certificate authority included in the first electronic certificate CC1 using the public key that is acquired. The second terminal 5 then performs cross-checking of the decrypted data that is obtained, with the remaining information (proprietary information and first public key) included in the first electronic certificate CC1. When encrypting the information after conversion thereof into a hash value, the second terminal 5 converts the proprietary information and the first public key into a hash value using a hash function, and performs cross-checking of the obtained hash value with the decrypted data. When the two agree in cross-checking, the second terminal 5 certifies that verification of the validity of the first electronic certificate CC1 is successful, and when the two do not agree, the second terminal 5 certifies that verification of the validity of the first electronic certificate CC1 is not successful.

Also, the second terminal 5 verifies the validity of the electronic signature CD1 (step SI140). The second terminal 5 decrypts the electronic signature CD1, using the first public key that is included in the first electronic certificate CC1. The second terminal 5 performs cross-checking of the decrypted data that is obtained with the shared information (first identifier I10 and electronic information). When encrypting after conversion into a hash value, the second terminal 5 converts the shared information (first identifier I10 and electronic information) into a hash value using a hash function, and performs cross-checking of the obtained hash value with the decrypted data. When the two agree in the cross-checking, the second terminal 5 certifies that verification of the validity of the electronic signature CD1 is successful, and when the two do not agree, the second terminal 5 certifies that verification of the validity of the electronic signature CD1 is not successful.

When the verification of the validity of both the first electronic certificate CC1 and the electronic signature CD1 is successful, the second terminal 5 transmits an association request, including the first identifier I10 and the second identifier I20, to the management server 1 (step SI150). In accordance with this, the management server 1 receives the association request from the second terminal 5. The management server 1 sets a correlative relation between the relevant individuals of the first object VA and the second object WA in accordance with the association request. The setting processing of the correlative relation may be the same as that in the above embodiment. Note that the series of processing from the data exchange between the terminals (4, 5) to the association setting may be executed in real time in accordance with the generation of the usage relation. The processing in step SI150 is an example of the processing in step S10 above. On the other hand, when the verification of the validity of at least one of the first electronic certificate CC1 and the electronic signature CD1 is unsuccessful, the second terminal 5 may end the processing procedures for association setting as appropriate. The second terminal 5 may request the first terminal 4 to resend the series of information.

Note that the processing procedures of FIG. 18A are merely an example, and each step may be changed to the greatest extent possible. Also, regarding the above processing procedures, steps can be omitted, substituted, or added as appropriate in accordance with the form of implementation. For example, the processing order of verifying the validity of the first electronic certificate CC1 (step SI130, step SI135) and verifying the validity of the electronic signature CD1 (step SI140) may be changed as appropriate. In another example, verification of the validity of the electronic signature CD1 may be executed before the verification of the validity of the first electronic certificate CC1 is executed. The validity verification processing of the first electronic certificate CC1 and the validity verification processing of the electronic signature CD1 may be executed at least partially in parallel.

Furthermore, in the authentication method No. 4, the object to be authenticated is not limited to the first object VA. In another example, instead of the authentication processing of the first object VA, the authentication processing of the second object WA may be executed. In yet another example, along with the authentication processing of the first object VA, the authentication processing of the second object WA may also be executed.

FIG. 18B schematically illustrates another example of a processing process of association settings when the authentication method No. 4 is employed. The example in FIG. 18B assumes a situation of employing a form in which authentication processing for the second object WA is executed instead of the authentication process for the first object VA. The processing procedures and each piece of data in FIG. 18B may be the same as the processing procedures and each piece of data in FIG. 18A, except that the first object VA and the second object WA are interchanged. That is to say, in the preparation stage, a combination of a second private key CC20 and a second public key is generated. Next, a second electronic certificate CC2 for the second public key is generated by the certificate authority. In one example, the second electronic certificate CC2 may be constituted of an electronic signature of the certificate authority, proprietary information, and the second public key. The second electronic certificate CC2 is provided to the second terminal 5 from the certificate authority. In the usage stage, when a usage relation is generated between the relevant individuals of the first object VA and the second object WA, data exchange is executed between the corresponding first terminal 4 and second terminal 5 (step SJ110, step SJ120). In this data exchange, electronic information is shared between the first terminal 4 and the second terminal 5. The second terminal 5 generates an electronic signature CD2 by encrypting the second identifier I20 and the electronic information using the second private key CC20. The second terminal 5 provides the second identifier I20, the electronic signature CD2 that is generated, and the second electronic certificate CC2 to the first terminal 4. Thus, the first terminal 4 acquires the second identifier I20, the electronic signature CD2, and the second electronic certificate CC2. The first terminal 4 verifies the validity of the second electronic certificate CC2 (step SJ130, step SJ135). The first terminal 4 also verifies the validity of the electronic signature CD2 (step SJ140). When verification of the validity of both the second electronic certificate CC2 and the electronic signature CD2 is successful, the first terminal 4 transmits an association request, including the first identifier I10 and the second identifier I20, to the management server 1 (step SJ150). In accordance with this, the management server 1 receives the association request from the first terminal 4. The management server 1 sets a correlative relation between the relevant individuals of the first object VA and the second object WA in accordance with the association request. The setting processing of the correlative relation may be the same as that in the above embodiment. On the other hand, when the verification of the validity of at least one of the second electronic certificate CC2 and the electronic signature CD2 is unsuccessful, the first terminal 4 may end the processing procedures for association setting as appropriate. The first terminal 4 may request the second terminal 5 to resend the series of information. In another example, the authentication processing for the first object VA and the second object WA may be executed by executing the series of processing in FIGS. 18A and 18B.

In the authentication method No. 4, at least one of the first object VA and the second object WA is authenticated using a private key and an electronic certificate. Thus, ensuring of security can be anticipated. Further, by performing the authentication processing on the terminal side before making the association request, reduction in the processing load on the management server 1 can be anticipated. Also, the processing time from the association request to the setting processing can be shortened.

### 5. SUPPLEMENTARY DESCRIPTION

The processing and means described in the present disclosure may be combined as desired as long as no technical contradiction occurs.

Also, processing described as being performed by a single device may be executed by a plurality of devices in a distributed manner. Alternatively, processing described as being executed by different devices may be executed by a single device. In a computer system, what sort of hardware configuration realizes the functions can be flexibly changed.

The present disclosure can also be realized by supplying computer programs implementing the functions described in the above embodiment to a computer and causing one or more processors of the computer to read and execute the programs. Such computer programs may be provided to the computer by a non-transitory computer-readable storage medium that can be connected to a system bus of the computer, or may be provided to the computer via a network. Examples of the non-transitory computer-readable storage medium include any type of disk or disc, such as magnetic disks (e.g., floppy (registered trademark) disks and hard disk drives (HDD) or the like), and optical discs (e.g., CD-ROM, DVD discs, and Blu-ray discs or the like), and so forth, read only memory (ROM), random access memory (RAM), erasable programmable ROM (EPROM), electrically erasable programmable ROM (EEPROM), magnetic cards, flash memory, optical cards, semiconductor drives (e.g., solid state drive or the like), and any type of medium suitable to store electronic instructions.

What is claimed is:

1. A system comprising:
a management server; a plurality of first terminals corresponding to respective first objects; and
a plurality of second terminals corresponding to respective second objects, wherein:
the first terminals and the second terminals are configured such that, in accordance with a usage relation being generated between the first objects and the second objects, at least one of the first terminals corresponding to the first objects or the second terminals corresponding to the second objects transmits an association request to the management server; and
the management server is configured to execute
accepting a setting of a correlative relation between the first objects and the second objects, by receiving the association request, and
when, in accordance with accepting the setting of the correlative relation by two or more of the association requests with respect to a same first object, settings of two or more correlative relations are established with two or more second objects that are different from each other, with respect to the same first object, setting the setting of one correlative relation out of the two or more correlative relations to active, and setting the settings of other correlative relations to non-active, in accordance with status information that is obtained from at least one of the first object regarding which settings for the two or more correlative relations are established, or the two or more second objects.

2. The system according to claim 1, wherein the management server is configured to execute:
in accordance with the setting of the active correlative relation being established, validating exercise of authority correlated with a corresponding first object via the second object regarding which the active correlative relation is set; and
in accordance with the setting of the non-active correlative relation being established, invalidating the exercise of authority associated with the corresponding first object via the second object to which the non-active correlative relation is set.

3. The system according to claim 1, wherein:
the status information includes a selection by the first object; and
activating the setting of the one correlative relation is constituted by activating the correlative relation setting selected by the first object.

4. The system according to claim 1, wherein;
the status information includes a report of an execution result of authentication processing for the first object by a second terminal; and
activating the setting of the one correlative relation is constituted by activating the setting of the correlative relation with a second object corresponding to the second terminal that most recently reported the execution result of the authentication processing for the first object.

5. The system according to claim 1, wherein:
each of the first terminals includes a first positioning module;
each of the second terminals includes a second positioning module;
the status information includes a first current position measured by the first positioning module of the first terminal corresponding to the first object, and a second current position measured by the second positioning module of the second terminal corresponding to each of the two or more second objects; and
activating the setting of the one correlative relation is constituted of activating the setting of the correlative relation as to a second object regarding which the second current position of the corresponding second terminal satisfies a condition of the usage relation, with respect to the first current position of the first terminal.

6. The system according to claim 1, wherein the management server is configured such that, after establishing an active correlative relation setting with a second object of a first predetermined type, the management server locks the setting of the active correlative relation until a predetermined condition is satisfied, so as to further execute prohibition of establishing a setting for another active correlative relation by another second object with respect to the first object regarding which the active correlative relation is set.

7. The system according to claim 6, wherein:
the first object is a user;
the second object of the first predetermined type is a mobile body for public transportation; and
the predetermined condition is that payment of fares for use of the mobile body for public transportation is completed.

8. The system according to claim 1, wherein the management server is configured to, when a predetermined relation holds between the first object and the second object for which the correlative relation is set,
maintain the correlative relation in an active or non-active state without terminating the correlative relation, until the predetermined relation is resolved, and
after the predetermined relation is resolved, the correlative relation is terminated.

9. The system according to claim 8, wherein the predetermined relation is an ownership relation.

10. The system according to claim 9, wherein:
the first object is a user; and
the second object is a mobile body owned by the user.

11. The system according to claim 8, wherein:
the first object is a user;
the second object is a mobile body rented by the user; and
the predetermined relation is that the user rents the mobile body.

12. The system according to claim 1, wherein the management server is further configured to establish a setting of a correlative relation with a second object of a second predetermined type, and then, in accordance with detecting an end of use of the second object, terminate the correlative relation.

13. The system according to claim 12, wherein:
the first object is a user;
the second object is a mobile body; and
the second object of the second predetermined type is a mobile body for public transportation.

14. A management server comprising a control unit configured to:
receive an association request from at least one of a first terminal of a first object or a second terminal of a second object, in accordance with a usage relation being generated between the first object and the second object;
accept a setting of a correlative relation between the first object and the second object, by receiving the association request; and
when, in accordance with accepting the setting of the correlative relation by two or more of the association requests with respect to a same first object, settings of two or more correlative relations are established with two or more second objects that are different from each other, with respect to the same first object, setting the setting of one correlative relation out of the two or more correlative relations to active, and setting the settings of other correlative relations to non-active, in accordance with status information that is obtained from at least one of the first object regarding which settings for the two or more correlative relations are established, or the two or more second objects.

15. The management server according to claim 14, wherein the control unit is configured to execute:
in accordance with the setting of the active correlative relation being established, validating exercise of authority correlated with the corresponding first object via a second object to which the active correlative relation is set; and
in accordance with the setting of the non-active correlative relation being established, invalidating the exercise of authority associated with the corresponding first object via a second object to which the non-active correlative relation is set.

16. The management server according to claim 14, wherein:
the status information includes a report of an execution result of authentication processing for the first object by the second terminal; and
activating the setting of the one correlative relation is constituted by activating the setting of the correlative relation with the second object corresponding to the second terminal that most recently reported the execution result of the authentication processing for the first object.

17. The management server according to claim 14, wherein:
the status information includes a first current position measured by a first positioning module of the first terminal corresponding to the first object, and a second current position measured by a second positioning module of the second terminal corresponding to each of the two or more second objects; and
activating the setting of the one correlative relation is constituted of activating a setting of the correlative relation as to the second object regarding which the second current position of the corresponding second terminal satisfies a condition of the usage relation, with respect to the first current position of the first terminal.

18. The management server according to claim 14, wherein the control unit is configured such that, after establishing an active correlative relation setting with a second object of a first predetermined type, the control unit locks the active correlative relation setting until a predetermined condition is satisfied, thus further executing prohibition of establishing another active correlative relation setting by another second object with respect to the first object regarding which the active correlative relation is set.

19. The management server according to claim 14, wherein the control unit is configured to, when a predetermined relation holds between the first object and the second object for which the correlative relation is set,
maintain the correlative relation in an active or non-active state without terminating the correlative relation, until the predetermined relation is resolved, and
terminate the correlative relation after the predetermined relation is resolved.

20. A management method executed by a management server, the management method comprising:
receiving an association request from at least one of a first terminal of a first object or a second terminal of a second object, in accordance with a usage relation being generated between the first object and the second object;
accepting a setting of a correlative relation between the first objects and the second objects, by receiving the association request; and
when, in accordance with accepting the setting of the correlative relation by two or more of the association requests with respect to a same first object, settings of two or more correlative relations are established with two or more second objects that are different from each other, with respect to the same first object, setting the setting of one correlative relation out of the two or more correlative relations to active, and setting the settings of other correlative relations to non-active, in accordance with status information that is obtained from at least one of the first object regarding which settings for the two or more correlative relations are established, or the two or more second objects.
